(19) United States
(12) Patent Application Publication
(10) Pub. No.: US 2008/0096770 A1
(43) Pub. Date: Apr. 24, 2008

(54) Evaluation of the Toxicity of Pharmaceutical Agents

(76) Inventors: Claudia McGinnis, Cambridge, MA (US); Frank Stadtler, Eimeldingen (DE); Peter Grass, Schopfheim (DE); Daniel Bauer, Lorrach (DE)

Correspondence Address: NOVARTIS INSTITUTES FOR BIOMEDICAL RESEARCH, INC., 400 TECHNOLOGY SQUARE, CAMBRIDGE, MA, 02139, US

(21) Appl. No.: 11/718,298

(22) PCT Filed: Oct. 27, 2005
(86) PCT No.: PCT/US05/39005

§ 371 Date: Apr. 30, 2007

Related U.S. Application Data
(60) Provisional application No. 60/623,628, filed on Oct. 29, 2004.

(51) Int. Cl. C40B 30/06

(52) U.S. Cl. 506/10

(57) ABSTRACT

The invention provides a rapid high throughput screening process to identify genotoxic compounds. This is accomplished by using a set of biomarker predictor genes that selectively screen for genotoxic or non-genotoxic compounds.

### BACKGROUND OF THE INVENTION

Performing toxicological studies for drug candidates is often time consuming and lengthy work. Prediction of endpoints such as carcinogenicity may take months or years to be completed and require a large number of laboratory animals. In vitro test systems (e.g., the Ames test, or in vitro micronucleus assays) allow for a reduction in cost and time, and are routinely used in preclinical testing. The Ames test, based on genetic effects on a single bacterial gene, may however have minimal relevance to toxicological effects in interacting networks of genes in mammals, especially in humans. Thus, reliable in vitro test systems allowing for early detection of human safety concerns of lead candidates still need to be improved to prevent late loss of development compounds.

Toxicogenomics—the use of gene expression in toxicology—is a new tool to assist drug safety groups in determining undesirable side effects of newly developed candidate pharmaceutical agents. Toxicogenomics-based studies exploit the fact that gene expression changes can be seen within a few hours or days. Predictive Toxicogenomics may only use a small set of well-defined marker genes to predict and compare potential toxicity effects of compounds, thereby assisting the selection of early drug candidates for lead optimization. Predictive toxicogenomics requires the use of microarray experiments only initially, for the definition of marker gene sets. Predictive marker gene screens can then be implemented using cheaper and higher throughput gene expression analysis techniques.

There is a strong need in predictive toxicogenomics to develop robust methods of analysis that can be applied to the identification of appropriate marker genes, preferably as a set of marker genes or as a small number of sets of marker genes. There furthermore is a pressing need for identification of sets of marker genes that remain largely independent of the test system employed and of the nature of the subject drug candidate being tested. The present invention addresses these and related needs.

### SUMMARY OF THE INVENTION

The invention is based on the discovery that certain predictor genes can be used to screen for genotoxic or non-genotoxic compounds. The invention therefore provides a rapid high throughput screening process to identify genotoxic compounds that is time saving over conventional genotoxic compounds screening processes.

Accordingly, in one aspect, the invention pertains to a method of predicting genotoxicity of a compound using a predictor model. This is performed by identifying a plurality of biomarker genes that display an altered expression profile when exposed to a genotoxic compound or a non-genotoxic compound from a calibration set of samples. A sub-set of biomarker genes are identified from the calibration set that display an altered expression profile when exposed to a genotoxic compound or a non-genotoxic compound from a validation set of samples. The biomarker genes identified in the validation set of samples are classified as those that respond to a genotoxic compound or a non-genotoxic compound. The classified biomarker genes are then used to identify the genotoxicity of a test compound by exposing the test compound to cell sample and comparing the expression profile of the biomarker genes in the sample with those identified in the validation set of samples. Based on calibration samples, a predictive model was constructed to predict toxicity of test samples.

The classified biomarker genes can be selected from the group consisting of biomarker-1 (BM1) genes, biomarker-2 (BM2) genes and biomarker-3 (BM3) genes. Biomarker-1 genes include, but are not limited to, Xeroderma pigmentosum, complementation group C, ferredoxin reductase, apolipoprotein B mRNA editing enzyme, catalytic polypeptide-like 3C, hypothetical protein MGC5370, damage-specific DNA binding protein 2, 48 kDa, transcribed locus, papilin, proteoglycan-like sulfated glycoprotein, fucosidase, alpha-L-1, tissue, carboxypeptidase M, tumor protein p53 inducible protein 3, cyclin-dependent kinase inhibitor 1A (p21, Cip1), phosphatidylinositol glycan, class F, interleukin 6 signal transducer (gp130, oncostatin M receptor), hypothetical protein FLJ10375, vacuolar protein sorting 54 (yeast), hv89d09, interleukin 6 signal transducer (gp130, oncostatin M receptor), phosphatidylserine receptor, alpha-cardiac actin, hypothetical protein FLJ11383, ras homolog gene family, member Q, thioredoxin interacting protein, hypothetical protein LOC339290, NCK-associated protein 1, TBC1 domain family, member 17, ectodermal-neural cortex (with BTB-like domain), thioredoxin interacting protein, phosphatidylinositol glycan, class F, phosphatidylinositol glycan, class F, and solute carrier family 33 (acetyl-CoA transporter), member 1. In one embodiment, the Biomarker-1 genes are selected from the group consisting of Xeroderma pigmentosum, complementation group C, .Ferrodoxin reductase, apolipoprotein BmRNA editing enzyme, catalytic polypeptide-like 3C, hypothetical protein MGC5370, and damage-specific DNA binding protein 2.48 kDa.

Biomarker-2 genes include, but are not limited to, EST370545, H. sapiens adenosine deaminase (ADA), Homo sapiens chromosome 12 open reading frame 5 mRNA, polymerase (DNA directed), eta, isocitrate dehydrogenase 1 (NADP+), carboxypeptidase M, plexin B2, polymerase (DNA directed), eta, hypothetical protein FLJ12484, KIAA0907 protein, transcribed locus, ARP9, wb67g03, leucine-rich repeats and death domain containing potassium large conductance calcium-activated channel, subfamily M beta member 3, KAT1914, mitochondrial carrier triple repeat 1, tax 1 (human T-cell leukemia virus type I) binding protein 3, sestrin 1, ret finger protein, SMAD, H. sapiens mitogen inducible gene mig-2, FLJ10378 protein, hypothetical protein MGC7036, ubiquitin-conjugating enzyme, KIAA0368, phosphatidylserine receptor, O-linked N-acetylglucosamine (GlcNAc) transferase (UDP-N-acetylglucosamine:polypeptide-N-acetylglucosaminyl transferase), Mdm2, hypothetical protein LOC51061, NudE nuclear distribution gene E homolog like 1 (A. nidulans), HTPAP protein, and syndecan 1. In one embodiment, the Biomarker-2 genes are selected from the group consisting of EST370545, H. sapiens adenosine deaminase (ADA), Homo sapiens chromosome 12 open reading frame 5 mRNA, polymerase (DNA directed), eta, and isocitrate dehydrogenase 1 (NADP+).

Biomarker-3 genes include, but are not limited to, LAG1 longevity assurance homolog 5 (S. cerevisiae), hypothetical protein HSPC132, FKSG44 gene, adenosine deaminase, pleckstrin homology-like domain, ectodermal-neural cortex (with BTB-like domain), F-box protein 22, ribonucleotide reductase M2 B (TP53 inducible), guanidinoacetate N-methyltransferase, transmembrane 7 superfamily member 3, isocitrate dehydrogenase 1 (NADP+), phosphohistidine phosphatase 1, hypothetical protein FLJ20296, discoidin domain receptor family, member 1, transcribed locus, guanidinoacetate N-methyltransferase, human receptor tyrosine kinase DDR gene, transmembrane 7 superfamily member 3, 601565341F1 NIH_MGC_{—}21 Homo sapiens cDNA clone, F-box protein 22, cytosolic sialic acid 9-O-acetylesterase homolog, BTG family member 2, astrotactin 2, IKK interacting protein, surfeit 4, neutral sphingomyelinase (N-SMase) activation associated factor, ADP-ribosylation factor-like 1, golgi reassembly stacking protein 2, leucine-rich repeats and death domain containing mixed-lineage leukemia, hypothetical protein LOC253981, placenta-specific 8, glutathione peroxidase 1, KDEL (Lys-Asp-Glu-Leu) endoplasmic reticulum protein retention receptor 2, syntaxin 7, lysosomal-associated multispanning membrane protein-5, and phosphoinositide-3-kinase catalytic alpha polypeptide. In one embodiment, the Biomarker-3 genes are selected from the group consisting of LAG1 longevity assurance homolog 5 (S. cerevisiae), hypothetical protein HSPC132, FKSG44 gene, and adenosine deaminase, pleckstrin homology-like domain.

In another aspect, the invention pertains to a method of predicting genotoxicity of a compound using a predictor model by exposing a test compound to a first set of a plurality of biomarker genes selected from the group consisting of biomarker-1 (BM1) genes, biomarker-2 (BM2) genes and biomarker-3 (BM3) genes. The distribution of the biomarker genes is compared against the distribution of gene expression of a known reference compound, and the test compound is separated into a class of compound based on the expression of the biomarker genes, wherein the class of compound is genotoxic compound or a non-genotoxic compound using the cascade of predictive models.

In yet another aspect, the invention pertains to a method of predicting genotoxicity of a compound using a predictor model by exposing a test compound to a plurality of biomarker-1 (BM1) genes selected from the group consisting of Xeroderma pigmentosum, complementation group C, ferredoxin reductase, apolipoprotein B mRNA editing enzyme, catalytic polypeptide-like 3C, hypothetical protein MGC5370, damage-specific DNA binding protein 2, 48 kDa, transcribed locus, papilin, proteoglycan-like sulfated glycoprotein, fucosidase, alpha-L-1, tissue, carboxypeptidase M, tumor protein p53 inducible protein 3, cyclin-dependent kinase inhibitor 1A (p21, Cip1), phosphatidylinositol glycan, class F, interleukin 6 signal transducer (gp130, oncostatin M receptor), hypothetical protein FLJ10375, vacuolar protein sorting 54 (yeast), hv89d09, interleukin 6 signal transducer (gp130, oncostatin M receptor), phosphatidylserine receptor, alpha-cardiac actin, hypothetical protein FLJ11383, ras homolog gene family, member Q, thioredoxin interacting protein, hypothetical protein LOC339290, NCK-associated protein 1, TBC1 domain family, member 17, ectodermal-neural cortex (with BTB-like domain), thioredoxin interacting protein, phosphatidylinositol glycan, class F, phosphatidylinositol glycan, class F, and solute carrier family 33 (acetyl-CoA transporter), member 1. The expression profile of the biomarker genes is compared against the distribution of gene expression of a known reference compound, and then the test compound is separated into a class of compound based on the expression of the biomarker genes, wherein the class of compound is genotoxic compound or a non-genotoxic compound.

In yet another aspect, the invention pertains to a method of predicting genotoxicity of a compound using a predictor model by exposing a test compound to a plurality of biomarker-2 (BM2) genes selected from the group consisting of EST370545, H. sapiens adenosine deaminase (ADA), Homo sapiens chromosome 12 open reading frame 5 mRNA, polymerase (DNA directed), eta, isocitrate dehydrogenase 1 (NADP+), carboxypeptidase M, plexin B2, polymerase (DNA directed), eta, hypothetical protein FLJ12484, KIAA0907 protein, transcribed locus, ARP9, wb67g03, leucine-rich repeats and death domain containing potassium large conductance calcium-activated channel, subfamily M beta member 3, KAT11914, mitochondrial carrier triple repeat 1, tax1 (human T-cell leukemia virus type I) binding protein 3, sestrin 1, ret finger protein, SMAD, H. sapiens mitogen inducible gene mig-2, FLJ10378 protein, hypothetical protein MGC7036, ubiquitin-conjugating enzyme, KIAA0368, phosphatidylserine receptor, O-linked N-acetylglucosamine (GlcNAc) transferase (UDP-N-acetylglucosamine:polypeptide-N-acetylglucosaminyl transferase), Mdm2, hypothetical protein LOC51061, NudE nuclear distribution gene E homolog like 1 (A. nidulans), HTPAP protein, and syndecan 1. The distribution of biomarker genes is compared against a known reference compound. The test compound is separated into a class of compound based on the expression of the biomarker genes, wherein the class of compound is genotoxic compound or a non-genotoxic compound.

In yet another aspect, the invention pertains to a method of predicting genotoxicity of a compound using a predictor model by exposing a test compound to a plurality of biomarker-3 (BM3) genes selected from the group consisting of LAG1 longevity assurance homolog 5 (S. cerevisiae), hypothetical protein HSPC132, FKSG44 gene, adenosine deaminase, pleckstrin homology-like domain, ectodermal-neural cortex (with BTB-like domain), F-box protein 22, ribonucleotide reductase M2 B (TP53 inducible), guanidinoacetate N-methyltransferase, transmembrane 7 superfamily member 3, isocitrate dehydrogenase 1 (NADP+), phosphohistidine phosphatase 1, hypothetical protein FLJ20296, discoidin domain receptor family, member 1, transcribed locus, guanidinoacetate N-methyltransferase, human receptor tyrosine kinase DDR gene, transmembrane 7 superfamily member 3, 601565341F1 NIH_MGC_{—}21 Homo sapiens cDNA clone, F-box protein 22, cytosolic sialic acid 9-O-acetylesterase homolog, BTG family member 2, astrotactin 2, IKK interacting protein, surfeit 4, neutral sphingomyelinase (N-SMase) activation associated factor, ADP-ribosylation factor-like 1, golgi reassembly stacking protein 2, leucine-rich repeats and death domain containing mixed-lineage leukemia, hypothetical protein LOC253981, placenta-specific 8, glutathione peroxidase 1, KDEL (Lys-Asp-Glu-Leu) endoplasmic reticulum protein retention receptor 2, syntaxin 7, lysosomal-associated multispanning membrane protein-5, and phosphoinositide-3-kinase catalytic alpha polypeptide. The distribution of biomarker genes is compared against a known reference compound. The test compound is separated into a class of compound based on the expression of the biomarker genes, wherein the class of compound is genotoxic compound or a non-genotoxic compound.

### BRIEF DESCRIPTION OF FIGURES

FIG. 1. Graphical representation of the percentage of cells in G2 phase as a function of dilution of the indicated genotoxic and nongenotoxic compounds (points 1-9), with control samples at points 10-12. An original color image has been converted to grayscale by computer.

FIG. 2. Graphical representation of the principal component analysis of gene expression of all 215 candidate genes extracted from expression data with 6 reference compounds, labelled by viable cell count. t[1] (the abscissa) represents the scores of principal component #1 explaining the highest proportion of variation and t[2] (the ordinate) represents the scores of principal component #2. Upper panel: original image with points in color; lower panel: image converted to grayscale by computer. As can be seen, cell count is randomly scattered and does not explain the genotoxic or non-genotoxic separation.

FIG. 3. Graphical representation of the principal component analysis of gene expression of all 215 candidate genes labelled by Alamar Blue. t[1] (the abscissa) represents the scores of principal component #1 explaining the highest proportion of variation and t[2] (the ordinate) represents the scores of principal component #2. Upper panel: original image with points in color; lower panel: image converted to grayscale by computer. As can be seen, Alamar Blue cell count is randomly scattered and does not explain genotoxic or non-genotoxic separation.

FIG. 4. Scores of PC1 (principal component 1; t[1]) of Partial Least Squares-Discriminant Analysis (PLS-DA) conducted with all 215 genes. An original image in color has been converted to grayscale by computer.

FIG. 5. Scores of PC1 (principal component 1; t[1]) of PLS-DA conducted with 23 best predictor genes based on 6 reference compounds. An original image in color has been converted to grayscale by computer.

FIG. 6. Cluster analysis with 23 predictor genes after 6 reference compounds with cytotoxic and genotoxic compounds. The upper panel shows the original image with points in color, and the lower panel shows an image converted to grayscale by computer.

FIG. 7. Cluster analysis with 6 predictor genes with cytotoxic and genotoxic compounds. The upper panel shows the original image with points in color, and the lower panel shows an image converted to grayscale by computer.

FIG. 8. Scores of PC1 (principal component 1; t[1]) of PLS-DA conducted with all 6 predictor genes. An original image in color has been converted to grayscale by computer.

FIG. 9. Validation of the predictive model by random response permutation. The x-axis presents the correlation of the original set of toxicity classes with the permuted ones; the y-axis represents the calculated R2 (goodness of fit) and Q2 (goodness of prediction) values. An original image in color has been converted to grayscale by computer.

FIG. 10A is a scatter plot of the t-scores of calibration and validation samples of biomarker-1 (BM1) genotoxic samples cluster on the left-hand side and non-genotoxic on the right-hand side; the separation line is x=0. Apart from the trans-platinum samples all other validation samples were correctly predicted.

FIG. 10B is a graph of the validation of BM1 by response permutation (n=100 times). For this type of validation the class membership of the samples is randomly shuffled and a predictive model constructed. The performance of these model with random data is assessed in terms of the intercept R2 and Q2 and compared with the performance parameters of the model obtained with the correct class membership of (x=1).

FIG. 11A is a scatter plot of the t-scores of calibration and validation samples of biomarker-2 (BM2). Genotoxic samples cluster on the left-hand side and non-genotoxic on the right-hand side; the separation line is x=0. Apart from the trans-platinum samples, all other validation samples were correctly predicted.

FIG. 11B is a graph of the validation by response permutation (n=100 times) of BM2. The class membership of the samples is randomly shuffled and a predictive model constructed. The performance of these model with random data is assessed in terms of R2 and Q2 and compared with the performance parameters of the model obtained with the correct class membership.

FIG. 12A is a scatter plot of the t-scores of calibration and validation samples of biomarker-3 (BM3). Genotoxic samples cluster on the left-hand side and non-genotoxic on the right-hand side; the separation line is x=0. Apart from the trans-platinum samples all other validation samples were correctly predicted.

FIG. 12B is graph of the validation by response permutation (n=100 times) of BM3. The class membership of the samples is randomly shuffled and a predictive model constructed. The performance of these model with random data is assessed in terms of R2 and Q2 and compared with the performance parameters of the model obtained with the correct class membership.

### DETAILED DESCRIPTION OF THE INVENTION

Toxicity testing carried out early in the development program for a pharmaceutical agent is oftentimes done in vitro, and often represents testing that would not be considered acceptable by third party review agencies. Such tests may serve, nevertheless, to predict endpoints in toxicity testing later in a development program, such as in vivo organ toxicity. Prediction of late endpoints is a complex problem, and commonly does not correlate with single early markers. Therefore, an approach involving several early markers (e.g., cellular markers like translocation, micronuclei, or gene expression, proteins) should outperform other single endpoint systems. But such a “multi-endpoint approach” requires an even more sophisticated “prediction function” to identify appropriate testing elements. This is achieved in the present invention by training of the system.

In the present invention, toxicity is established using a class prediction or a class discrimination system in a predictor model for genotoxicity. As used herein, the term “predictor model” refers to a system that uses the expression profile of genes and computer algorithms to assess and classify compounds into genotoxic or non-genotoxic compounds based on the level of gene expression of a plurality of genes. The biomarker genes have been identified by a weighted voting system where the level of gene expression is given a weighing value. The predictive performance of the genes is further evaluated in cross-validation. This identifies certain genes that are predictive of genotoxicity. The resulting predictor model can then be used to identify compounds that are genotoxic or non-genotoxic based on the expression of the classified genes.

In embodiments of the invention described in detail in the Examples, two classes of compound, namely, genotoxic and nongenotoxic, were established. In general, more than two classes may be defined. Tools developed for diagnostic/predictive purposes are supervised, or knowledge-based methods (e.g., Bayesian Networks, k-nearest neighbor (KNN), Partial Least Squares Discriminant Analysis (PLS-DA), or Support Vector Machines). In the embodiments of the Examples, certain supervised tools are designated for use in class prediction. Genes are identified that permit most effective prediction of the classes chosen. These methods include training of the classifier algorithm with reference data, such as the expression profiles obtained for the predictive genes using model class compounds. In summary, instead of seeking one single endpoint (e.g., colony number), development of an optimized prediction or discrimination function is done using the expression of a set of selected marker genes.

In the general classification methods disclosed herein, in order to identify a set of marker genes a cell is exposed to a plurality of classes of compounds in culture. Preferably, for each compound, prior to the identifying procedure involving the exposure, a concentration of the compound is determined at which the cell exhibits a predetermined extent of cyto-toxicity. In commonly used procedures, the predetermined toxicity level is 50% cyto-toxicity. Nevertheless, any intended level of toxicity may be predetermined, such as 20%, 25%, 30%, 40%, 60%, 70%, 75%, 80% toxicity of the compound with respect to the cell; in addition the predetermined level of toxicity may be other than a value listed here according to the needs or intention of a worker of skill in the field of the invention. An important aspect of this determination of toxicity level is that the same predetermined level of toxicity be chosen for all the compounds employed in the identification method. This will ensure that the response of the cell for each compound employed in the identifying procedure will be comparable for all compounds in the method.

In evaluating the predetermined level of toxicity, any method of establishing cell viability or, conversely, cell death (e.g., TK6 human lymphoblastoid cells), may be employed in evaluating the predetermined level of cyto-toxicity for the compound on the cell. Many dyes are known to workers of skill in fields related to the present invention that distinguish between living and dead cells. Among these are trypan blue dye and alamar blue, which are a chromophore and a fluorophore, respectively. Other viability reagents include Guava ViaCount™ (Guava Technologies, Hayward, Calif.), and the CellTiter-Glo® Luminescent Cell Viability Assay, based on bioluminescence (Promega, Madison, Wis.). Equivalent methods of establishing cell viability or death known to workers of skill in the field of the invention are within the scope of the present methods.

Once the concentrations of all compounds corresponding to the predetermined toxicity level are determined, a cell is exposed separately to each compound at that concentration. In advantageous embodiments the same cell is used in establishing the predetermined toxicity level and the assay of the effect of the compound on the cell. It is not necessary that the same cell be used in the two stages of the method, however. As noted, a variety of compounds is tested. The compounds are chosen to represent a plurality of classes.

Thus, at a minimum, the compounds are segregated into two classes, such as toxic and nontoxic, although it is advantageous to generate classifications with a greater degree of specialized attributes. Examples of specialization include, by way of nonlimiting example, genotoxic, nephrotoxic, hepatotoxic, neurotoxic, cytotoxic, and the like covering all known organ-specific, tissue-specific toxicities or other classes of toxicities or pathologies. In each case, a negative classification such as nongenotoxic, non-nephrotoxic, and so forth, i.e., a class in opposition to the first class, may be employed. Furthermore, within each category of toxicity specialization, sub-classes exist such as direct or indirect genotoxicity, and/or classes representing different pathologies responsible for a given organ toxicity. Any equivalent classification of compounds known to a worker of skill in the field of the invention may be employed, and falls within the scope of the present invention.

In the methods of the present invention the modality of evaluating the effect of the various compounds on the cell encompasses any consequence of incubating the cell with the compounds being tested. Thus, for example, cell morphology, cellular metabolism or physiology, any cellular phenotype, differential gene expression, differential protein expression, differential metabolic expression, and similar phenomena or attributes serve to identify a characteristic effect induced by the compound that is not evinced by a compound not falling in the same class as the compound in question. In embodiments presented in the Examples, differential gene expression provides the experimental output; differentially expressed genes are evaluated by hybridizing RNA obtained from the cell samples with probes that encompass a large proportion of the total genome of the species from which the cell originates. The experimental output from all the cells exposed to the various compounds in the plurality of classes used is evaluated by supervised statistical methods such as those identified above. Any equivalent set of statistical analyses that provide trainable evaluation methods, known to a worker of skill in fields related to the present invention, may be used to identify cellular characteristics that serve to distinguish the classes of compound from one another. In important embodiments of the present invention the cellular characteristics include those genes whose differential expression optimally distinguishes the classes of compound used. Those characteristics identified in this way become a predictor set of characteristics to be used in the present invention to classify candidate pharmaceutical agents.

Methods such as those described in the preceding paragraphs provide sets of cellular characteristics that are used to classify a new compound, such as a candidate pharmaceutical agent. In important embodiments of the invention, the classes that were used to identify the cellular characteristics have been classified as toxic versus nontoxic, and in certain exemplary cases the classes are genotoxic versus nongenotoxic, or genotoxic versus purely cytotoxic. In other important embodiments that are described in detail in the Examples, the cellular characteristics employed to discern toxicity vs nontoxicity include coding sequences for genes that are identified by differential expression and application of supervised statistical analytical procedures.

The invention provides sets of isolated polynucleotides identified by methods such as those described herein that permit effective classification of a test compound as toxic or nontoxic, and in particular, as genotoxic or nongenotoxic, or as genotoxic or cytotoxic. These polynucleotide sets are further capable of permitting classification between subsets or sub-classes of given toxicity classifications, such as those described supra. The sets include two or more isolated polynucleotides or oligonucleotides (as explained below, these terms are used interchangeably in the present disclosure) to be employed in the methods of classifying the test compound. Commonly the polynucleotides are used as probes in differential gene expression assays, i.e., they serve as oligonucleotide probes. Sets of two or more, or three or more, or four or more, even larger numbers of oligonucleotides are identified for the first time in the present invention for use in the assay methods described herein. Importantly, whereas complete coding sequences are identified as the ones whose differential expression are to be used in classifying a test compound, typically, and although the complete coding sequence could constitute a particular probe polynucleotide, advantageously a probe oligonucleotide is a fragment of such a coding sequence. More comprehensively, a probe polynucleotide is either a) a complete coding sequence, such as sequence identified by an NCBI (National Center for Biotechnology Information) Accession Number (also termed a GenBank or Refseq Accession Number); b) a nucleotide sequence complementary to a coding sequence in item a); c) a nucleotide sequence that is at least 90% identical to a coding sequence identified in item a); d) a nucleotide sequence complementary to a nucleotide sequence identified in item c); or e) a nucleotide sequence that is a fragment of any of the nucleotide sequences of items a) through d).

As used herein the term “TEST”, and related terms and phrases, relates to a compound or composition that is either a member of a population of compounds or compositions that will be identified as being useful in the classifying methods of the present invention, or the actual compounds or compositions so identified as a result of evaluating those compounds or compositions to be used in the methods. In important embodiments of the invention a TEST compound is a TEST polynucleotide or a TEST protein or polypeptide. Thus TEST substances may be found in samples after treatment with model compounds or candidate compounds.

As used herein, the term “sample” and similar words, relate to any cell or component thereof, or any substance, composition or object that includes a cellular component such as a nucleic acid, polynucleotide or oligonucleotide, or a protein or polypeptide, a biochemical metabolite, a subcellular organelle, a lipid, a polysaccharide, or any other cellular component in a form identical to, or minimally altered from, the form of the nucleic acid, polynucleotide or oligonucleotide, or a protein or polypeptide, or a metabolite, or an organelle or other component in an intact cell. As used herein a sample has been treated with a model compound or a candidate pharmaceutical agent. Broadly, a sample can be a biological sample composed of intact cells. In this broad sense, DNA in a sample is genomic DNA, and RNA in a sample includes mRNA, tRNA, rRNA, and similar or other RNA such as, but not exclusively, microRNA. A sample may also contain DNA that is minimally altered from genomic DNA in view of steps such as isolating nuclei from a sample of cells, or disrupting nuclei contained in a sample of cells. In alternative meanings, a sample may be a subcellular fraction, or a subcellular component or organelle, or, when viewing an intact cell, the cell itself or a subcellular region of the cell.

As used herein, the term “reference” or “control” and similar words, relate to any substance, composition or object as defined above for “sample”, with the exception that instead of being treated with a model compound or candidate compound, the reference is untreated or treated only with a carrier or medium which would otherwise contain the compound. More broadly, a reference is from a source that reliably can serve as a control, or as characterizing a nonexperimental status.

I. Detection and Labeling

A TEST substance such as a TEST polynucleotide or a TEST polypeptide or any TEST cellular component may be detected in many ways. Detecting may include any one or more processes that result in the ability to observe the presence and or the amount of a TEST polynucleotide or a TEST polypeptide. In one embodiment a sample nucleic acid containing a TEST polynucleotide may be detected prior to expansion, or amplification. In an alternative embodiment a TEST polynucleotide in a sample may be expanded, or amplified, to provide an expanded TEST polynucleotide, and the expanded polynucleotide is detected or quantitated. Physical, chemical or biological methods may be used to detect and quantitate a TEST polynucleotide.

Physical methods include, by way of nonlimiting example, optical visualization including various microscopic techniques such as fluorescence microscopy, confocal microscopy, microscopic visualization of in situ hybridization, surface plasmon resonance (SPR) detection such as binding a probe to a surface and using SPR to detect binding of a TEST polynucleotide or a TEST polypeptide to the immobilized probe, or having a probe in a chromatographic medium and detecting binding of a TEST polynucleotide in the chromatographic medium. Physical methods further include a gel electrophoresis or capillary electrophoresis format in which TEST polynucleotides or TEST polypeptides are resolved from other polynucleotides or polypeptides, and the resolved TEST polynucleotides or TEST polypeptides are detected. Physical methods additionally include broadly any spectroscopic method of detecting or quantitating a substance, including without limitation absorption spectroscopy, fluorescence or phosphorescence spectroscopy, infrared spectroscopy, microwave spectroscopy, total internal reflectance spectroscopy, nuclear magnetic resonance spectroscopy and electron spin resonance spectroscopy.

Chemical methods include hybridization methods generally in which a TEST polynucleotide hybridizes to a probe. Chemical methods also include any diagnostic or enzymatic assay for detection of a cellular component such as a metabolite. Chemical methods for detecting polypeptides and certain other cellular components also include immunoassay methods. Such immunoassay methods include, but are not limited to, dot blotting, Western blotting, competitive and noncompetitive protein binding assays, enzyme-linked immunosorbant assays (ELISA), immunohistochemistry, fluorescence-activated cell sorting (FACS), and others commonly used and widely known to workers of skill in fields related to the present invention.

Biological methods include causing a TEST polynucleotide or a TEST polypeptide to exert a biological effect on a cell, and detecting the effect. The present invention discloses examples of biological effects which may be used as a biological assay. In many embodiments, the polynucleotides may be labeled as described below to assist in detection and quantitation. For example, a sample nucleic acid may be labeled by chemical or enzymatic addition of a labeled moiety such as a labeled nucleotide or a labeled oligonucleotide linker. Many equivalent methods of detecting a TEST polynucleotide or a TEST polypeptide are known to workers of skill in fields related to the field of the invention, and are contemplated to be within the scope of the invention.

A nucleic acid of the invention can be expanded using cDNA, mRNA or any other type of RNA, or alternatively, genomic DNA, as a template together with appropriate oligonucleotide primers according to any of a wide range of PCR amplification techniques. The nucleic acid so amplified can be cloned into an appropriate vector and characterized by DNA sequence analysis. Furthermore, oligonucleotides corresponding to TEST nucleotide sequences can be prepared by standard synthetic techniques, e.g., using an automated DNA synthesizer.

Expanded polynucleotides may be detected and/or quantitated directly. For example, an expanded polynucleotide may be subjected to electrophoresis in a gel that resolves by size, and stained with a dye that reveals its presence and amount. Alternatively an expanded TEST polynucleotide may be detected upon exposure to a probe nucleic acid under hybridizing conditions (see below) and binding by hybridization is detected and/or quantitated. Detection is accomplished in any way that permits determining that a TEST polynucleotide has bound to the probe. This can be achieved by detecting the change in a physical property of the probe brought about by hybridizing a fragment. A nonlimiting example of such a physical detection method is surface plasma resonance (SPR).

An alternative way of accomplishing detection is to use a labeled form of a TEST polynucleotide or a TEST polypeptide, and to detect the bound label. The polynucleotide may be labeled as an additional feature in the process of expanding the nucleic acid, or by other methods. A label may be incorporated into the fragments by use of modified nucleotides included in the compositions used to expand the fragment populations. A label may be a radioisotopic label, such as ¹²⁵I, ³⁵S, ³²P, ¹⁴C, or ³H, for example, that is detectable by its radioactivity. Alternatively, a label may be selected such that it can be detected using a spectroscopic method, for example. In one instance, a label may be a chromophore, absorbing incident light. A preferred label is one detectable by luminescence. Luminescence includes fluorescence, phosphorescence, and chemiluminescence. Thus a label that fluoresces, or that phosphoresces, or that induces a chemiluminescent reaction, may be employed. Examples of suitable fluorescent labels, or fluorochromes, include a ¹⁵²Eu label, a fluorescein label, a rhodamine label, a phycoerythrin label, a phycocyanin label, Cy-3, Cy-5, an allophycocyanin label, an o-phthalaldehyde label, and a fluorescamine label. Luminescent labels afford detection with high sensitivity.

A label may furthermore be a magnetic resonance label, such as a stable free radical label detectable by electron paramagnetic resonance, or a nuclear label, detectable by nuclear magnetic resonance. A label may still further be a ligand in a specific ligand-receptor pair; the presence of the ligand is then detected by the secondary binding of the specific receptor, which commonly is itself labeled for detection. Nonlimiting examples of such ligand-receptor pairs include biotin and streptavidin or avidin, a hapten such as digoxigenin or antigen and its specific antibody, and so forth. A label still further may be a fusion sequence appended to a TEST polynucleotide or a TEST polypeptide. Such fusions permit isolation and/or detection and quantitation of the TEST polynucleotide or a TEST polypeptide. By way of nonlimiting example, a fusion sequence may be a FLAG sequence, a polyhistidine sequence, a fluorescent protein sequence such as a green fluorescent protein, a yellow fluorescent protein, an alkaline phosphatase, a glutathione transferase, and the like. In summary, labeling can be accomplished in a wide variety of ways known to workers of skill in fields related to the present disclosure. Any equivalent label that permits detecting and/or quantitation of a TEST polynucleotide or a TEST polypeptide is understood to fall within the scope of the invention.

Detecting, quantitating, including labeling, methods are known generally to workers of skill in fields related to the present invention, including, by way of nonlimiting example, workers of skill in spectroscopy, nucleic acid chemistry, biochemistry, molecular biology and cell biology. Quantitating permits determining the quantity, mass, or concentration of a nucleic acid or polynucleotide, or fragment thereof, that has bound to the probe. Quantitation includes determining the amount of change in a physical, chemical, or biological property as described in this and preceding paragraphs. For example the intensity of a signal originating from a label may be used to assess the quantity of the nucleic acid bound to the probe. Any equivalent process yielding a way of detecting the presence and/or the quantity, mass, or concentration of a polynucleotide or fragment thereof that hybridizes to a probe nucleic acid is envisioned to be within the scope of the present invention.

II. Polynucleotides

As used herein the terms “nucleic acid” and “polynucleotide” and similar terms and phrases are considered synonymous with each other, and are used as conventionally understood by workers of skill in fields such as biochemistry, molecular biology, genomics, and similar fields related to the field of the invention. A polynucleotide employed in the invention may be single stranded or it may be a base paired double stranded structure, or even a triple stranded base paired structure. A polynucleotide may be a DNA, an RNA, or any mixture or combination of a DNA strand and an RNA strand, such as, by way of nonlimiting example, a DNA-RNA duplex structure. A polynucleotide and an “oligonucleotide” as used herein are identical in any and all attributes defined here for a polynucleotide except for the length of a strand. As used herein, a polynucleotide may be about 50 nucleotides or base pairs in length or longer, or may be of the length of, or longer than, about 60, or about 70, or about 80, or about 100, or about 150, or about 200, or about 300, or about 400, or about 500, or about 700, or about 1000, or about 1500, or about 2000 or about 2500, or about 3000, nucleotides or base pairs or even longer. An oligonucleotide may be at least 3 nucleotides or base pairs in length, and may be shorter than about 70, or about 60, or about 50, or about 40, or about 30, or about 20, or about 15, or about 10 nucleotides or base pairs in length. Both polynucleotides and oligonucleotides may be chemically synthesized. Oligonucleotides and polynucleotides may be used as probes.

As used herein “fragment” and similar words relate to portions of a nucleic acid, polynucleotide or oligonucleotide, or to portions of a protein or polypeptide, shorter than the full sequence of a reference. The sequence of bases, or the sequence of amino acid residues, in a fragment is unaltered from the sequence of the corresponding portion of the molecule from which it arose; there are no insertions or deletions in a fragment in comparison with the corresponding portion of the molecule from which it arose. As contemplated herein, a fragment of a nucleic acid or polynucleotide, such as an oligonucleotide, is 15 or more bases in length, or 16 or more, 17 or more, 18 or more, 21 or more, 24 or more, 27 or more, 30 or more, 50 or more, 75 or more, 100 or more bases in length, up to a length that is one base shorter than the full length sequence. Any fragment of a polynucleotide may be chemically synthesized and may be used as a probe.

As used herein and in the claims “nucleotide sequence”, “oligonucleotide sequence” or “polynucleotide sequence”, “polypeptide sequence”, “amino acid sequence”, “peptide sequence”, “oligopeptide sequence”, and similar terms, relate interchangeably both to the sequence of bases or amino acids that an oligonucleotide or polynucleotide, or polypeptide, peptide or oligopeptide has, as well as to the oligonucleotide or polynucleotide, or polypeptide, peptide or oligopeptide structure possessing the sequence. A nucleotide sequence or a polynucleotide sequence, or polypeptide sequence, peptide sequence or oligopeptide sequence furthermore relates to any natural or synthetic polynucleotide or oligonucleotide, or polypeptide, peptide or oligopeptide, in which the sequence of bases or amino acids is defined by description or recitation of a particular sequence of letters designating bases or amino acids as conventionally employed in the field.

Nucleotide residues occupy sequential positions in an oligonucleotide or a polynucleotide. Accordingly a modification or derivative of a nucleotide may occur at any sequential position in an oligonucleotide or a polynucleotide. All modified or derivatized oligonucleotides and polynucleotides are encompassed within the invention and fall within the scope of the claims. Modifications or derivatives can occur in the phosphate group, the monosaccharide or the base. Such modifications include, by way of nonlimiting example, modified bases, and nucleic acids whose sugar phosphate backbones are modified or derivatized. These modifications are carried out at least in part to enhance the chemical stability of the modified nucleic acid, such that they may be used, for example, as antisense binding nucleic acids in therapeutic applications in a subject.

As used herein and in the claims, a “nucleic acid” or “polynucleotide”, and similar terms based on these, refer to polymers composed of naturally occurring nucleotides as well as to polymers composed of synthetic or modified nucleotides. Thus, as used herein, a polynucleotide that is an RNA, or a polynucleotide that is a DNA may include naturally occurring moieties such as the naturally occurring bases and ribose or deoxyribose rings, or they may be composed of synthetic or modified moieties as described in the following. The linkages between nucleotides is commonly the 3′-5′ phosphate linkage, which may be a natural phosphodiester linkage, a phosphothioester linkage, and still other synthetic linkages. Examples of modified backbones include, phosphorothioates, chiral phosphorothioates, phosphorodithioates, phosphotriesters, aminoalkylphosphotriesters, methyl and other alkyl phosphonates including 3′-alkylene phosphonates, 5′-alkylene phosphonates and chiral phosphonates, phosphinates, phosphoramidates including 3′-amino phosphoramidate and aminoalkylphosphoramidates, thionophosphoramidates, thionoalkylphosphonates, thionoalkylphosphotriesters, selenophosphates and boranophosphates. Additional linkages include phosphotriester, siloxane, carbonate, carboxymethylester, acetamidate, carbamate, thioether, bridged phosphoramidate, bridged methylene phosphonate, bridged phosphorothioate and sulfone internucleotide linkages. Other polymeric linkages include 2′-5′ linked analogs of these. See U.S. Pat. Nos. 6,503,754 and 6,506,735 and references cited therein, incorporated herein by reference. The monosaccharide may be modified by being, for example, a pentose or a hexose other than a ribose or a deoxyribose. The monosaccharide may also be modified by substituting hydroxyl groups with hydro or amino groups, by esterifying additional hydroxyl groups, and so on.

The bases in oligonucleotides and polynucleotides may be “unmodified” or “natural” bases include the purine bases adenine (A) and guanine (G), and the pyrimidine bases thymine (T), cytosine (C) and uracil (U). In addition they may be bases with modifications or substitutions. As used herein, modified bases include other synthetic and natural bases such as 5-methylcytosine (5-me-C), 5-hydroxymethyl cytosine, xanthine, hypoxanthine, 2-aminoadenine, 6-methyl and other alkyl derivatives of adenine and guanine, 2-propyl and other alkyl derivatives of adenine and guanine, 2-thiouracil, 2-thiothymine and 2-thiocytosine, 5-halouracil and cytosine, 5-propynyl uracil and cytosine and other alkynyl derivatives of pyrimidine bases, 6-azo uracil, cytosine and thymine, 5-uracil (pseudouracil), 4-thiouracil, 8-halo, 8-amino, 8-thiol, 8-thioalkyl, 8-hydroxyl and other 8-substituted adenines and guanines, 5-halo particularly 5-bromo, 5-trifluoromethyl and other 5-substituted uracils and cytosines, 7-methylguanine and 7-methyladenine, 2-fluoro-adenine, 2-amino-adenine, 8-azaguanine and 8-azaadenine, 7-deazaguanine and 7-deazaadenine and 3-deazaguanine and 3-deazaadenine. Further modified bases include tricyclic pyrimidines such as phenoxazine cytidine (1H-pyrimido[5,4-b][1,4]benzoxazin-2(3H)-one), phenothiazine cytidine (1H-pyrimido[5,4-b][1,4]benzothiazin-2(3H)-one), G-clamps such as a substituted phenox azine cytidine (e.g., 9-(2-aminoethoxy)-H-pyrimido[5,4-b][1,4]benzoxazin-2(3H)-one), carbazole cytidine (2H-pyrimido[4,5-b]indol-2-one), pyridoindole cytidine (H-pyrido[3′, 2′:4,5]pyrrolo[2,3-d]pyrimidin-2-one). Modified bases may also include those in which the purine or pyrimidine base is replaced with other heterocycles, for example 7-deaza-adenine, 7-deazaguanosine, 2-aminopyridine and 2-pyridone.

Further bases include those disclosed in U.S. Pat. No. 3,687,808, those disclosed in The Concise Encyclopedia of Polymer Science And Engineering, pages 858-859, Kroschwitz, J. I., ed. John Wiley & Sons, 1990, those disclosed by Englisch et al., Angewandte Chemie, International Edition (1991) 30, 613, and those disclosed by Sanghvi, Y. S., Chapter 15, Antisense Research and Applications, pages 289-302, Crooke, S. T. and Lebleu, B., ed., CRC Press, 1993. Certain of these bases are particularly useful for increasing the binding affinity of the oligomeric compounds of the invention. These include 5-substituted pyrimidines, 6-azapyrimidines and N-2, N-6 and O-6 substituted purines, including 2-aminopropyladenine, 5-propynyluracil and 5-propynylcytosine. 5-methylcytosine substitutions have been shown to increase nucleic acid duplex stability by 0.6-1.2° C. (Sanghvi, Y. S., Crooke, S. T. and Lebleu, B., eds., Antisense Research and Applications, CRC Press, Boca Raton, 1993, pp. 276-278) and are presently preferred base substitutions, even more particularly when combined with 2′-O-methoxyethyl sugar modifications. See U.S. Pat. Nos. 6,503,754 and 6,506,735 and references cited therein, incorporated herein by reference.

Nucleotides may also be modified to harbor a label. Nucleotides bearing a fluorescent label or a biotin label, for example, are available from Sigma (St. Louis, Mo.).

As used herein an “isolated” nucleic acid molecule is one that is separated from at least one other nucleic acid molecule that is present in the natural source of the nucleic acid. Examples of isolated nucleic acid molecules include, but are not limited to, recombinant polynucleotide molecules, recombinant polynucleotide sequences contained in a vector, recombinant polynucleotide molecules maintained in a heterologous host-cell, partially or substantially purified nucleic acid molecules, and synthetic DNA or RNA molecules. Preferably, an “isolated” nucleic acid is free of sequences which naturally flank the nucleic acid (i.e., sequences located at the 5′ and 3′ ends of the nucleic acid) in the genomic DNA of the organism from which the nucleic acid is derived. For example, in various embodiments, the isolated TEST nucleic acid molecule can contain less than about 50 kb, 25 kb, 5 kb, 4 kb, 3 kb, 2 kb, 1 kb, 0.5 kb or 0.1 kb of nucleotide sequences which naturally flank the nucleic acid molecule in genomic DNA of the cell from which the nucleic acid is derived. Moreover, an “isolated” nucleic acid molecule, such as a cDNA molecule, can be substantially free of other cellular material or culture medium when produced by recombinant techniques, or of chemical precursors or other chemicals when chemically synthesized.

A nucleic acid molecule used in the present invention, e.g., a nucleic acid molecule having the nucleotide sequence identified herein by an NCBI GenBank or Refseq Accession Number, or a complement of any of these nucleotide sequence, can be isolated using standard molecular biology techniques and the sequence information provided herein. Using all or a portion of the nucleic acid sequence of any sequence identified herein by an NCBI Accession Number as a hybridization probe, TEST nucleic acid sequences can be isolated using standard hybridization and cloning techniques (e.g., as described in Sambrook et al., eds., MOLECULAR CLONING: A Laboratory Manual 3^{rd} Ed., Cold Spring Harbor Laboratory Press, Cold Spring Harbor, N.Y., 2001; and Brent et al., Current Protocols in Molecular Biology, Wiley Interscience Publishers, (2003)).

As used herein, the term “complementary” refers to Watson-Crick or Hoogsteen base pairing between nucleotides units of a nucleic acid molecule. As used herein and in the claims, the term “complementary” and similar words, relate to the ability of a first nucleic acid base in one strand of a nucleic acid, polynucleotide or oligonucleotide to interact specifically only with a particular second nucleic acid base in a second strand of a nucleic acid, polynucleotide or oligonucleotide. By way of nonlimiting example, if the naturally occurring bases are considered, A and T or U interact with each other, and G and C interact with each other. As employed in this invention and in the claims, “complementary” is intended to signify “fully complementary” within a region, namely, that when two polynucleotide strands are aligned with each other, at least in the region each base in a sequence of contiguous bases in one strand is complementary to an interacting base in a sequence of contiguous bases of the same length on the opposing strand.

As used herein, “hybridize”, “hybridization” and similar words relate to a process of forming a nucleic acid, polynucleotide, or oligonucleotide duplex by causing strands with complementary sequences to interact with each other. The interaction occurs by virtue of complementary bases on each of the strands specifically interacting to form a pair. The ability of strands to hybridize to each other depends on a variety of conditions, as set forth below. Nucleic acid strands hybridize with each other when a sufficient number of corresponding positions in each strand are occupied by nucleotides that can interact with each other. It is understood by workers of skill in the field of the present invention, including by way of nonlimiting example molecular biologists and cell biologists, that the sequences of strands forming a duplex need not be 100% complementary to each other to be specifically hybridizable.

In another embodiment, an isolated nucleic acid molecule of the invention comprises a nucleic acid molecule that is a complement of the nucleotide sequence in any sequence identified herein by an NCBI GenBank or Refseq Accession Number, or a portion of this nucleotide sequence. A nucleic acid molecule that is complementary to the nucleotide sequence identified herein by an NCBI GenBank or Refseq Accession Number is one that is sufficiently complementary to the nucleotide sequence identified herein by an NCBI GenBank or Refseq Accession Number that it can hydrogen bond with few or no mismatches to the nucleotide sequence identified herein by an NCBI GenBank or Refseq Accession Number, thereby forming a stable duplex.

A significant use of a nucleic acid, polynucleotide, or oligonucleotide is in an assay directed to identifying a target sequence to which a probe nucleic acid hybridizes. The selectivity of a probe for a target is affected by the stringency of the hybridizing conditions. “Stringency” of hybridization reactions is readily determinable by one of ordinary skill in the art, and generally is an empirical evaluation dependent upon probe length, temperature, and buffer composition. Hybridization generally depends on the ability of denatured DNA to reanneal when complementary strands are present in an environment below their melting temperature. Higher relative temperatures tend to make the reaction conditions more stringent, while lower temperatures less so. For additional details and explanation of stringency of hybridization reactions and identifying hybridization conditions of varying stringency, see Brent et al., Current Protocols in Molecular Biology, Wiley Interscience Publishers, (2003), and Sambrook et al., Molecular Cloning: A Laboratory Manual, 3^{rd} Ed., New York: Cold Spring Harbor Press, 2001. In addition, in high throughput or multiplexed assay systems, both the probe characteristics and the stringency may be optimized to permit achieving the objectives of the multiplexed assay under a single set of stringency conditions.

Nonlimiting examples of “stringent conditions” or “high stringency conditions”, as defined herein, include those that: (1) employ low ionic strength and high temperature for washing, for example 0.015 M sodium chloride/0.0015 M sodium citrate/0.1% sodium dodecyl sulfate at 50° C.; (2) employ during hybridization a denaturing agent, such as formamide, for example, 50% (v/v) formamide with 0.1% bovine serum albumin/0.1% Ficoll/0.1% polyvinylpyrrolidone/50 mM sodium phosphate buffer at pH 6.5 with 750 mM sodium chloride, 75 mM sodium citrate at 42° C.; (3) employ 50% formamide, 5×SSC (0.75 M NaCl, 0.075 M sodium citrate), 50 mM sodium phosphate (pH 6.8), 0.1% sodium pyrophosphate, 5×Denhardt's solution, sonicated salmon sperm DNA (50 μg/ml), 0.1% SDS, and 10% dextran sulfate at 42° C., with washes at 42° C. in 0.2×SSC (sodium chloride/sodium citrate) and 50% formamide at 55° C., followed by a high-stringency wash consisting of 0.1×SSC containing EDTA at 55° C., or (4) employ 7% sodium dodecyl sulfate (SDS), 0.5 M NaPO₄, 1 mM ED-FA at 50° C. with washing in 2×SSC, 0.1% SDS at 50° C.

“Moderately stringent conditions” include, by way of nonlimiting example, the use of washing solution and hybridization conditions (e.g., temperature, ionic strength and % SDS) less stringent that those described above. An example of moderately stringent conditions is overnight incubation at 37° C. in a solution comprising: 20% formamide, 5×SSC (150 mM NaCl, 15 mM trisodium citrate), 50 mM sodium phosphate (pH 7.6), 5×Denhardt's solution, 10% dextran sulfate, and 20 mg/ml denatured sheared salmon sperm DNA, followed by washing the filters in 1×SSC at about 37-50° C. The skilled artisan will recognize how to adjust the temperature, ionic strength, etc. as necessary to accommodate factors such as probe length and the like.

III. Variant Test Polynucleotides

The invention further encompasses nucleic acid molecules that differ from the disclosed TEST nucleotide sequences. For example, a sequence may differ due to degeneracy of the genetic code. These nucleic acids thus encode the same TEST protein as that encoded by the nucleotide sequence shown in a sequence identified herein by an NCBI GenBank or Refseq Accession Number. In such embodiments, an isolated nucleic acid molecule of the invention has a nucleotide sequence encoding a protein having an amino acid sequence identified herein by an NCBI or comparable GenBank or Refseq Accession Number.

In addition to the human TEST nucleotide sequences identified herein by an NCBI GenBank or Refseq Accession Number, it will be appreciated by those skilled in the art that DNA allelic sequence polymorphisms that lead to changes in the amino acid sequences of TEST protein may exist within a population (e.g., the human population). Such natural allelic variations can typically result in 1-5% variance in the nucleotide sequence of the TEST gene. Any and all such nucleotide variations and resulting amino acid polymorphisms in the TEST protein that are the result of natural allelic variation and that do not alter the functional activity of the TEST protein are intended to be within the scope of the invention.

Moreover, nucleic acid molecules encoding TEST orthologs from other species, and thus that have a nucleotide sequence that differs from the human sequence of any sequence identified herein by an NCBI GenBank or Refseq Accession Number, are intended to be within the scope of the invention. Nucleic acid molecules corresponding to natural allelic variants and orthologs of the TEST cDNAs of the invention can be isolated based on their homology to the human TEST nucleic acids disclosed herein using the human cDNAs, or a portion thereof, as a hybridization probe according to standard hybridization techniques under stringent hybridization conditions.

IV. Polypeptides

As used herein the term “protein”, “polypeptide”, or “oligopeptide”, and similar words based on these, relate to polymers of alpha amino acids joined in peptide linkage. Alpha amino acids include those encoded by triplet codons of nucleic acids, polynucleotides and oligonucleotides. They may also include amino acids with side chains that differ from those encoded by the genetic code.

As used herein, a “mature” form of a polypeptide or protein disclosed in the present invention is the product of a naturally occurring polypeptide or precursor form or proprotein. The naturally occurring polypeptide, precursor or proprotein includes, by way of nonlimiting example, the full length gene product, encoded by the corresponding gene. Alternatively, it may be defined as the polypeptide, precursor or proprotein encoded by an open reading frame described herein. The product “mature” form arises, again by way of nonlimiting example, as a result of one or more naturally occurring processing steps as they may take place within the cell, or host cell, in which the gene product arises. Examples of such processing steps leading to a “mature” form of a polypeptide or protein include the cleavage of the N-terminal methionine residue encoded by the initiation codon of an open reading frame, or the proteolytic cleavage of a signal peptide or leader sequence. Thus a mature form arising from a precursor polypeptide or protein that has residues 1 to N, where residue 1 is the N-terminal methionine, would have residues 2 through N remaining after removal of the N-terminal methionine. Alternatively, a mature form arising from a precursor polypeptide or protein having residues 1 to N, in which an N-terminal signal sequence from residue 1 to residue M is cleaved, would have the residues from residue M+1 to residue N remaining. Further as used herein, a “mature” form of a polypeptide or protein may arise from a step of post-translational modification other than a proteolytic cleavage event. Such additional processes include, by way of non-limiting example, glycosylation, myristoylation or phosphorylation. In general, a mature polypeptide or protein may result from the operation of only one of these processes, or a combination of any of them.

A TEST protein or polypeptide identified by the methods of the invention may be the product of alternative splicing processes. Thus protein homologues are considered that may have certain exons found in genomic DNA excluded from a particular mRNA, giving rise to a gene product lacking the sequence coded by the excluded exon.

As used herein an “amino acid” designates any one of the naturally occurring alpha-amino acids that are found in proteins. In addition, the term “amino acid” designates any nonnaturally occurring amino acids known to workers of skill in protein chemistry, biochemistry, and other fields related to the present invention. These include, by way of nonlimiting example, sarcosine, hydroxyproline, norleucine, alloisoleucine, cyclohexylalanine, phenylglycine, homocysteine, dihydroxyphenylalanine, ornithine, citrulline, D-amino acid isomers of naturally occurring L-amino acids, and others. In addition an amino acid may be modified or derivatized, for example by coupling the side chain with a label. Any amino acid known to a worker of skill in the art may be incorporated into a polypeptide disclosed herein.

The term “epitope tagged” when used herein refers to a chimeric polypeptide comprising a TEST polypeptide fused to a “tag polypeptide”. The tag polypeptide has enough residues to provide an epitope against which an antibody can be made, yet is short enough such that it does not interfere with activity of the polypeptide to which it is fused. The tag polypeptide preferably also is fairly unique so that the antibody does not substantially cross-react with other epitopes. Suitable tag polypeptides generally have at least six amino acid residues and usually between about 8 and 50 amino acid residues (preferably, between about 10 and 20 amino acid residues).

As used herein, the terms “active” or “activity” and similar terms refer to form(s) of a polypeptide which retain a biological and/or an immunological activity of native or naturally-occurring TEST, wherein “biological” activity refers to a biological function (either inhibitory or stimulatory) caused by a native or naturally-occurring TEST other than the ability to induce the production of an antibody against an antigenic epitope possessed by a native or naturally-occurring TEST and an “immunological” activity refers to the ability to induce the production of an antibody against an antigenic epitope possessed by a native or naturally-occurring TEST.

V. Determining Similarity Between Two or More Sequences

To determine the percent similarity of two amino acid sequences or of two nucleic acids, the sequences are aligned for optimal comparison purposes (e.g., gaps can be introduced in either of the sequences being compared for optimal alignment between the sequences). As used herein amino acid or nucleotide “identity” is synonymous with amino acid or nucleotide “homology”.

The term “sequence identity” refers to the degree to which two polynucleotide or polypeptide sequences are identical on a residue-by-residue basis over a particular region of comparison. The term “percentage of sequence identity” is calculated by comparing two optimally aligned sequences over that region of comparison, determining the number of positions at which the identical nucleic acid base (e.g., A, T or U, C, G, or I, in the case of nucleic acids) occurs in both sequences to yield the number of matched positions, dividing the number of matched positions by the total number of positions in the region of comparison (i.e., the window size), and multiplying the result by 100 to yield the percentage of sequence identity. The term “substantial identity” as used herein denotes a characteristic of a polynucleotide sequence, wherein the polynucleotide comprises a sequence that has at least 80 percent sequence identity, preferably at least 85 percent identity and often 90 to 95 percent sequence identity, more usually at least 99 percent sequence identity as compared to a reference sequence over a comparison region. In polypeptides the “percentage of positive residues” is calculated by comparing two optimally aligned sequences over that region of comparison, determining the number of positions at which the identical and conservative amino acid substitutions, as defined above, occur in both sequences to yield the number of matched positions, dividing the number of matched positions by the total number of positions in the region of comparison (i.e., the window size), and multiplying the result by 100 to yield the percentage of positive residues.

“Identity,” as known in the art, is a relationship between two or more polypeptide sequences or two or more polynucleotide sequences, as determined by, comparing the sequences. In the art, “identity” also means the degree of sequence relatedness between polypeptide or polynucleotide sequences, as the case may be, as determined by the match between strings of such sequences. “Identity” and “similarity” can be readily calculated by known methods, including but not limited to those described in (Computational Molecular Biology, Lesk. A. M., ed., Oxford University Press, New York, 1988; Biocomputing: Informatics and Genome Projects, Smith, D. W., ed., Academic Press, New York, 1993; Computer Analysis of Sequence Data, Part I. Griffin, A. M., and Griffin, H. G., eds. Humana Press, New Jersey, 1994; Sequence Analysis in Molecular Biology, von Heinje, G., Academic Press, 1987; and Sequence Analysis Primer, Gribskov, M. and Devereux, J., eds., M Stockton Press. New York, 1991; and Carillo, H., and Lipman, D., SIAM J. Applied Math. (1988) 48: 1073. Preferred methods to determine identity are designed to give the largest match between the sequences tested. Methods to determine identity and similarity are codified in publicly available computer programs. Preferred computer program methods to determine identity and similarity between two sequences include, but are not limited to, the GCG program package (Devereux, J., et al. (1984) Nucleic Acids Research 12(1): 387), BLASTP, BLASTN, and FASTA (Atschul, S. F. et al. (1990) J. Molec. Biol. 215: 403-410. The BLAST X program is publicly available from NCBI and other sources (BLAST Manual, Altschul, S., et al., NCBI NLM NIH Bethesda, Md. 20894; Altschul, S., et al. (1990) J. Mol. Biol. 215: 403-410. The well known Smith Waterman algorithm may also be used to determine identity.

Additionally, the BLAST alignment tool is useful for detecting similarities and percent identity between two sequences. BLAST is available on the World Wide Web at the National Center for Biotechnology Information site. References describing BLAST analysis include Madden, T. L., Tatusov, R. L. & Zhang, J. (1996) Meth. Enzymol. 266:131-141; Altschul, S. F., Madden, T. L., Schäffer, A. A., Zhang, J., Zhang, Z., Miller, W. & Lipman, D. J. (1997) Nucleic Acids Res. 25:3389-3402; and Zhang, J. & Madden, T. L. (1997) Genome Res. 7:649-656.

VI. Test Proteins and Polypeptides

A protein employed in the invention includes an isolated TEST protein whose sequence is provided in any sequence identified herein by an NCBI or comparable GenBank or Refseq Accession Number. The invention also includes a mutant or variant protein any of whose residues may be changed from the corresponding residue of a sequence identified herein by an NCBI or comparable GenBank or Refseq Accession Number, while still encoding a protein that maintains its TEST protein-like activities and physiological functions, or a functional fragment thereof. For example, the invention includes the polypeptides encoded by the variant TEST nucleic acids described above. In the mutant or variant protein, up to 20% or more of the residues may be so changed.

In general, a TEST protein-like variant that preserves TEST protein-like function includes any variant in which residues at a particular position in the sequence have been substituted by other amino acids, and further includes the possibility of inserting an additional residue or residues between two residues of the parent protein as well as the possibility of deleting one or more residues from the parent sequence. Any amino acid substitution, insertion, or deletion is encompassed by the invention. In favorable circumstances, the substitution is a non-essential or conservative substitution as defined above. Furthermore, without limiting the scope of the invention, positions of any sequence identified herein by an NCBI or comparable GenBank or Refseq Accession Number may be substituted such that a mutant or variant protein may include one or more substitutions.

The invention also includes use of isolated TEST proteins, and biologically active portions thereof, or derivatives, fragments, analogs or homologs thereof. Also provided are polypeptide fragments suitable for use as immunogens to raise anti-TEST protein antibodies. A fragment of a protein or polypeptide, such as a peptide or oligopeptide, may be 5 amino acid residues or more in length, or 6 or more, 7 or more, 8 or more, 9 or more, 10 or more, 15 or more, 20 or more, 25 or more, 30 or more, 50 or more, 100 or more residues in length, up to a length that is one residue shorter than the full length sequence. In one embodiment, native TEST proteins can be isolated from cells or tissue sources by an appropriate purification scheme using standard protein purification techniques. In another embodiment, TEST proteins are produced by recombinant DNA techniques. Alternative to recombinant expression, a TEST protein or polypeptide can be synthesized chemically using standard peptide synthesis techniques. Purification of proteins and polypeptides is described, for example, in texts such as “Protein Purification, 3^{rd} Ed.”, R. K. Scopes, Springer-Verlag, New York, 1994; “Protein Methods, 2^{nd} Ed.,” D. M. Bollag, M. D. Rozycki, and S. J. Edelstein, Wiley-Liss, New York, 1996; and “Guide to Protein Purification”, M. Deutscher, Academic Press, New York, 2001.

VII. Variant Test Proteins

In addition to naturally-occurring allelic variants of the TEST sequence that may exist in the population, the skilled artisan will further appreciate that variants of the amino acid identified herein by an NCBI GenBank or Refseq Accession Number can be generated by a skilled artisan. Variant proteins may arise in a cell used in the present methods, or may serve as a standard for detecting protein expression in the present methods. Any amino acid change leading to a functional protein or retaining the ability to be detected is contemplated within the scope of the present invention. Accordingly, in another embodiment, the TEST protein is a protein that comprises an amino acid sequence at least about 45% similar, and more preferably about 55% or more, 65% or more, 70% or more, 75% or more, 80% or more, 85% or more, 90% or more, 95% or more, 98% or more, or even 99% or more similar to the amino acid sequence of any sequence identified herein by an NCBI or comparable GenBank or Refseq Accession Number.

VIII. Anti-Test Protein Antibodies

An important class of TEST protein is an antibody or antibody fragment that specifically binds a TEST protein gene product identified in the classification methods of the invention. Antibodies that bind identified TEST proteins or fragments or variants thereof are used in the detection of the TEST proteins. An anti-TEST antibody may be a polyclonal antibody, a monoclonal antibody, or specific-binding portion thereof that binds the antigen TEST protein, fragment or variant.

IX. Arrays

In important embodiments of the invention a set of isolated polynucleotides or a set of isolated polypeptides is affixed to a solid substrate to form an array. An important class of polypeptide affixed to an array includes anti-TEST antibody molecules. Each locus or spot in an array is addressable and is distinct from other loci or spots in the array. Each locus may be identified by the composition that is affixed thereto. Thus in principle each locus bears a unique composition that is identified by the address of the locus. By way of nonlimiting example, in an array made up of polynucleotide probes, for example, each locus of the array may have affixed thereto a probe polynucleotide that is either a) a complete coding sequence, such as sequence identified by an NCBI (National Center for Biotechnology Information) GenBank or Refseq Accession Number; b) a nucleotide sequence complementary to a coding sequence in item a); c) a nucleotide sequence that is at least 90% identical to a coding sequence identified in item a); d) a nucleotide sequence complementary to a nucleotide sequence identified in item c); or e) a nucleotide sequence that is a fragment of any of the nucleotide sequences of items a) through d). Other compositions, such as proteins or polypeptides, or specific binding agents that specifically bind particular proteins or polypeptides, may be affixed to the loci of an array, instead of polynucleotide probes.

Examples of solid supports for constructing arrays include, but are not limited to, membranes, filters, slides, paper, nylon, wafers, fibers, magnetic or nonmagnetic beads, gels, tubing, polymers, polyvinyl chloride dishes, etc. Any solid surface to which the oligonucleotides can be bound, either directly or indirectly, either covalently or non-covalently, can be used. A particularly preferred solid substrate is a high density microarray or GeneChip expression probe array (e.g., a GeneChip™ from Affymetrix Inc., Santa Clara, Calif.). These high density arrays contain a particular oligonucleotide probe in a pre-selected location on the array. Each pre-selected location can contain more than one molecule of the particular probe. Because the oligonucleotides are at specified locations on the substrate, the hybridization patterns and intensities (which together result in a unique expression profile or pattern) can be interpreted in terms of expression levels of particular genes.

Arrays are prepared by any of a wide range of methods known in the art. Nonlimiting examples of sources describing the preparation of arrays of oligonucleotides and other compositions include Chetverin et al., “Oligonucleotide Arrays: New Concepts and Possibilities,” Biotechnology, 12:1093-1099 (1994); Di Mauro et al., “DNA Technology in Chip Construction,” Adv. Mater., 5(5):384-386 (1993); Dower et al., “The Search for Molecular Diversity (II): Recombinant and Synthetic Randomized Peptide Libraries,” Ann. Rep. Med. Chem., 26:271-280 (1991); Diggelmann, “Investigating the VLSIPS synthesis process,” Sep. 9, 1994; U.S. Pat. No. 6,506,558; U.S. Pat. No. 6,054,270; and U.S. Pat. No. 5,830,645.

X. Methods of Classifying Candidate Compounds

The present invention is directed toward determining into which class of toxicity a candidate compound, such as a candidate pharmaceutical agent, falls. As noted above, important class distinctions of significance in the present invention include two-fold distinctions such as toxic and nontoxic, or genotoxic and nongenotoxic, as well as more complex classification schemes. In order to accelerate the process of identifying strong leads for compounds that may become pharmaceutical agents, it is advantageous to use high throughput assays such as in vitro assays for this purpose. In vitro cell based assays are included in this group. As described in detail above, any suitable cellular characteristic or group of cellular characteristics may be identified as providing the discrimination power to provide the classification result. These include, by way of nonlimiting example, cell morphology, cellular metabolism or physiology, any cellular phenotype, differential gene expression, differential protein expression, differential metabolic expression, and similar phenomena or attributes.

In order to classify a candidate compound, a concentration or range of concentrations at which the compound is expected to exert a beneficial pharmacological or therapeutic effect is determined. In the in vitro assays of the present method, a suitable cell that is considered to provide results in assays that closely reflect those expected from in vivo tests is used. In several replicate samples, the cell is exposed to at least one concentration, and advantageously to several concentrations of the candidate compound under conditions, and for a length of time, that are considered sufficient for an effect, such as toxic effect, or a genotoxic effect, to be exerted on various classes of cellular component. In various embodiments of this procedure, nonlimiting examples of classes of cellular component that may be analyzed include nucleic acids such as DNA and various types of cellular RNA species, protein and polypeptide components of the cell, membrane-bound proteins and polypeptides, lipid components of a cell, metabolites characteristic of biochemical processes occurring within the cell, organelles and components thereof, and ionic components of the cell. After the passage of sufficient time, members of the cellular component of interest in the chosen method are isolated from the cell. One or more of members of the class has already been determined to respond to the application of compounds that permit classification to proceed.

As used herein the term “responsive” and similar terms and phrases relate to a cellular component whose presence, absence or concentration measurably differs when the cell from which the cellular component originates is incubated with a model compound or a candidate compound, compared to a control incubation lacking the compound. The measurable difference exceeds limits of detection or other criteria for significance imposed by a worker of skill in the field of the present invention when implementing the methods disclosed herein.

The responsive members of this class of cellular component are then subjected to analysis to evaluate their presence, absence or concentration. The ensemble of results for all the responsive members of the class are then characterized, using methods such as the supervised statistical analyses described in the Examples, to determine whether the characterization resembles a characterization obtained when a toxic model compound is used in similar experiments carried out simultaneously with the candidate compound, or prior to or after the experiments with the candidate compound are conducted. The results of the analysis and characterization provide a result that the candidate compound is classified as being toxic or nontoxic, or genotoxic or nongenotoxic, and so forth, depending on the classification system initially set up with the model compounds.

XI. Classifying Candidate Compounds Using Differential Gene Expression

In important embodiments of methods of classifying candidate compounds the cellular component subjected to analysis is the population of RNA molecules present in the cell in response to contacting the cell with the candidate compound. Prior to the characterization and classification of the candidate compound the cell has been used to identify a plurality of genes, using methods analyzing differential gene expression, that respond in statistically significant fashion to application of toxic as opposed to nontoxic compounds. In particularly significant embodiments the classification has been made according to genotoxicity or the lack thereof.

In this method of classifying a candidate compound, first a concentration or set of concentrations at which the compound exerts a predetermined toxic (genotoxic or cytotoxic) effect is identified. Next, a cell is exposed to the predetermined toxic concentration or set of concentrations of the compound. After the candidate compound has been allowed to exert an effect on the expression of RNA in the cell, the cellular RNA population is isolated; as noted, the presence, absence or concentration of at least some RNA species has been previously demonstrated to be responsive to the classes of compound being considered. The presence, absence or concentration of the responsive RNA species the RNA is determined, for example by hybridization to a plurality of probe nucleotide sequences that include at least fragments of the responsive gene sequences. Finally, the pattern of expression reflected in the hybridization procedure is used to determine whether the characterization resembles a characterization obtained when a toxic model compound is used, or a nontoxic model compound is used. The results of this analysis and determination thus classifies the candidate compound. Other classification schemes may be used, such as genotoxic versus nongenotoxic, or genotoxic versus cytotoxic, in establishing the classes of model compounds.

The Examples disclose use of an initial set of genotoxic compounds that may be considered to be an initial training set, as well as a set of cytotoxic but not genotoxic compounds, in the differential gene expression in a subject cell culture. In Examples 1-7, transcription profiles were obtained from TK6 human lymphoblastoid cells treated with control containing no experimental compound, three known genotoxic compounds (cis-Platinum, Methyl Methane Sulfonate, and Mitomycin C), or three compounds known to be purely cytotoxic (NaCl, Rifampicin, and Trans-Platinum).

The experiments reported in the Examples 1-7 provided discriminant functions involving the expression pattern of two sets, believed to be novel, of predictor genes; one set containing 23 genes was identified using Partial Least Squares-Discriminant Analysis (PLS-DA), and a second set of 27 predictor genes was identified using KNN analysis. Six genes identified as being capable of separating samples treated with cytotoxic and genotoxic compounds without any misclassification were found to be in common to both predictor sets. Most of the 23 predictor genes derived from PLS-DA and most of the 27 predictor genes derived from KNN directly or indirectly represent correlates of molecular events that are involved in genotoxicity. Selected members of the gene sets are given in the following paragraphs.

In Example 8, additional reference compounds were included in the data set. These include five additional known genotoxic compounds (Ethyl nitroso urea, Doxorubicin HCl, Styrene oxide, Bleomycin sulfate, and Daunorubicin HCl), and five additional compounds known to be purely cytotoxic (KCl, N-Acetylcystein, Ranitidin HCl, Flufenamic acid, and Verapamil HCl).

The results from Example 8 further confirm the results from the initial experiments and provides evidence that certain biomarker genes can be used as predictors of genotoxicity of compounds in the predictor model. In one embodiment, the set of biomarker genes used to predict genotoxicty or non-genotoxicity of compounds are in the Biomarker-1 (BM1) group. These include, but are not limited to, Xeroderma pigmentosum, complementation group C, ferredoxin reductase, apolipoprotein B mRNA editing enzyme, catalytic polypeptide-like 3C, hypothetical protein MGC5370, damage-specific DNA binding protein 2, 48 kDa, transcribed locus, papilin, proteoglycan-like sulfated glycoprotein, fucosidase, alpha-L-1, tissue, carboxypeptidase M, tumor protein p53 inducible protein 3, cyclin-dependent kinase inhibitor 1A (p21, Cip1), phosphatidylinositol glycan, class F, interleukin 6 signal transducer (gp130, oncostatin M receptor), hypothetical protein FLJ10375, vacuolar protein sorting 54 (yeast), hv89d09, interleukin 6 signal transducer (gp130, oncostatin M receptor), phosphatidylserine receptor, alpha-cardiac actin, hypothetical protein FLJ11383, ras homolog gene family, member Q, thioredoxin interacting protein, hypothetical protein LOC339290, NCK-associated protein 1, TBC1 domain family, member 17, ectodermal-neural cortex (with BTB-like domain), thioredoxin interacting protein, phosphatidylinositol glycan, class F, phosphatidylinositol glycan, class F, and solute carrier family 33 (acetyl-CoA transporter), member 1. In one embodiment, the Biomarker-1 genes are selected from the group consisting of Xeroderma pigmentosum, complementation group C, .Ferrodoxin reductase, apolipoprotein BmRNA editing enzyme, catalytic polypeptide-like 3C, hypothetical protein MGC5370, and damage-specific DNA binding protein 2.48 kDa.

In one embodiment, the set of biomarker genes used to predict genotoxicty or non-genotoxicity of compounds are in the Biomarker-2 (BM2) group. These include, but are not limited to, EST370545, H. sapiens adenosine deaminase (ADA), Homo sapiens chromosome 12 open reading frame 5 mRNA, polymerase (DNA directed), eta, isocitrate dehydrogenase 1 (NADP+), carboxypeptidase M, plexin B2, polymerase (DNA directed), eta, hypothetical protein FLJ12484, KIAA0907 protein, transcribed locus, ARP9, wb67g03, leucine-rich repeats and death domain containing potassium large conductance calcium-activated channel, subfamily M beta member 3, KAT11914, mitochondrial carrier triple repeat 1, tax1 (human T-cell leukemia virus type I) binding protein 3, sestrin 1, ret finger protein, SMAD, H. sapiens mitogen inducible gene mig-2, FLJ10378 protein, hypothetical protein MGC7036, ubiquitin-conjugating enzyme, KIAA0368, phosphatidylserine receptor, O-linked N-acetylglucosamine (GlcNAc) transferase (UDP-N-acetylglucosamine:polypeptide-N-acetylglucosaminyl transferase), Mdm2, hypothetical protein LOC51061, NudE nuclear distribution gene E homolog like 1 (A. nidulans), HTPAP protein, and syndecan 1. In one embodiment, the Biomarker-2 genes are selected from the group consisting of LAG1 longevity assurance homolog 5 (S. cerevisiae), hypothetical protein HSPC132, FKSG44 gene, adenosine deaminase, pleckstrin homology-like domain.

In one embodiment, the set of biomarker genes used to predict genotoxicty or non-genotoxicity of compounds are in the Biomarker-3 (BM3) group. These include, but are not limited to, LAG1 longevity assurance homolog 5 (S. cerevisiae), hypothetical protein HSPC132, FKSG44 gene, adenosine deaminase, pleckstrin homology-like domain, ectodermal-neural cortex (with BTB-like domain), F-box protein 22, ribonucleotide reductase M2 B (TP53 inducible), guanidinoacetate N-methyltransferase, transmembrane 7 superfamily member 3, isocitrate dehydrogenase 1 (NADP+), phosphohistidine phosphatase 1, hypothetical protein FLJ20296, discoidin domain receptor family, member 1, transcribed locus, guanidinoacetate N-methyltransferase, human receptor tyrosine kinase DDR gene, transmembrane 7 superfamily member 3, 601565341F1 NIH_MGC_{—}21 Homo sapiens cDNA clone, F-box protein 22, cytosolic sialic acid 9-O-acetylesterase homolog, BTG family member 2, astrotactin 2, IKK interacting protein, surfeit 4, neutral sphingomyelinase (N-SMase) activation associated factor, ADP-ribosylation factor-like 1, golgi reassembly stacking protein 2, leucine-rich repeats and death domain containing mixed-lineage leukemia, hypothetical protein LOC253981, placenta-specific 8, glutathione peroxidase 1, KDEL (Lys-Asp-Glu-Leu) endoplasmic reticulum protein retention receptor 2, syntaxin 7, lysosomal-associated multispanning membrane protein-5, and phosphoinositide-3-kinase catalytic alpha polypeptide. In one embodiment, the Biomarker-3 genes are selected from the group consisting of LAG1 longevity assurance homolog 5 (S. cerevisiae), hypothetical protein HSPC132, FKSG44 gene, and adenosine deaminase, pleckstrin homology-like domain.

It will be appreciated by those skilled in the art that any one set of biomarker genes, (i.e., BM1, BM2 or BM3) can be used alone, or in combination with each other. For example, genes from the BM1 group can be used in combination with genes from the BM2 group or genes form the BM3 group to predict genotoxicity of the compound.

Also within the scope of the invention is adaptation of the predictor model in which genes identified from classical genotoxicity testing can be included in the dataset to predict genotoxicity of compounds.

From the experiments conducted herewith, a number of common predictor genes have been identified that play an important role in cell cycle and DNA repair processes. A representative few are as follows:

Xeroderma Pigmentosum group C gene (XPC): The nucleotide excision repair (NER) gene XPC is a DNA damage-inducible and p53-regulated gene and likely plays a role in the p53-dependent NER pathway. XPC defect reduces the cisplatin treatment-mediated p53 response, which suggests that the XPC protein plays an important role in the cisplatin treatment-mediated cellular response. It may also suggest a possible mechanism of cancer cell drug resistance (Wang G, Dombkowski A, Chuan L; Xu XX: Cell Res. 2004 August; 14(4):303-14).

Ferredoxin Reductase (FDXR): The ferredoxin reductase gene is regulated by the p53 family and sensitizes cells to oxidative stress-induced apoptosis. It increases the sensibility of H1299 and HCT116 cells to 5-fluorouracil-, doxorubicin- and H(2)O(2)-mediated apoptosis (Liu G, Chen X.: Oncogene. 2002 Oct. 17; 21(47):7195-204). FDXR contributes to p53-mediated apoptosis through the generation of oxidative stress in mitochondria.

Apolipoprotein B mRNA editing enzyme, catalytic polypeptide-like 3C (APOBEC3C): APOBEC1 is the catalytic component of an RNA editing complex but shows homology to activation-induced cytidine deaminase (AID), a protein whose function is to potentiate diversification of immunoglobulin gene DNA. Here, we show that APOBEC1 and its homologs APOBEC3C and APOBEC3G exhibit potent DNA mutator activity in an E. coli assay. Indeed, like AID, these proteins appear to trigger DNA mutation through dC deamination. However, each protein exhibits a distinct local target sequence specificity. The results reveal the existence of a family of potential active dC/dG mutators, with possible implications for cancer (Harris R S, Petersen-Mahrt S K, Neuberger M S.: Mol Cell. 2002 November; 10(5):1247-53.)

Ribosomal Protein S27-like (RPS27L): A recessive Arabidopsis mutant with elevated sensitivity to DNA damaging treatments was identified in one out of 800 families generated by T-DNA insertion mutagenesis. The T-DNA generated a chromosomal deletion of 1287 bp in the promoter of one of three S27 ribosomal protein genes (ARS27A) preventing its expression. Seedlings of ars27A developed normally under standard growth conditions, suggesting wild-type proficiency of translation. However, growth was strongly inhibited in media supplemented with methyl methane sulfate (MMS) at a concentration not affecting the wild type. This inhibition was accompanied by the formation of tumor-like structures instead of auxiliary roots. Wild-type seedlings treated with increasing concentrations of MMS up to a lethal dose never displayed such a trait, neither was this phenotype observed in ars27A plants in the absence of MMS or under other stress conditions. Thus, the hypersensitivity and tumorous growth are mutant-specific responses to the genotoxic MMS treatment. Another important feature of the mutant is its inability to perform rapid degradation of transcripts after UV treatment, as seen in wild-type plants. Therefore, we propose that the ARS27A protein is dispensable for protein synthesis under standard conditions but is required for the elimination of possibly damaged mRNA after UV irradiation. (Revenkova E, Masson J, Koncz C, Afsar K, Jakovleva L, Paszkowski J.: Involvement of Arabidopsis thaliana ribosomal protein S27 in mRNA degradation triggered by genotoxic stress. EMBO J. 1999 Jan. 15; 18(2):490-9.)

Damage-Specific DNA binding protein 2 (DDB2): cDNA microarray analyses indicated that arsenic (AsIII) treatment decreased the expression of genes associated with DNA repair (e.g., p53 and Damage-specific DNA-binding protein 2) and increased the expression of genes indicative of the cellular response to oxidative stress (e.g., Superoxide dismutase 1, NAD(P)H quinone oxidoreductase, and Serine/threonine kinase 25). AsIII also modulated the expression of certain transcripts associated with increased cell proliferation (e.g., Cyclin G1, Protein kinase C delta), oncogenes, and genes associated with cellular transformation (e.g., Gro-1 and V-yes). These observations correlated with measurements of cell proliferation and mitotic measurements as AsIII treatment resulted in a dose-dependent increase in cellular mitoses at 24 h and an increase in cell proliferation at 48 h of exposure. (Hamadeh H K, Trouba K J, Amin R P, Afshari C A, Germolec D.: Coordination of altered DNA repair and damage pathways in arsenite-exposed keratinocytes. Toxicol Sci. 2002 October; 69(2):306-16.)

A newly identified patient with clinical xeroderma pigmentosum phenotype has a non-sense mutation in the DDB2 gene and incomplete repair in (6-4) photoproducts. (Itoh T, Mori T, Ohkubo H, Yamaizumi M. A newly identified patient with clinical xeroderma pigmentosum phenotype has a non-sense mutation in the DDB2 gene and incomplete repair in (6-4) photoproducts. J Invest Dermatol. 1999 August; 113(2):251-7.).

Cells pretreated with UV light, mitomycin C, or aphidicolin, but not TPA or serum starvation, have higher levels of this damage-specific DNA binding (DDB) protein. These results suggest that the signal for induction of DDB protein can either be damage to the DNA or interference with cellular DNA replication. The induction of DDB protein varies among primate cells with different phenotypes: (1) virus-transformed repair-proficient cells have partially or fully lost the ability to induce DDB protein above constitutive levels; (2) primary cells from repair-deficient xeroderma pigmentosum (XP) group C, and transformed XP groups A and D, show constitutive DDB protein, but do not show induced levels of this protein 48 h after UV; and (3) primary and transformed repair-deficient cells from one XP E patient are lacking both the constitutive and the induced DDB activity. The correlation between the induction of the DDB protein and the enhanced repair of UV-damaged expression vectors implies the involvement of the DDB protein in this inducible cellular response. (Protic M, Hirschfeld S, Tsang A P, Wagner M, Dixon K, Levine A S.: Induction of a novel damage-specific DNA binding protein correlates with enhanced DNA repair in primate cells. Mol Toxicol. 1989 October-December; 2(4):255-70.)

Polymerase (DNA directed), eta (POLH): UV irradiation generates predominantly cyclobutane pyrimidine dimers (CPDs) and (6-4) photoproducts in DNA. CPDs are thought to be responsible for most of the UV-induced mutations. Thymine-thymine CPDs, and probably also CPDs containing cytosine, are replicated in vivo in a largely accurate manner by a DNA polymerase eta (Pol eta) dependent process. Pol eta is encoded by the POLH (XPV) gene in humans. (Choi J H, Pfeifer G P.: The role of DNA polymerase eta in UV mutational spectra. DNA Repair (Amst). 2005 Feb. 3; 4(2):211-20.). Xeroderma pigmentosum V (XPV) is caused by molecular alterations in the POLH gene, located on chromosome 6p21.1-6p12. Affected individuals are homozygous or compound heterozygous for a spectrum of genetic lesions, including nonsense mutations, deletions or insertions, confirming the autosomal recessive nature of the condition. Identification of POLH as the XPV gene provides an important instrument for improving molecular diagnostics in XPV families. (Gratchev A, Strein P, Utikal J, Sergij G.: Molecular genetics of Xeroderma pigmentosum variant. Exp Dermatol. 2003 October; 12(5):529-36.)

Systematic analysis of nucleotide excision repair mutants demonstrate the involvement of transcription-coupled nucleotide excision repair and a partial requirement for the lesion bypass DNA polymerase eta encoded by the human POLH gene. (Zheng H, Wang X, Warren A J, Legerski R J, Nairn R S, Hamilton J W, Li L.: Nucleotide excision repair- and polymerase eta-mediated error-prone removal of mitomycin C interstrand cross-links. Mol Cell Biol. 2003 January; 23(2):754-61.)

Leucine-rich and death domain containing (LRDD): The protein encoded by this gene contains a leucine-rich repeat and a death domain. This protein has been shown to interact with other death domain proteins, such as Fas (TNFRSF6)-associated via death domain (FADD) and MAP-kinase activating death domain-containing protein (MADD), and thus may function as an adaptor protein in cell death-related signaling processes. The expression of the mouse counterpart of this gene has been found to be positively regulated by the tumor suppressor p53 and to induce cell apoptosis in response to DNA damage, which suggests a role for this gene as an effector of p53-dependent apoptosis. Three alternatively spliced transcript variants encoding distinct isoforms have been reported.

Protein phosphatase 1D magnesium-dependent, delta isoform (PPM1D): The protein encoded by this gene is a member of the PP2C family of Ser/Tbr protein phosphatases. PP2C family members are known to be negative regulators of cell stress response pathways. The expression of this gene is induced in a p53-dependent manner in response to various environmental stresses. While being induced by tumor suppressor protein TP53/p53, this phosphatase negatively regulates the activity of p38 MAP kinase, MAPK/p38, through which it reduces the phosphorylation of p53, and in turn suppresses p53-mediated transcription and apoptosis. This phosphatase thus mediates a feedback regulation of p38-p53 signaling that contributes to growth inhibition and the suppression of stress induced apoptosis. This gene is located in a chromosomal region known to be amplified in breast cancer. The amplification of this gene has been detected in both breast cancer cell line and primary breast tumors, which suggests a role of this gene in cancer development.

Tax interaction protein 1 (TIP-1): TIP-1 may represent a novel regulatory element in the Wnt/beta-catenin signaling pathway. Wnt signaling is essential during development while deregulation of this pathway frequently leads to the formation of various tumors including colorectal carcinomas. A key component of the pathway is beta-catenin that, in association with TCF-4, directly regulates the expression of Wnt-responsive genes. It was shown that overexpression of TIP-1 reduced the proliferation and anchorage-independent growth of colorectal cancer cells. [Kanamori M et al., 2003]

TBC1 domain family, member 5 (TBC1D5), hypothetical protein FLJ23311, and hypothetical protein MGC13024 have unknown function.

Tumor necrosis factor receptor superfamily, member 1B (TNFRSF1B): The protein encoded by this gene is a member of the TNF-receptor superfamily. This protein and TNF-receptor 1 form a heterocomplex that mediates the recruitment of two anti-apoptotic proteins, c-IAP1 and c-IAP2, which possess E3 ubiquitin ligase activity. The function of LAPs in TNF-receptor signalling is unknown, however, c-IAP1 is thought to potentiate TNF-induced apoptosis by the ubiquitination and degradation of TNF-receptor-associated factor 2, which mediates anti-apoptotic signals. Knockout studies in mice also suggest a role of this protein in protecting neurons from apoptosis by stimulating antioxidative pathways.

Discoidin domain receptor family, member 1 (DDR1): Receptor tyrosine kinases (RTKs) play a key role in the communication of cells with their microenvironment. These molecules are involved in the regulation of cell growth, differentiation and metabolism. The protein encoded by this gene is a RTK that is widely expressed in normal and transformed epithelial cells and is activated by various types of collagen. This protein belongs to a subfamily of tyrosine kinase receptors with a homology region to the Dictyostelium discoideum protein discoidin I in their extracellular domain. Its autophosphorylation is achieved by all collagens so far tested (type I to type VI). In situ studies and Northern-blot analysis showed that expression of this encoded protein is restricted to epithelial cells, particularly in the kidney, lung, gastrointestinal tract, and brain. In addition, this protein is significantly over-expressed in several human tumors from breast, ovarian, esophageal, and pediatric brain. This gene is located on chromosome 6p21.3 in proximity to several HLA class I genes. Three isoforms of this gene are generated by alternative splicing.

Ketohexokinase (fructokinase) (KHK): KHK encodes the gene ketohexokinase that catalyzes conversion of fructose to fructose-1-phosphate. The splice variant presented encodes the highly active form found in liver, renal cortex, and small intestine, while the alternate variant encodes the lower activity form found in most other tissues.

Sirtuin (silent mating type information regulation 2, S. cerevisiae, homolog) 3 (SIRT3): This gene encodes a member of the sirtuin family of proteins, homologs to the yeast Sir2 protein. Members of the sirtuin family are characterized by a sirtuin core domain and grouped into four classes. The functions of human sirtuins have not yet been determined; however, yeast sirtuin proteins are known to regulate epigenetic gene silencing and suppress recombination of rDNA. Studies suggest that the human sirtuins may function as intracellular regulatory proteins with mono-ADP-ribosyltransferase activity. The protein encoded by this gene is included in class I of the sirtuin family.

Transforming growth factor, beta 1 (TGFB1): Transforming growth factor TGF beta1 is involved in a variety of important cellular functions, including cell growth and differentiation, angiogenesis, immune function and extracellular matrix formation. TGF beta(1) might be associated with tumor progression by modulating the angiogenesis in colorectal cancer and TGF beta(1) may be used as a possible biomarker. World J Gastroenterol. 2002 June; 9(3):496-8.

Protein tyrosine phosphatase, non-receptor type 22 (lymphoid) (PTPN22): This gene encodes a protein tyrosine phosphatase which is expressed primarily in lymphoid tissues. This enzyme associates with the molecular adapter protein CBL and may be involved in regulating CBL function in the T-cell receptor signaling pathway. Alternative splicing of this gene results in two transcript variants encoding distinct isoforms.

Actin, alpha 2, smooth muscle, aorta (ACTA2): Actin alpha 2, the human aortic smooth muscle actin gene, is one of six different actin isoforms which have been identified. Actins are highly conserved proteins that are involved in cell motility, structure and integrity. Alpha actins are a major constituent of the contractile apparatus.

Syndecan-1 (Sdc1): Induction of syndecan-1 expression in stromal fibroblasts promotes proliferation of human breast cancer cells. Furthermore, high syndecan-1 expression in breast carcinoma is related to an aggressive phenotype and to poorer prognosis. Syndecan-1 expression in thyroid carcinoma: stromal expression followed by epithelial expression is significantly correlated with dedifferentiation.

### EXAMPLES

### Methods and Materials

(i) Chemicals, Media and Serums

All chemicals were of reagent grade (Sigma-Aldrich, St. Louis, Mo.; fluka sold through Sigma Aldrich; Lancaster Synthesis, Lancashire, UK) and were purchased as “cell culture tested” where possible. “RPMI 1640 Glutamax-I” medium, Penicillin/Streptomycin and Fetal Horse Serum were obtained from Gibco. RNeasy Mini Kits were from Qiagen.

(ii) Cell Culture

The human lymphoblastoid cell line TK6 (ATCC, Manassas, Va.) was cultured in RPMI 1640 medium (with Glutamax and 10% FHS) at a cell density of 0.2×10⁵ to 10×10⁵ cells/ml. Cells were routinely subcultured starting from frozen aliquots after passage number. For experiments, passage numbers between 3 to 15 were used.

(iii) Cytotoxicity Determination

Cytotoxic concentrations were determined either by measuring cell density on a Sysmex Cell Counter (Sysmex America, Inc., Mundelein, Ill.) or by metabolic cell activity using the Alamar Blue (Serotec Inc., Raleigh, N.C.) cytotoxicity assay. Alamar Blue indicator dye quantitatively measures proliferation in human and other cells. Alamar Blue is a sensitive fluorimetric and calorimetric reagent sensitive to the redox state of the growth medium. Cell density by Sysmex was measured after the 24 h treatment. Cytotoxicity by Alamar Blue was measured 3 hours prior to end of treatment, i.e., at 21 hours. 200 III of cell suspension were mixed with 20 μl of Alamar Blue reagent in a 96-well plate and measured once/hour using a fluorescence plate reader with 544 nm excitation and 612 nm emission filters. Cell suspension samples from the cytotoxicity dilution series were analyzed for cytometry endpoints by Laser Scanning Cytometry.

(iv) Treatment Of Cell Cultures

TK6 human lymphoblastoid cells were exposed to following treatments (24 hours, 0.15×10⁶ cells/ml):

TABLE 1
Study design

| Class | Compound | Abbreviation | Dose, μg/mL | # of Samples |
|---|---|---|---|---|
| Control | None | | | 6 |
| Cytotoxic | NaCl | NaCl | 3,840 | 6 |
| | trans-Platinum | tPt | 33 | 6 |
| | Rifampicin | Rif | 167 | 6 |
| Genotoxic | cis-Platinum | cPt | 1.3 | 6 |
| | Methyl Methane | MMS | 6.25 | 6 |
| | Sulfonate | | | |
| | Mitomycin C | MMC | 0.10 | 6 |

In Table 1, trans-Platinum is trans-diammineplatinum(II) dichloride and cis-Platinum is cis-diammineplatinum(II) dichloride. Dose-response determination to provide the doses given in column 4 of Table 1 was carried out with an initial cell density of 0.15×10⁶ cells/ml (see Example 1).

(v) RNA Isolation

Total RNA was isolated after 24 hours of treatment with the agents or control using Qiagen's (Hilden, Germany) RNeasy Mini Kits. Samples were made up of 10 ml TK6 cell suspensions with an approximate cell density of 0.3×10⁶ cells/ml. Column-purified RNA was eluted with 40 μl water and quality-checked by UV spectrometry and Agilent's “lab-on-a-chip” technology (RNA nano chip, Bioanalyzer 2100, Agilent Technologies, Santa Clara, Calif.). RNA extraction and purification is described by the manufacturer of the GeneChip system.

(vi) Microarray Hybridization

D1 examples 1-7, DNA microarray experiments were conducted for Examples 1-7 as recommended by the manufacturer of the GeneChip system (Affymetrix, Inc. 2002) and as previously described (Lockhart et al. 1996). Purified total human TK6 RNA was analyzed using the human specific Human Genome U133, 2.0 array (Affymetrix). The Human Genome U133A 2.0 array covers approximately 18,400 transcripts and variants, including 14,500 well-characterized human genes represented by more than 22,000 probe sets. Sequences used in the design of the array were selected from GenBank®, dbEST, and RefSeq. The sequence clusters were created from the UniGene database (Build 133, Apr. 20, 2001) and then were refined by analysis and comparison with a number of other publicly available databases including the Washington University EST trace repository and the University of California, Santa Cruz Golden-Path human genome database (April 2001 release).

For experiments conducted in Example 8, the Human Genome U133 Plus 2.0 array was used. This array covers more than 47,000 transcripts in more than 54,000 probe sets. The sequences from which these probe sets were derived were selected from GenBank®, dbEST, and RefSeq. The sequence clusters were created from the UniGene database (Build 133, April 20, 2001) and then refined by analysis and comparison with a number of other publicly available databases, including the Washington University EST trace repository and the University of California, Santa Cruz Golden-Path human genome database (April 2001 release). In addition, it contains 9,921 probe sets representing approximately 6,500 genes based on sequences selected from GenBank, dbEST, and RefSeq. Sequence clusters were created from the UniGene database (Build 159, Jan. 25, 2003) and refined by analysis and comparison with a number of other publicly available databases, including the Washington University EST trace repository and the NCBI human genome assembly (Build 31).

The resulting primary raw data, the image files (.dat files), were processed using the Microarray Analysis Suite 5 (MAS5) software (Affymetrix). Tab-delimited files were obtained containing data regarding signal intensity (Signal) and categorical expression level measurement (Absolute Call).

(vii) Microarray Data Analysis

MAS5-derived raw data was analyzed using Simca-P 10.5/GeneSpring 7.2.

Simca-P 10.5/GeneSpring 7.2

The “Simca-P 10.5/GeneSpring 7.2” approach combined the statistical tools of the SIMCA-P 10.5 software (Umetrics AB, S-Umea) with GeneSpring 7.2. The raw data obtained from the GeneChip by MAS5 were imported to GeneSpring 7.2 for analysis. Data were normalized per chip and per gene to the respective median. Genes were annotated according to LocusLink nomenclature (http://www.ncbi.nlm.nih.gov/LocusLink/).

For the development of a model being capable of differentiating the two classes of toxicity only samples treated with cytotoxic and genotoxic compounds were included in the analysis: control samples were excluded from the analysis. Filtering of the data was performed according to following criteria for each gene:

Fold-change>1.4 OR Fold-change<0.7; AND

Signal Mean(cytotoxic)>50 OR Signal Mean(genotoxic)>50; AND

Signal CV(cytotoxic)<50% AND Signal CV(genotoxic)<50%; where CV is the coefficient of variation.

Fold-change refers to the ratio of genotoxic versus cytotoxic. Since these studies seek robust predictor genes the limit ratios (1.4 and 0.7) were selected in order to excluded genes that show consistent but only small differences. Furthermore, the mean signal of at least one of the two classes should show a reliable signal with intensity greater than 50, and the coefficient of variation of gene expression signals within each class should be smaller than 50% in order to exclude highly variable genes. The filtering was performed by Microsoft Excel 2002 SP 2. 215 genes resulted from the filtering analysis.

After data filtering, two predictive modeling approaches were applied, the partial least squares—discriminant analysis and the k-nearest neighbor analysis.

Partial Least Squares—Discriminant Analysis (PLS-DA); all calculations were performed by the software package SIMCA-P version 10 (Umetrics AB, Umea, Sweden).

Raw gene expression intensities of the 215 genes were log-transformed, centered and scaled to uni-variance. Principal Component Analysis (PCA) was applied to the data to check their relative position in a low-dimensional space and to investigate the impact of cell count and Alamar Blue on their relative position.

PLS-DA was applied iteratively to the gene expression data with cyto- and genotcoxicity as class variables. The evaluation of the differential gene pattern between the mean scores of either class identified the genes that contributed significantly to the separation. With each iteration the predictive model was cross-validated by a leave-one-out approach (LOO). The final model was validated by response permutation; i.e. the class membership of each sample was randomly attributed, evaluated by the model and contrasted to the solution of the model with the original class membership. 100 permutations were performed.

The second approach of predictive modeling was performed by k-nearest neighbor (KNN) analysis (GeneSpring 7.2). The same 215 candidate genes that were used for PLS-DA were used in this approach. Due to the limited sample size the composition of the calibration sample set and test sample set were permutated several times.

The intersection of predictor genes resulting from PLS-DA and the k-nearest neighbor approach were subjected to PLS-DA and a condition clustering (GeneSpring 7.2) in order to investigate the predictive power of the selected genes.

For the experiments conducted in Example 8, the following procedure was used: Normalization: Per chip: normalization on sample median. Per gene: normalization on gene median of all samples (Genespring 7.2).

Pre-Filtering of Genes: Filter on flags: probe set needs to show present or marginal flags in at least 50% of samples and filter on intensities: probe set must have intensities>50 in at least 50% of samples resulting in 18′512 probe sets (Genespring 7.2).

Statistical Filtering: Welch t-test (Genespring 7.2): All (98) Samples Default Interpretation—Genes from Present and signal GT 50 in 50% of samples with statistically significant differences when grouped by ‘Class (non-genotoxic versus gtx)’; parametric test, variances not assumed equal (Welch t-test). p-value cutoff 0.001, multiple testing correction: Benjamini and Hochberg False Discovery Rate (FDR). This restriction tested 18′512 genes About 0.1% of the identified genes would be expected to pass the restriction by chance. 4′9 11 probe sets passed this filter. Given a FDR of 0.1% 5 out of 4911 would be expected to be falsely positive.

### Example 1

### Determination of Cytotoxicity and G2 Phase Block

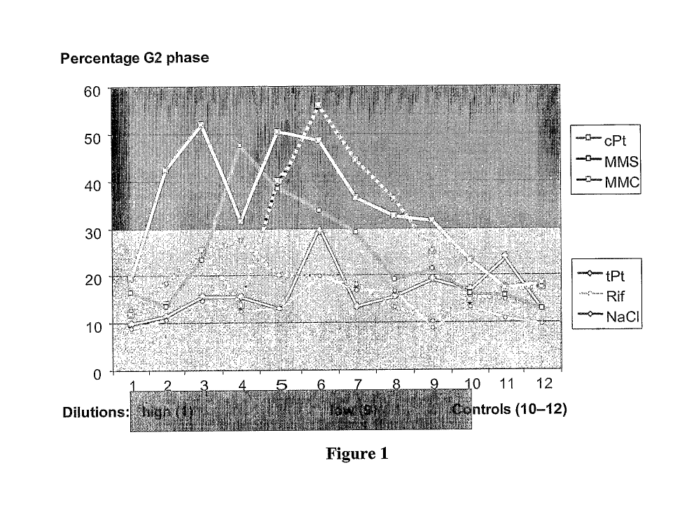

The six model compounds identified in Table 1 were applied in a dilution series to TK6 cells. The resulting dilution series for each of the six compounds provided individually optimized cytotoxic concentrations for 50% cell death (EC₅₀) as determined by cell density and the Alamar Blue assay. These data are shown in FIG. 1 and Table 2. It is possible that cell density and the Alamar Blue assay may not give identical cytotoxicity profiles. Thus, concentrations of the compounds were optimized with the objective to have both cytotoxicity parameters within the range of 40-60% viability decrease. In addition, for representative dilution series several cytometry endpoints were analyzed (BrdU incorporation, KI-67 staining (Histogenex, Edegem, Belgium), propidium iodide staining), although these parameters were not used for concentration selection.

TABLE 2

| | | Cell Density | Alamar Blue |
|---|---|---|---|
| Class | Compounds or Drugs | (±S.D.) | (±S.D.) |
| Non-genotoxic | trans-Platinum | 58 ± 7% | 36 ± 13% |
| | Rifampicin | 52 ± 9% | 61 ± 8% |
| | NaCl | 30 ± 4% | 65 ± 5% |
| Genotoxic | cis-Platinum | 53 ± 4% | 46 ± 5% |
| | Mitomycin C | 53 ± 3% | 48 ± 1% |
| | Methyl methanesulfonate | 44 ± 2% | 43 ± 8% |

The three non-genotoxic compounds tPt, Rif and NaCl belong to relatively diverse compound classes. Consequently, the most pronounced effects and finally the crucial mode-of-actions leading to strong cytotoxicity may be totally different. This situation is reflected by the obtained cytotoxicity profiles. The approximated EC₅₀ values range between 33 μM and 3.8 mM, similarly, the sensitivity of cell density and the redox endpoint (Alamar Blue) is compound dependent. Up to the ascertained EC₅₀ values no significant shifts in cell cycle parameters were detected (FIG. 1), concluding that none of the three compounds had specific impact on regulatory pathways of the cell cycle.

Compared with this the three genotoxic compounds had significantly lower EC₅₀ values (ranging between 0.10 μM and 6.3 μM) and led to remarkable shifts in cell cycle parameters. The most outstanding effect is an obvious G₂ phase block with estimated maxima around the EC₅₀ values, indicating DNA repair activity (FIG. 1). This observation is in accordance with the fundamental hypothesis, that within this cellular model system an adaptive response as an answer to the exogenous genotoxic stress will occur. Fortunately, this is already visible on the cytometry level.

### Example 2

### Identification of Candidate Predictor Genes

For experiments leading to hybridization of RNA to human genomic probes, concentrations of the compounds as specified in Table 1 were used (Example 1). These concentrations are equicytotoxic (e.g., cPt: 1.3 μM, and tPt: 33 μM). Each compound was tested using six independent replicates on two or three different dates. After isolation of total RNA expression profiles were compiled using Affymetrix HGU133A PLUS 2 microarrays

As noted in Materials and Methods, one vehicle, three cytotoxic reagents and three genotoxic reagents were used to treat TK6 cells. Each of the replicate samples was applied to an Affymetrix HGU133A chip for hybridization and detection of the results. These data were filtered for fold-change, signal mean, and signal CV as described in Materials and Methods. Only 215 genes passed this rigorous filter process. These filtered genes are compiled in Table 3.

TABLE 3
215 GENES FROM FILTERING

| LOCUS- | | | | |
|---|---|---|---|---|
| LINK | GENBANK | REFSEQ | UNIGENE | GENENAME |
| 23498 | BC029510, BC029510, NM_012205, | NM_012205.1 | Hs.108441 | 3-hydroxyanthranilate |
| | Z29481 | | | 3,4-dioxygenase |
| 27301 | AB021260, AB021260, AB049211, | NM_014481.2 | Hs.154149 | APEX nuclease |
| | AF119046, AJ011311, BC002959, | | | (apurinic/apyrimidinic |
| | BI837686 | | | endonuclease) 2 |
| 10058 | AB039371, AB039371, AF070598, | NM_005689.1 | Hs.107911 | ATP-binding cassette, |
| | AF076775, AF308472, AJ289233, | | | sub-family B |
| | AK057026, BC000559, BC043423, | | | (MDR/TAP), member 6 |
| | NM_005689 | | | |
| 489 | AF068220, AF068220, AF068221, | NM_005173.2, | Hs.5541 | ATPase, Ca++ |
| | AF458228, AF458229, BC035729, | NM_005173.2, | | transporting, ubiquitous |
| | NM_005173, NM_174953, | NM_174955.1, | | |
| | NM_174954, NM_174955, | NM_174953.1, | | |
| | NM_174956, NM_174957, | NM_174954.1, | | |
| | NM_174958, S68239, Y15724, | NM_174956.1, | | |
| | Y15737, Y15738, Z69880, Z69881 | NM_174958.1 | | |
| 694 | BC009050, BC009050, BC016759, | NM_001731.1 | Hs.255935 | B-cell translocation gene |
| | BC064953, NM_001731, X61123 | | | 1, anti-proliferative |
| 27113 | AF332558, AF332558, AF354654, | NM_014417.2 | Hs.87246 | BCL2 binding component 3 |
| | AF354655, AF354656, NM_014417 | | | |
| 581 | AF007826, AF007826, AF008195, | NM_004324.3, | Hs.159428 | BCL2-associated X |
| | AF008196, AF020360, AF247393, | NM_004324.3, | | protein |
| | AF339054, AJ417988, BC014175, | NM_138762.2, | | |
| | BE396495, BM706954, L22473, | NM_138764.2, | | |
| | L22474, L22475, NM_004324, | NM_138765.2, | | |
| | NM_138761, NM_138762, | NM_138763.2 | | |
| | NM_138763, NM_138764, | | | |
| | NM_138765, U19599 | | | |
| 581 | AF007826, AF007826, AF008195, | NM_004324.3, | Hs.159428 | BCL2-associated X |
| | AF008196, AF020360, AF247393, | NM_004324.3, | | protein |
| | AF339054, AJ417988, BC014175, | NM_138762.2, | | |
| | BE396495, BM706954, L22473, | NM_138764.2, | | |
| | L22474, L22475, NM_004324, | NM_138765.2, | | |
| | NM_138761, NM_138762, | NM_138763.2 | | |
| | NM_138763, NM_138764, | | | |
| | NM_138765, U19599 | | | |
| 580 | AF038034, AF038034, AF038035, | NM_000465.1 | Hs.54089 | BRCA1 associated RING |
| | AF038036, AF038037, AF038038, | | | domain 1 |
| | AF038039, AF038040, AF038041, | | | |
| | AF038042, NM_000465, U76638 | | | |
| 7832 | AF361937, AF361937, NM_006763, | NM_006763.2 | Hs.75462 | BTG family, member 2 |
| | U72649, Y09943 | | | |
| 7832 | AF361937, AF361937, NM_006763, | NM_006763.2 | Hs.75462 | BTG family, member 2 |
| | U72649, Y09943 | | | |
| 585 | AF090947, AF090947, AF359281, | NM_033028.2 | Hs.26471 | Bardet-Biedl syndrome 4 |
| | AK075321, BC008923, BC027624, | | | |
| | BI562463, BX647855, NM_033028 | | | |
| 641 | BC034480, BC034480, NM_000057, | NM_000057.1 | Hs.383913 | Bloom syndrome |
| | U39817 | | | |
| 9738 | AB007879, AB007879, AC003108, | NM_014711.3 | Hs.279912 | CP110 protein |
| | BC030223, BC034140, BC036654, | | | |
| | NM_014711 | | | |
| 1663 | AK021703, AK021703, BC001591, | NM_004399.1, | Hs.443960 | DEAD/H (Asp-Glu-Ala- |
| | BC011264, BC012834, BC047317, | NM_004399.1, | | Asp/His) box polypeptide |
| | BC050069, BC050522, NM_004399, | NM_030655.2 | | 11 (CHL1-like helicase |
| | NM_030653, NM_030655, U33833, | | | homolog, S. cerevisiae) |
| | U35241, U75967, U75968, U75969 | | | |
| 1663 | AK021703, AK021703, BC001591, | NM_004399.1, | Hs.443960 | DEAD/H (Asp-Glu-Ala- |
| | BC011264, BC012834, BC047317, | NM_004399.1, | | Asp/His) box polypeptide |
| | BC050069, BC050522, NM_004399, | NM_030655.2 | | 11 (CHL1-like helicase |
| | NM_030653, NM_030655, U33833, | | | homolog, S. cerevisiae) |
| | U35241, U75967, U75968, U75969 | | | |
| 55247 | AB079071, AB079071, AK001720, | NM_018248.1 | Hs.405467 | DNA glycosylase hFPG2 |
| | BC025954 | | | |
| 81620 | AB053172, AB053172, AF070552, | NM_030928.2 | Hs.122908 | DNA replication factor |
| | AF321125, BC000137, BC008676, | | | |
| | BC008860, BC009410, BC014202, | | | |
| | BC021126, BC049205 | | | |
| 1870 | AF086395, AF086395, AK092799, | NM_004091.2 | Hs.231444 | E2F transcription factor 2 |
| | BC007609, BC053676, L22846, | | | |
| | NM_004091 | | | |
| 23770 | AC005387, AC005387, AY225339, | NM_012181.2 | Hs.173464 | FK506 binding protein 8, |
| | BC009966, BX538124, BX647405, | | | 38 kDa |
| | BX647720, L37033, NM_012181 | | | |
| 79733 | AK026964, AK026964, AK055206, | NM_024680.2 | Hs.94292 | FLJ23311 protein |
| | BC028244, BU164108, BX504614, | | | |
| | CB959621 | | | |
| 2491 | BC005967, BC005967, BC012462, | NM_006733.2 | Hs.348920 | FSH primary response |
| | BG114761, BQ224168, M78295, | | | (LRPR1 homolog, rat) 1 |
| | NM_006733, X97249 | | | |
| 2842 | AK074729, AK074729, NM_006143, | NM_006143.1 | Hs.92458 | G protein-coupled |
| | U55312, U64871 | | | receptor 19 |
| 2760 | AF173832, AF173832, BC009273, | NM_000405.3 | Hs.387156 | GM2 ganglioside |
| | BX473154, L01439, M76477, | | | activator protein |
| | NM_000405, X16087, X61094, | | | |
| | X61095, X62078 | | | |
| 29893 | AB030304, AB030304, AK126369, | NM_013290.3, | Hs.279032 | GT198, complete ORF |
| | BC008792, NM_013290, NM_016556 | NM_013290.3 | | |
| 11147 | AF126163, AF126163, AF126164, | NM_007071.1 | Hs.142245 | HERV-H LTR- |
| | BC010922 | | | associating 3 |
| 283638 | AB006622, AB006622, AK025023, | XM_208766.3 | Hs.182536 | KIAA0284 |
| | AK091980, BC047913 | | | |
| 23354 | AB020648, AB020648, BC013947 | XM_049237.6 | Hs.7426 | KIAA0841 |
| 22889 | AB020714, AB020714, AY112680, | | Hs.24656 | KIAA0907 protein |
| | AY112681, AY112682, BC027182 | | | |
| 79682 | AA761728, AA761728, AF469667, | NM_024629.2 | Hs.38178 | KSHV latent nuclear |
| | AK027121, BC031520, BG031878, | | | antigen interacting protein 1 |
| | BQ185248, BX355581 | | | |
| 3985 | AB016655, AB016655, AB016656 | NM_005569.2, | Hs.278027 | LIM domain kinase 2 |
| | AC002073, AK093554, AL117466, | NM_005569.2 | | |
| | BC013051, D45906, D85527, | | | |
| | NM_005569, NM_016733 | | | |
| 7805 | D42042, D42042, NM_006762, | NM_006762.1 | Hs.436200 | Lysosomal-associated |
| | U51240 | | | multispanning membrane |
| | | | | protein-5 |
| 7805 | D42042, D42042, NM_006762, | NM_006762.1 | Hs.436200 | Lysosomal-associated |
| | U51240 | | | multispanning membrane |
| | | | | protein-5 |
| 83463 | AF114834, AF114834, AK057034, | NM_031300.2 | Hs.442993 | MAX dimerization |
| | AL833959, BC000745, BC032586, | | | protein 3 |
| | BC041690 | | | |
| 4173 | AK022899, AK022899, BC031061, | NM_005914.2, | Hs.460184 | MCM4 minichromosome |
| | BM781972, BQ058022, NM_005914, | NM_005914.2 | | maintenance deficient 4 |
| | NM_182746, U63630, U90415, | | | (S. cerevisiae) |
| | X74794 | | | |
| 4276 | AK094237, AK094237, AY204547, | NM_000247.1 | Hs.90598 | MHC class I polypeptide- |
| | BC016929, L14848, NM_000247, | | | related sequence A |
| | U56940, U56941, U56942, U56943, | | | |
| | U56944, U56946, U56947, U56948, | | | |
| | U56950, U56951, U56952, U56953, | | | |
| | U56954, X92841, Y16805, Y16806, | | | |
| | Y16808, Y16810 | | | |
| 123803 | AF092440, AF092440, BC017336 | NM_173474.2 | Hs.351573 | N-terminal asparagine |
| | | | | amidase |
| 79671 | AB094095, AB094095, AK025131, | NM_024618.2, | Hs.31097 | NOD9 protein |
| | AK056454, AK095247, AL049456, | NM_024618.2 | | |
| | BC013199, BC023974, BK001111, | | | |
| | BX647705, NM_024618 | | | |
| 4851 | AF308602, AF308602, AK000012, | NM_017617.2 | Hs.311559 | Notch homolog 1, |
| | BC013208, BC032414, M73980, | | | translocation-associated |
| | NM_017617 | | | (Drosophila) |
| 8438 | AA582917, AA582917, BM464345, | NM_003579.2 | Hs.66718 | RAD54-like (S. cerevisiae) |
| | NM_003579 | | | |
| 5875 | AL547259, AL547259, AU125148, | NM_004581.2, | Hs.377992 | Rab |
| | BC003093, CB995791, CD370056, | NM_004581.2 | | geranylgeranyltransferase, |
| | CD672493, NM_004581, NM_182836, | | | alpha subunit |
| | Y08200 | | | |
| 6955 | M12423, M12423, X01403, X02592 | | | T cell receptor alpha locus |
| 10312 | AF025374, AF025374, AF033033, | NM_006019.2, | Hs.46465 | T-cell, immune regulator |
| | AW083897, BC018133, BC032465, | NM_006019.2 | | 1, ATPase, H+ |
| | NM_006019, NM_006053, U45285 | | | transporting, lysosomal |
| | | | | V0 protein a isoform 3 |
| 9779 | AK097990, AK097990, BC013145, | | Hs.115740 | TBC1 domain family, |
| | D86965 | | | member 5 |
| 7071 | AF050110, AF050110, BC011538, | NM_005655.1 | Hs.82173 | TGFB inducible early |
| | BT006634, NM_005655, S81439, | | | growth response |
| | U21847 | | | |
| 9618 | AF082185, AF082185, BC001769, | NM_004295.2, | Hs.8375 | TNF receptor-associated |
| | BC026726, BC047358, NM_004295, | NM_004295.2 | | factor 4 |
| | NM_145751, X80200 | | | |
| 9618 | AF082185, AF082185, BC001769, | NM_004295.2, | Hs.8375 | TNF receptor-associated |
| | BC026726, BC047358, NM_004295, | NM_004295.2 | | factor 4 |
| | NM_145751, X80200 | | | |
| 11257 | AB007455, AB007455, AB007456, | NM_007233.1 | Hs.274329 | TP53 activated protein 1 |
| | AB007457, BC002709 | | | |
| 11257 | AB007455, AB007455, AB007456, | NM_007233.1 | Hs.274329 | TP53 activated protein 1 |
| | AB007457, BC002709 | | | |
| 30851 | AF028823, AF028823, AF168787, | NM_014604.1 | Hs.12956 | Tax interaction protein 1 |
| | AF234997, AF277318, AK001327, | | | |
| | BC023980, NM_014604 | | | |
| 30851 | AF028823, AF028823, AF168787, | NM_014604.1 | Hs.12956 | Tax interaction protein 1 |
| | AF234997, AF277318, AK001327, | | | |
| | BC023980, NM_014604 | | | |
| 7454 | AF115548, AF115548, AF115549, | NM_000377.1 | Hs.2157 | Wiskott-Aldrich |
| | AF196970, BC002961, BC012738, | | | syndrome (eczema- |
| | NM_000377, U12707, U18935, | | | thrombocytopenia) |
| | U19927 | | | |
| 59 | BC017554, BC017554, D00618, | NM_001613.1 | Hs.208641 | actin, alpha 2, smooth |
| | J05192, K01741, K01742, K01743, | | | muscle, aorta |
| | K01744, K01745, K01746, K01747, | | | |
| | M33216, NM_001613, X13839 | | | |
| 100 | AL832305, AL832305, BC007678, | NM_000022.1 | Hs.407135 | adenosine deaminase |
| | BC040226, K00509, K02567, M13792, | | | |
| | NM_000022, X02994, Z97053 | | | |
| 375790 | AF016903, AF016903, AK021586, | | Hs.273330 | agrin |
| | AK125197, AK128761, BC004220, | | | |
| | BC007649, BC034009, BC063620, | | | |
| | S44195 | | | |
| 286 | BC007930, BC007930, BC014467, | NM_000037.2, | Hs.443711 | ankyrin 1, erythrocytic |
| | BC030957, M28880, NM_000037, | NM_000037.2, | | |
| | NM_020475, NM_020476, | NM_020478.1, | | |
| | NM_020477, NM_020478, | NM_020480.1, | | |
| | NM_020479, NM_020480, | NM_020481.1, | | |
| | NM_020481, S82671, U49691, | NM_020479.1, | | |
| | U50092, U50133, X16609 | NM_020477.1, | | |
| | | NM_020475.1 | | |
| 286 | BC007930, BC007930, BC014467, | NM_000037.2, | Hs.443711 | ankyrin 1, erythrocytic |
| | BC030957, M28880, NM_000037, | NM_000037.2, | | |
| | NM_020475, NM_020476, | NM_020478.1, | | |
| | NM_020477, NM_020478, | NM_020480.1, | | |
| | NM_020479, NM_020480, | NM_020481.1, | | |
| | NM_020481, S82671, U49691, | NM_020479.1, | | |
| | U50092, U50133, X16609 | NM_020477.1, | | |
| | | NM_020475.1 | | |
| 25959 | AB040951, AB040951, AK000011, | NM_015493.3, | Hs.284208 | ankyrin repeat domain 25 |
| | AK002094, AK023332, AL117489, | NM_015493.3 | | |
| | AL701379, BC030030, BC032745, | | | |
| | BC049201, BQ631109, NM_015493 | | | |
| 9582 | AK024854, AK024854, BC031803, | NM_004900.3 | Hs.226307 | apolipoprotein B mRNA |
| | BC053859, NM_004900, U61083, | | | editing enzyme, catalytic |
| | U61084 | | | polypeptide-like 3B |
| 27350 | AF165520, AF165520, BC011739, | NM_014508.2 | Hs.441124 | apolipoprotein B mRNA |
| | BC021080, NM_014508 | | | editing enzyme, catalytic |
| | | | | polypeptide-like 3C |
| 60489 | AF182420, AF182420, AK022802, | NM_021822.1 | Hs.286849 | apolipoprotein B mRNA |
| | AK092614, AK093635, BC009683, | | | editing enzyme, catalytic |
| | BC024268 | | | polypeptide-like 3G |
| 29108 | AB023416, AB023416, AF184072, | NM_013258.3, | Hs.197875 | apoptosis-associated |
| | AF184073, AF255794, AF310103, | NM_013258.3, | | speck-like protein |
| | AF384665, AK000211, BC004470, | NM_145182.1 | | containing a CARD |
| | BC013569, NM_013258, NM_145182, | | | |
| | NM_145183 | | | |
| 23621 | AB032975, AB032975, AB050436, | NM_012104.2, | Hs.49349 | beta-site APP-cleaving |
| | AB050437, AB050438, AF161367, | NM_012104.2, | | enzyme |
| | AF190725, AF200193, AF200343, | NM_138971.1, | | |
| | AF201468, AF204943, AF338816, | NM_138972.1 | | |
| | AF338817, AL833810, BC036084, | | | |
| | BC065492, BM996673, NM_012104, | | | |
| | NM_138971, NM_138972, | | | |
| | NM_138973 | | | |
| 649 | BC002593, BC002593, BC009305, | NM_001199.1, | Hs.1274 | bone morphogenetic |
| | BC032105, BC044626, L35278, | NM_001199.1, | | protein 1 |
| | L35279, M22488, NM_001199, | NM_006132.1, | | |
| | NM_006128, NM_006129, | NM_006131.1, | | |
| | NM_006130, NM_006131, | NM_006128.1, | | |
| | NM_006132, U50330, Y08723, | NM_006130.1 | | |
| | Y08724, Y08725 | | | |
| 675 | NM_000059, NM_000059, U43746, | NM_000059.1 | Hs.34012 | breast cancer 2, early |
| | X95152, Z73359, Z74739 | | | onset |
| 634 | AC004785, AC004785, AL833584, | NM_001712.2 | Hs.512682 | carcinoembryonic |
| | BC014473, BC024164, D12502, | | | antigen-related cell |
| | D90311, D90312, D90313, J03858, | | | adhesion molecule 1 |
| | M69176, M72238, M76742, | | | (biliary glycoprotein) |
| | NM_001712, S71326, X14831, | | | |
| | X16354, X16356 | | | |
| 634 | AC004785, AC004785, AL833584, | NM_001712.2 | Hs.512682 | carcinoembryonic |
| | BC014473, BC024164, D12502, | | | antigen-related cell |
| | D90311, D90312, D90313, J03858, | | | adhesion molecule 1 |
| | M69176, M72238, M76742, | | | (biliary glycoprotein) |
| | NM_001712, S71326, X14831, | | | |
| | X16354, X16356 | | | |
| 834 | BC041689, BC041689, BC062327, | NM_001223.2, | Hs.2490 | caspase 1, apoptosis- |
| | M87507, NM_001223, NM_033292, | NM_001223.2, | | related cysteine protease |
| | NM_033293, NM_033294, | NM_033293.1, | | (interleukin 1, beta, |
| | NM_033295, U13697, U13698, | NM_033294.1, | | convertase) |
| | U13699, U13700, X65019 | NM_033295.1 | | |
| 56998 | AB021262, AB021262 | NM_020248.1 | Hs.108222 | catenin, beta interacting |
| | | | | protein 1 |
| 9744 | BC018543, BC018543, BT009788, | NM_014716.2 | Hs.337242 | centaurin, beta 1 |
| | D30758, NM_014716 | | | |
| 56997 | AB073905, AB073905, AJ278126, | NM_020247.3 | Hs.273186 | chaperone, ABC1 activity |
| | AK074693, AK090494, AK092784, | | | of bc1 complex like (S. pombe) |
| | AK126200, AK126466, BC005171, | | | |
| | BX648860, NM_020247 | | | |
| 8973 | AB079246, AB079246, AB079247, | NM_004198.2 | Hs.103128 | cholinergic receptor, |
| | AB079248, AB079249, AB079250, | | | nicotinic, alpha |
| | AB079251, BC014456, NM_004198, | | | polypeptide 6 |
| | U62435, Y16282 | | | |
| 57103 | AJ272206, AJ272206, AY425618, | NM_020375.1 | Hs.24792 | chromosome 12 open |
| | BC012340 | | | reading frame 5 |
| 79144 | AK024699, AK024699, AL121829, | NM_024299.2 | Hs.79625 | chromosome 20 open |
| | BC002531, BC056416, NM_024299 | | | reading frame 149 |
| 54535 | AB029331, AB029331, AB029343, | NM_019052.2 | Hs.110746 | chromosome 6 open |
| | AB112474, AB112475, AC004195, | | | reading frame 18 |
| | AF216493, AK000204, AK000217, | | | |
| | AK000533, AY029160 | | | |
| 55602 | AF246705, AF246705, AK000043, | NM_017632.1 | Hs.32922 | collaborates/cooperates |
| | AK096180, BC022270, BX538162 | | | with ARF (alternate |
| | | | | reading frame) protein |
| 1435 | BC021117, BC021117, M11038, | NM_000757.3, | Hs.173894 | colony stimulating factor |
| | M11295, M11296, M27087, M37435, | NM_000757.3, | | 1 (macrophage) |
| | M64592, M76453, NM_000757, | NM_172212.1, | | |
| | NM_172210, NM_172211, | NM_172211.1 | | |
| | NM_172212, U22386, X05825 | | | |
| 727 | AV682721, AV682721, BC022299, | NM_001735.2 | Hs.1281 | complement component 5 |
| | BG533927, CB250401, M57729, | | | |
| | M65134, NM_001735, T82068 | | | |
| 9134 | AA830205, AA830205, AF091433, | NM_004702.2, | Hs.408658 | cyclin E2 |
| | AF102778, AF106690, AF112857, | NM_004702.2, | | |
| | BC007015, BC020729, BG720611, | NM_057735.1 | | |
| | NM_004702, NM_057735, | | | |
| | NM_057749 | | | |
| 26999 | AB032994, AB032994, AF132197, | NM_014376.1, | Hs.211201 | cytoplasmic FMR1 |
| | AF160973, AL136549, AL161999, | NM_014376.1 | | interacting protein 2 |
| | BC011762, BC021008, BC026892, | | | |
| | L47738, NM_014376 | | | |
| 26999 | AB032994, AB032994, AF132197, | NM_014376.1, | Hs.211201 | cytoplasmic FMR1 |
| | AF160973, AL136549, AL161999, | NM_014376.1 | | interacting protein 2 |
| | BC011762, BC021008, BC026892, | | | |
| | L47738, NM_014376 | | | |
| 26999 | AB032994, AB032994, AF132197, | NM_014376.1, | Hs.301824 | cytoplasmic FMR1 |
| | AF160973, AL136549, AL161999, | NM_014376.1 | | interacting protein 2 |
| | BC011762, BC021008, BC026892, | | | |
| | L47738, NM_014376 | | | |
| 26999 | AB032994, AB032994, AF132197, | NM_014376.1, | Hs.301824 | cytoplasmic FMR1 |
| | AF160973, AL136549, AL161999, | NM_014376.1 | | interacting protein 2 |
| | BC011762, BC021008, BC026892, | | | |
| | L47738, NM_014376 | | | |
| 55526 | AA009773, AA009773, AA393480, | NM_018706.4 | Hs.501565 | dehydrogenase E1 and |
| | AL359587, BC002477, BC007955, | | | transketolase domain |
| | BG469693, BI333272, BQ420710, | | | containing 1 |
| | BU187564, BU855972, BU927608, | | | |
| | CB134342, CF593518, NM_018706 | | | |
| 1831 | AB025432, AB025432, AF153603, | NM_004089.2, | Hs.420569 | delta sleep inducing |
| | AF183393, AF228339, AK092645, | NM_004089.2 | | peptide, immunoreactor |
| | AK092669, AK127938, AL110191, | | | |
| | AY007119, BC018148, BM047061, | | | |
| | BX647854, NM_004089, NM_198057, | | | |
| | Z50781 | | | |
| 1719 | BC000192, BC000192, BC003584, | NM_000791.2 | Hs.464813 | dihydrofolate reductase |
| | BC009634, J00139, J00140, | | | |
| | NM_000791, V00507, X00855 | | | |
| 1719 | BC000192, BC000192, BC003584, | NM_000791.2 | Hs.83765 | dihydrofolate reductase |
| | BC009634, J00139, J00140, | | | |
| | NM_000791, V00507, X00855 | | | |
| 780 | AK130776, AK130776, BC008716, | NM_001954.3, | Hs.423573 | discoidin domain receptor |
| | BC013400, L11315, L20817, L57508, | NM_001954.3, | | family, member 1 |
| | NM_001954, NM_013993, | NM_013993.1 | | |
| | NM_013994, U48705, X74979, | | | |
| | X98208, X99031, Z29093 | | | |
| 780 | AK130776, AK130776, BC008716, | NM_001954.3, | Hs.423573 | discoidin domain receptor |
| | BC013400, L11315, L20817, L57508, | NM_001954.3, | | family, member 1 |
| | NM_001954, NM_013993, | NM_013993.1 | | |
| | NM_013994, U48705, X74979, | | | |
| | X98208, X99031, Z29093 | | | |
| 780 | AK130776, AK130776, BC008716, | NM_001954.3, | Hs.423573 | discoidin domain receptor |
| | BC013400, L11315, L20817, L57508, | NM_001954.3, | | family, member 1 |
| | NM_001954, NM_013993, | NM_013993.1 | | |
| | NM_013994, U48705, X74979, | | | |
| | X98208, X99031, Z29093 | | | |
| 780 | AK130776, AK130776, BC008716, | NM_001954.3, | Hs.423573 | discoidin domain receptor |
| | BC013400, L11315, L20817, L57508, | NM_001954.3, | | family, member 1 |
| | NM_001954, NM_013993, | NM_013993.1 | | |
| | NM_013994, U48705, X74979, | | | |
| | X98208, X99031, Z29093 | | | |
| 11072 | AF038844, AF038844, AF120032, | NM_007026.1 | Hs.91448 | dual specificity |
| | AK027210, BC000370, BC001894, | | | phosphatase 14 |
| | BC004448, NM_007026 | | | |
| 9538 | AF010313, AF010313, BC002390, | NM_004879.2 | Hs.343911 | etoposide induced 2.4 |
| | BC029333, NM_004879 | | | mRNA |
| 9156 | AC004783, AC004783, AF042282, | NM_003686.3, | Hs.47504 | exonuclease 1 |
| | AF060479, AF084974, AF091740, | NM_003686.3, | | |
| | AF091742, AF091754, AL080139, | NM_006027.3 | | |
| | BC007491, BM465399, CD644038, | | | |
| | NM_003686, NM_006027 | | | |
| 81691 | AC004381, AC004381, AF332193, | NM_030941.1 | Hs.177926 | exonuclease NEF-sp |
| | AK057254, AL136763, AL162035, | | | |
| | BC007646 | | | |
| 81691 | AC004381, AC004381, AF332193, | NM_030941.1 | Hs.177926 | exonuclease NEF-sp |
| | AK057254, AL136763, AL162035, | | | |
| | BC007646 | | | |
| 2678 | AC000051, AC000051, AJ006806, | NM_005265.1, | Hs.352119 | gamma- |
| | AJ006854, AJ007378, AJ007379, | NM_005265.1, | | glutamyltransferase 1 |
| | AJ007380, AJ007493, AJ230125, | NM_013421.1 | | |
| | AL832738, BC025927, BC035341, | | | |
| | J04131, J05235, L20490, L20493, | | | |
| | M24087, M24903, NM_005265, | | | |
| | NM_013421, NM_013430, X60069 | | | |
| 2678 | AC000051, AC000051, AJ006806, | NM_005265.1, | Hs.352119 | gamma- |
| | AJ006854, AJ007378, AJ007379, | NM_005265.1, | | glutamyltransferase 1 |
| | AJ007380, AJ007493, AJ230125, | NM_013421.1 | | |
| | AL832738, BC025927, BC035341, | | | |
| | J04131, J05235, L20490, L20493, | | | |
| | M24087, M24903, NM_005265, | | | |
| | NM_013421, NM_013430, X60069 | | | |
| 2678 | AC000051, AC000051, AJ006806, | NM_005265.1, | Hs.352119 | gamma- |
| | AJ006854, AJ007378, AJ007379, | NM_005265.1, | | glutamyltransferase 1 |
| | AJ007380, AJ007493, AJ230125, | NM_013421.1 | | |
| | AL832738, BC025927, BC035341, | | | |
| | J04131, J05235, L20490, L20493, | | | |
| | M24087, M24903, NM_005265, | | | |
| | NM_013421, NM_013430, X60069 | | | |
| 2678 | AC000051, AC000051, AJ006806, | NM_005265.1, | Hs.352119 | gamma- |
| | AJ006854, AJ007378, AJ007379, | NM_005265.1, | | glutamyltransferase 1 |
| | AJ007380, AJ007493, AJ230125, | NM_013421.1 | | |
| | AL832738, BC025927, BC035341, | | | |
| | J04131, J05235, L20490, L20493, | | | |
| | M24087, M24903, NM_005265, | | | |
| | NM_013421, NM_013430, X60069 | | | |
| 92086 | AL133466, AL133466, BC040904, | NM_080920.2, | Hs.355394 | gamma- |
| | L20491, L20492, NM_080920, | NM_080920.2, | | glutamyltransferase-like |
| | NM_178311, NM_178312 | NM_178311.1 | | activity 4 |
| 10243 | AB037806, AB037806, AF272663, | NM_020806.3 | Hs.13405 | gephyrin |
| | AJ272033, AJ272343, AK025169, | | | |
| | BC030016, NM_020806 | | | |
| 2629 | AF023268, AF023268, BC000349, | NM_000157.1 | Hs.282997 | glucosidase, beta; acid |
| | BC003356, BC030240, BX648487, | | | (includes |
| | D13286, D13287, J03059, K02920, | | | glucosylceramidase) |
| | M16328, M19285, NM_000157 | | | |
| 2629 | AF023268, AF023268, BC000349, | NM_000157.1 | Hs.511984 | glucosidase, beta; acid |
| | BC003356, BC030240, BX648487, | | | (includes |
| | D13286, D13287, J03059, K02920, | | | glucosylceramidase) |
| | M16328, M19285, NM_000157 | | | |
| 2937 | AL133324, AL133324, BC007927, | NM_000178.2 | Hs.82327 | glutathione synthetase |
| | NM_000178, U34683 | | | |
| 1647 | BC011757, BC011757, L24498, | NM_001924.2 | Hs.80409 | growth arrest and DNA- |
| | M60974, NM_001924 | | | damage-inducible, alpha |
| 2593 | AC005329, AC005329, AF010246, | NM_000156.4, | Hs.81131 | guanidinoacetate N- |
| | AF010247, AF010248, AF086508, | NM_000156.4 | | methyltransferase |
| | AF188893, BC016760, BC017936, | | | |
| | BI914772, NM_000156, NM_138924, | | | |
| | Z49878 | | | |
| 10973 | AJ223948, AJ223948, AL834463, | NM_006828.1 | Hs.143917 | helicase, ATP binding 1 |
| | AY013288, BC039857 | | | |
| 55055 | AK000898, AK000898, AK023175, | NM_017975.2 | Hs.21331 | hypothetical protein |
| | AK027468, BC036900, BX640701 | | | FLJ10036 |
| 55215 | AB058697, AB058697, AK001581, | NM_018193.1, | Hs.334828 | hypothetical protein |
| | AK027564, AK055176, BC004277, | NM_018193.1 | | FLJ10719 |
| | BC021859, NM_018193 | | | |
| 64782 | AF327352, AF327352, AK022546, | NM_022767.2 | Hs.436102 | hypothetical protein |
| | AK022624, BC005164, BC014407, | | | FLJ12484 |
| | BC020988 | | | |
| 80152 | AK023173, AK023173, AK055237, | NM_025082.1 | Hs.288382 | hypothetical protein |
| | AK056097, BC007642, BC007864, | | | FLJ13111 |
| | BC015202, BC042204, BX648617 | | | |
| 80178 | AK023971, AK023971, AK093788, | NM_025108.1 | Hs.288672 | hypothetical protein |
| | AK128408, BC008882, BC018719 | | | FLJ13909 |
| 54884 | AK000303, AK000303, AK075261, | NM_017750.2 | Hs.440401 | hypothetical protein |
| | AL833237, AY358568, BC011418 | | | FLJ20296 |
| 54923 | AK000413, AK000413, AK054722, | NM_017806.1 | Hs.149227 | hypothetical protein |
| | BC017016 | | | FLJ20406 |
| 79891 | AK027159, AK027159, AK091421, | NM_024833.1 | Hs.180402 | hypothetical protein |
| | BC025728 | | | FLJ23506 |
| 127544 | AK074486, AK074486, BC020595, | NM_153341.1 | Hs.511807 | hypothetical protein |
| | BC062374 | | | FLJ90005 |
| 127544 | AK074486, AK074486, BC020595, | NM_153341.1 | Hs.511807 | hypothetical protein |
| | BC062374 | | | FLJ90005 |
| 51499 | AF161481, AF161481, BC002638, | NM_016399.2 | Hs.69499 | hypothetical protein |
| | BC055313, CB141335, NM_016399, | | | HSPC132 |
| | U75688 | | | |
| 51257 | AF151074, AF151074, AK130163, | NM_016496.3 | Hs.331308 | hypothetical protein |
| | BC015910, BC032624 | | | LOC51257 |
| 60492 | AF182412, AF182412, AF182424, | NM_021825.3 | Hs.368866 | hypothetical protein |
| | AF271782, AK055972, AL136791, | | | MDS025 |
| | BC014573, BC017771, BC020783, | | | |
| | BC032701, BC048795 | | | |
| 84263 | AK090940, AK090940, AL833735, | NM_032303.2 | Hs.388160 | hypothetical protein |
| | AY093428, BC004331, BC036620, | | | MGC10940 |
| | BC047074 | | | |
| 84263 | AK090940, AK090940, AL833735, | NM_032303.2 | Hs.388160 | hypothetical protein |
| | AY093428, BC004331, BC036620, | | | MGC10940 |
| | BC047074 | | | |
| 93129 | BC006126, BC006126, BC015555, | NM_152288.1 | Hs.333488 | hypothetical protein |
| | BC016150, BC022786 | | | MGC13024 |
| 84296 | BC005995, BC005995, BC027454 | NM_032336.1 | Hs.333166 | hypothetical protein |
| | | | | MGC14799 |
| 79154 | AK026196, AK026196, AY358712, | NM_024308.2 | Hs.435826 | hypothetical protein |
| | BC002731 | | | MGC4172 |
| 3399 | BC003107, BC003107, D28449, | NM_002167.2 | Hs.76884 | inhibitor of DNA binding |
| | NM_002167, X66924, X69111, | | | 3, dominant negative |
| | X73428 | | | helix-loop-helix protein |
| 10437 | AB049659, AB049659, AC007192, | NM_006332.3 | Hs.14623 | interferon, gamma- |
| | AF401212, BC021136, BC031020, | | | inducible protein 30 |
| | BE515053, NM_006332 | | | |
| 3430 | BC001356, BC001356, NM_005533, | NM_005533.2 | Hs.50842 | interferon-induced protein |
| | U72882 | | | 35 |
| 3594 | AJ297688, AJ297688, AJ297689, | NM_005535.1, | Hs.223894 | interleukin 12 receptor, |
| | AJ297690, AJ297691, AJ297692, | NM_005535.1 | | beta 1 |
| | AJ297693, AJ297694, AJ297695, | | | |
| | AJ297696, AJ297697, AJ297698, | | | |
| | AJ297699, AJ297700, AJ297701, | | | |
| | BC029121, BX647221, NM_005535, | | | |
| | NM_153701, U03187 | | | |
| 10300 | AF052432, AF052432, BC001353, | NM_005886.1 | Hs.275675 | katanin p80 (WD repeat |
| | BC014141, BT007022 | | | containing) subunit B 1 |
| 3795 | AK130033, AK130033, BC006233, | NM_000221.1, | Hs.412228 | ketohexokinase |
| | BX648873, NM_000221, NM_006488, | NM_000221.1 | | (fructokinase) |
| | X78677, X78678, Y09336, Y09340, | | | |
| | Y09341 | | | |
| 4000 | AF381029, AF381029, AK026584, | NM_005572.2, | Hs.436441 | lamin A/C |
| | AK056143, AK056191, AK057997, | NM_005572.2, | | |
| | AK097801, AK098128, AK122732, | NM_170707.1 | | |
| | AK130179, AY357727, BC000511, | | | |
| | BC003162, BC014507, BC018863, | | | |
| | BC033088, L12399, M13451, M13452, | | | |
| | NM_005572, NM_170707, | | | |
| | NM_170708, X03444, X03445 | | | |
| 3965 | AB005894, AB005894, AB006782, | NM_002308.2, | Hs.81337 | lectin, galactoside- |
| | AK097892, AK126017, NM_002308, | NM_002308.2 | | binding, soluble, 9 |
| | NM_009587, Z49107 | | | (galectin 9) |
| 55367 | AF229178, AF229178, AF274972, | NM_018494.2, | Hs.438986 | leucine-rich and death |
| | AK074893, AL833849, BC014904, | NM_018494.2, | | domain containing |
| | NM_018494, NM_145886 | NM_145886.1 | | |
| 55367 | AF229178, AF229178, AF274972, | NM_018494.2, | Hs.438986 | leucine-rich and death |
| | AK074893, AL833849, BC014904, | NM_018494.2, | | domain containing |
| | NM_018494, NM_145886 | NM_145886.1 | | |
| 3978 | M36067, M36067, NM_000234 | NM_000234.1 | Hs.1770 | ligase I, DNA, ATP- |
| | | | | dependent |
| 4066 | AC005546, AC005546, BC002796, | NM_005583.3 | Hs.46446 | lymphoblastic leukemia |
| | M22637, M22638, NM_005583 | | | derived sequence 1 |
| 3140 | AF010446, AF010446, AF010447, | NM_001531.1 | Hs.101840 | major histocompatibility |
| | AF031469, AF073485, AJ249778, | | | complex, class I-related |
| | BC012485, NM_001531 | | | |
| 3140 | AF010446, AF010446, AF010447, | NM_001531.1 | Hs.101840 | major histocompatibility |
| | AF031469, AF073485, AJ249778, | | | complex, class I-related |
| | BC012485, NM_001531 | | | |
| 3140 | AF010446, AF010446, AF010447, | NM_001531.1 | Hs.101840 | major histocompatibility |
| | AF031469, AF073485, AJ249778, | | | complex, class I-related |
| | BC012485, NM_001531 | | | |
| 3140 | AF010446, AF010446, AF010447, | NM_001531.1 | Hs.101840 | major histocompatibility |
| | AF031469, AF073485, AJ249778, | | | complex, class I-related |
| | BC012485, NM_001531 | | | |
| 10916 | AF126181, AF126181, AF128527, | NM_006787, | Hs.376719 | melanoma antigen, family |
| | AF128528, AF148815, AF320907, | NM_006787, | | D, 2 |
| | AJ293618, AK091003, AK092463, | NM_014599.4, | | |
| | AK098645, BC000304, BM043994, | NM_177433.1 | | |
| | BM803170, BQ423605, BX647995, | | | |
| | NM_006787, NM_014599, | | | |
| | NM_177433, NM_201222, U92544, | | | |
| | Z98046 | | | |
| 9088 | AC004233, AC004233, AC004235, | NM_004203.3, | Hs.77783 | membrane-associated |
| | AF549406, AK097642, AK098452, | NM_004203.3 | | tyrosine- and threonine- |
| | BG530406, BQ017689, NM_004203, | | | specific cdc2-inhibitory |
| | NM_182687 | | | kinase |
| 4580 | AF023268, AF023268, BC001906, | NM_002455.2, | Hs.247551 | metaxin 1 |
| | BC035616, BE394487, BG717732, | NM_002455.2 | | |
| | BQ003402, BU552401, CF529296, | | | |
| | NM_002455, NM_198883, U46920 | | | |
| 7786 | AK094195, AK094195, BC037585, | NM_006301.2 | Hs.211601 | mitogen-activated protein |
| | BC050050, NM_006301, U07358 | | | kinase kinase kinase 12 |
| 51754 | AF070572, AF070572, AF188239, | NM_016446.2 | Hs.440953 | nasopharyngeal |
| | AK074844, BC041377, BC043384 | | | carcinoma related protein |
| 4900 | BC002835, BC002835, NM_006176, | NM_006176.1 | Hs.232004 | neurogranin (protein |
| | U89165, X99075, X99076, Y09689, | | | kinase C substrate, RC3) |
| | Y15059 | | | |
| 4687 | AF330627, AF330627, AK127905, | NM_000265.1 | Hs.1583 | neutrophil cytosolic factor |
| | BC002816, BC065731, M25665, | | | 1 (47 kDa, chronic |
| | M55067, NM_000265, U25793, | | | granulomatous disease, |
| | U57835 | | | autosomal 1) |
| 4687 | AF330627, AF330627, AK127905, | NM_000265.1 | Hs.458275 | neutrophil cytosolic factor |
| | BC002816, BC065731, M25665, | | | 1 (47 kDa, chronic |
| | M55067, NM_000265, U25793, | | | granulomatous disease, |
| | U57835 | | | autosomal 1) |
| 4863 | BC040356, BC040356, BC050561, | NM_002519.1 | Hs.89385 | nuclear protein, ataxia- |
| | D83243, NM_002519, U58852 | | | telangiectasia locus |
| 23225 | AB020713, AB020713, AK026042, | NM_024923.2 | Hs.292119 | nucleoporin 210 |
| | AK074101, AK075545, AL117527, | | | |
| | BC020573 | | | |
| 4521 | AB025233, AB025233, AB025234, | NM_002452.3, | Hs.413078 | nudix (nucleoside |
| | AB025235, AB025236, AB025237, | NM_002452.3, | | diphosphate linked moiety |
| | AB025238, AB025239, AB025240, | NM_198948.1, | | X)-type motif 1 |
| | AB025241, AB025242, AK026631, | NM_198949.1, | | |
| | BC014618, BC022818, BC040144, | NM_198950.1, | | |
| | BC051375, BC065367, D16581, | NM_198952.1, | | |
| | D38591, D38592, D38593, D38594, | NM_198953.1 | | |
| | NM_002452, NM_198948, | | | |
| | NM_198949, NM_198950, | | | |
| | NM_198952, NM_198953, | | | |
| | NM_198954 | | | |
| 55270 | AK001818, AK001818, BC064607 | NM_018283.1 | Hs.144407 | nudix (nucleoside |
| | | | | diphosphate linked moiety |
| | | | | X)-type motif 15 |
| 64393 | AF355465, AF355465, AK022358, | NM_022470.2, | Hs.386299 | p53 target zinc finger |
| | AK122768, AY037945, BC002896, | NM_022470.2 | | protein |
| | NM_022470 | | | |
| 23113 | AB014608, AB014608, AJ318215, | NM_015089.1 | Hs.412832 | p53-associated parkin-like |
| | AY145132, BC002879, BC017747, | | | cytoplasmic protein |
| | BC028159 | | | |
| 56288 | AB073671, AB073671, AF177228, | NM_019619.2 | Hs.72249 | par-3 partitioning |
| | AF196185, AF196186, AF252293, | | | defective 3 homolog (C. elegans) |
| | AF332592, AF332593, AF454057, | | | |
| | AF454058, AF454059, AF467002, | | | |
| | AF467003, AF467004, AF467005, | | | |
| | AF467006, AK000761, AK025892, | | | |
| | AK027735, BC011711, NM_019619 | | | |
| 23646 | BC000553, BC000553, BC036327, | NM_012268.1 | Hs.257008 | phospholipase D3 |
| | NM_012268 | | | |
| 51316 | AF208846, AF208846, AJ422147, | NM_016619.1 | Hs.371003 | placenta-specific 8 |
| | AK000140, BC012205 | | | |
| 23612 | AF151100, AF151100, AK075179, | NM_012396.1 | Hs.268557 | pleckstrin homology-like |
| | BC014390 | | | domain, family A, |
| | | | | member 3 |
| 23654 | AB002313, AB002313, AK025415, | XM_371474.1 | Hs.278311 | plexin B2 |
| | AK025701, AK056543, AK074932, | | | |
| | AK123131, AK126394, AL022328, | | | |
| | BC004542, BT006887, S76730 | | | |
| 23654 | AB002313, AB002313, AK025415, | XM_371474.1 | Hs.3989 | plexin B2 |
| | AK025701, AK056543, AK074932, | | | |
| | AK123131, AK126394, AL022328, | | | |
| | BC004542, BT006887, S76730 | | | |
| 1263 | AA421212, AA421212, AJ293866, | NM_004073.2 | Hs.153640 | polo-like kinase 3 |
| | BC004135, BC004198, BC013899, | | | (Drosophila) |
| | BC013960, NM_004073, U56998 | | | |
| 57060 | AF092441, AF092441, AF141340, | NM_020418.2, | Hs.20930 | poly(rC) binding protein 4 |
| | AF176330, AF257770, AF257771, | NM_020418.2, | | |
| | AF257772, AK001244, AK023993, | NM_033008.1, | | |
| | BC003008, BC004153, BC017098, | NM_033009.1 | | |
| | BX647811, NM_020418, NM_033008, | | | |
| | NM_033009, NM_033010 | | | |
| 5424 | BC008800, BC008800, M80397, | NM_002691.1 | Hs.279413 | polymerase (DNA |
| | M81735, NM_002691 | | | directed), delta 1, |
| | | | | catalytic subunit 125 kDa |
| 10714 | BC020587, BC020587, BC032636, | NM_006591.1, | Hs.82502 | polymerase (DNA- |
| | BC041703, D26018, NM_006591, | NM_006591.1 | | directed), delta 3, |
| | XM_166243 | | | accessory subunit |
| 29802 | AF163825, AF163825, AP000348, | NM_013378.1 | Hs.136713 | pre-B lymphocyte gene 3 |
| | BC020666, NM_013378 | | | |
| 92335 | AF308302, AF308302, AK074771, | NM_153335.3 | Hs.279731 | protein kinase LYK5 |
| | AK075005, AL832407, AY290821, | | | |
| | BC043641, BK001542 | | | |
| 5564 | AF022116, AF022116, AJ224515, | NM_006253.4 | Hs.6061 | protein kinase, AMP- |
| | AK127820, BC001007, BC001056, | | | activated, beta 1 non- |
| | BC001823, BC017671, BC018818, | | | catalytic subunit |
| | BU539177, BX537486, NM_006253, | | | |
| | U83994, U87276, Y12556 | | | |
| 5564 | AF022116, AF022116, AJ224515, | NM_006253.4 | Hs.6061 | protein kinase, AMP- |
| | AK127820, BC001007, BC001056, | | | activated, beta 1 non- |
| | BC001823, BC017671, BC018818, | | | catalytic subunit |
| | BU539177, BX537486, NM_006253, | | | |
| | U83994, U87276, Y12556 | | | |
| 5613 | BC041073, BC041073, NM_005044, | NM_005044.1 | Hs.147996 | protein kinase, X-linked |
| | X85545 | | | |
| 8493 | AA326266, AA326266, AU280469, | NM_003620.2 | Hs.286073 | protein phosphatase 1D |
| | BC016480, BC032826, BC033893, | | | magnesium-dependent, |
| | BC042418, BC060877, BT009780, | | | delta isoform |
| | NM_003620, U78305 | | | |
| 29901 | BC007448, BC007448, NM_013299 | NM_013299.1 | Hs.23642 | protein predicted by clone |
| | | | | 23627 |
| 7803 | AF051160, AF051160, AJ420505, | NM_003463.2 | Hs.227777 | protein tyrosine |
| | BC023975, BC040303, BI222469, | | | phosphatase type IVA, |
| | NM_003463, U48296 | | | member 1 |
| 26191 | AF001846, AF001846, AF077031, | NM_012411.2, | Hs.87860 | protein tyrosine |
| | AF150732, AL137856, BC017785, | NM_012411.2 | | phosphatase, non-receptor |
| | NM_012411, NM_015967, U69700 | | | type 22 (lymphoid) |
| 26191 | AF001846, AF001846, AF077031, | NM_012411.2, | Hs.87860 | protein tyrosine |
| | AF150732, AL137856, BC017785, | NM_012411.2 | | phosphatase, non-receptor |
| | NM_012411, NM_015967, U69700 | | | type 22 (lymphoid) |
| 5900 | AB037729, AB037729, AF295773, | NM_006266.1 | Hs.106185 | ral guanine nucleotide |
| | AK000242, AK056462, AK074114, | | | dissociation stimulator |
| | AK090450, AK127524, BC021581, | | | |
| | BC033198, BC059362, NM_006266, | | | |
| | U14417 | | | |
| 5900 | AB037729, AB037729, AF295773, | NM_006266.1 | Hs.106185 | ral guanine nucleotide |
| | AK000242, AK056462, AK074114, | | | dissociation stimulator |
| | AK090450, AK127524, BC021581, | | | |
| | BC033198, BC059362, NM_006266, | | | |
| | U14417 | | | |
| 5920 | AF060228, AF060228, AF092922, | NM_004585.2 | Hs.17466 | retinoic acid receptor |
| | NM_004585 | | | responder (tazarotene |
| | | | | induced) 3 |
| 6240 | AF107045, AF107045, AK122695, | NM_001033.2 | Hs.383396 | ribonucleotide reductase |
| | BC006498, L10342, NM_001033, | | | M1 polypeptide |
| | X59543, X59617, X65708 | | | |
| 6241 | AK092671, AK092671, AK123010, | NM_001034.1 | Hs.226390 | ribonucleotide reductase |
| | AY032750, BC001886, BC028932, | | | M2 polypeptide |
| | BC030154, NM_001034, X59618 | | | |
| 51065 | AF070668, AF070668, AK024591, | NM_015920.2 | Hs.108957 | ribosomal protein S27- |
| | BC003667, BC031307, BC047648 | | | like |
| 6195 | AK092955, AK092955, BC014966, | NM_002953.2 | Hs.149957 | ribosomal protein S6 |
| | BC039069, L07597, NM_002953 | | | kinase, 90 kDa, |
| | | | | polypeptide 1 |
| 9252 | AF074393, AF074393, AF080000, | NM_004755.2, | Hs.109058 | ribosomal protein S6 |
| | AF090421, AL050099, BC017187, | NM_004755.2 | | kinase, 90 kDa, |
| | BF593074, BG699153, NM_004755, | | | polypeptide 5 |
| | NM_182398 | | | |
| 6678 | AK096969, AK096969, BC004974, | NM_003118.1 | Hs.111779 | secreted protein, acidic, |
| | BC008011, J03040, NM_003118, | | | cysteine-rich |
| | Y00755 | | | (osteonectin) |
| 27244 | AF033120, AF033120, AF033121, | NM_014454.1 | Hs.14125 | sestrin 1 |
| | AF033122, AK001886, NM_014454 | | | |
| 6774 | AF029311, AF029311, AF332508, | NM_003150.2, | Hs.421342 | signal transducer and |
| | AJ012463, BC000627, BC014482, | NM_003150.2 | | activator of transcription |
| | BC029783, BI461226, L29277, | | | 3 (acute-phase response |
| | NM_003150, NM_139276 | | | factor) |
| 6494 | AB005666, AB005666, AF029789, | NM_006747.2, | Hs.7019 | signal-induced |
| | AF052232, AF052233, AF052237, | NM_006747.2 | | proliferation-associated |
| | AF052238, BC010492, BM677738, | | | gene 1 |
| | NM_006747, NM_153253 | | | |
| 23410 | AF083108, AF083108, AL137276, | NM_012239.3 | Hs.511950 | sirtuin (silent mating type |
| | BC001042, NM_012239, U73637 | | | information regulation 2 |
| | | | | homolog) 3 (S. cerevisiae) |
| 6518 | BC001692, BC001692, BC001820, | NM_003039.1 | Hs.33084 | solute carrier family 2 |
| | BC035878, M55531, NM_003039, | | | (facilitated |
| | U05344, U11843 | | | glucose/fructose |
| | | | | transporter), member 5 |
| 55508 | AF148713, AF148713, AY358943, | NM_018656.1 | Hs.445043 | solute carrier family 35, |
| | BC008412, BC030504 | | | member E2 |
| 6303 | AL050290, AL050290, BC002503, | NM_002970.1 | Hs.28491 | spermidine/spermine N1- |
| | BC008424, M55580, M77693, | | | acetyltransferase |
| | NM_002970, U40369, Z14136 | | | |
| 2040 | AL040491, AL040491, AU137947, | NM_004099.4, | Hs.439776 | stomatin |
| | BC010703, BI763647, BM451470, | NM_004099.4 | | |
| | BM925356, CA447945, M81635, | | | |
| | NM_004099, NM_198194, X60067, | | | |
| | X85116 | | | |
| 6382 | AJ551176, AJ551176, BC008765, | NM_002997.3 | Hs.82109 | syndecan 1 |
| | J05392, NM_002997, X60306, Z48199 | | | |
| 6382 | AJ551176, AJ551176, BC008765, | NM_002997.3 | Hs.82109 | syndecan 1 |
| | J05392, NM_002997, X60306, Z48199 | | | |
| 10628 | BX537824, BX537824, NM_006472 | NM_006472.1 | Hs.179526 | thioredoxin interacting |
| | | | | protein |
| 10628 | BX537824, BX537824, NM_006472 | NM_006472.1 | Hs.179526 | thioredoxin interacting |
| | | | | protein |
| 10628 | BX537824, BX537824, NM_006472 | NM_006472.1 | Hs.179526 | thioredoxin interacting |
| | | | | protein |
| 7083 | BC006484, BC006484, BC007872, | NM_003258.1 | Hs.164457 | thymidine kinase 1, |
| | BC007986, K02581, M15205, | | | soluble |
| | NM_003258 | | | |
| 7205 | AF000974, AF000974, AF025437, | NM_003302.1 | Hs.380230 | thyroid hormone receptor |
| | AF312032, AJ001902, AK056773, | | | interactor 6 |
| | BC002680, BC004249, BC004999, | | | |
| | BC021540, BC028985, L40374, | | | |
| | NM_003302 | | | |
| 7153 | AF064590, AF064590, AF069522, | NM_001067.2 | Hs.156346 | topoisomerase (DNA) II |
| | AF071738, AF071739, AF071740, | | | alpha 170 kDa |
| | AF071741, AF071742, AF071743, | | | |
| | AF071744, AF071745, AF071746, | | | |
| | AF071747, AF285157, AF285158, | | | |
| | AF285159, AJ011741, AK024080, | | | |
| | BC013429, J04088, NM_001067 | | | |
| 6919 | AK027824, AK027824, AW474513, | NM_003195.4, | Hs.224397 | transcription elongation |
| | BC014211, BC018896, BC031877, | NM_003195.4 | | factor A (SII), 2 |
| | BC050623, BC050624, BC056407, | | | |
| | BI668232, BI756937, CB961240, | | | |
| | D50495, NM_003195, NM_198723 | | | |
| 6924 | BC002883, BC002883, BC019949, | NM_003198.1 | Hs.15535 | transcription elongation |
| | BC020448, L47345 | | | factor B (SIII), |
| | | | | polypeptide 3 (110 kDa, |
| | | | | elongin A) |
| 7040 | BC000125, BC000125, BC001180, | NM_000660.1 | Hs.1103 | transforming growth |
| | BC022242, BT007245, M38449, | | | factor, beta 1 (Camurati- |
| | NM_000660, X02812, X05839 | | | Engelmann disease) |
| 7108 | AF023676, AF023676, AF048704, | NM_003273.1 | Hs.31130 | transmembrane 7 |
| | AF096304, BC009052, BC012857, | | | superfamily member 2 |
| | BC038353, NM_003273 | | | |
| 51768 | AB032470, AB032470, AK002031, | NM_016551.1 | Hs.10071 | transmembrane 7 |
| | AK023085, BC005176, NM_016551 | | | superfamily member 3 |
| 10346 | AL360134, AL360134, AL360187, | NM_006074.2 | Hs.318501 | tripartite motif-containing |
| | AL360190, BC022281, BC035582, | | | 22 |
| | NM_006074 | | | |
| 8743 | AF178756, AF178756, BC009795, | NM_003810.2 | Hs.387871 | tumor necrosis factor |
| | BC020220, BC032722, NM_003810, | | | (ligand) superfamily, |
| | U37518, U57059 | | | member 10 |
| 7133 | AB030949, AB030949, AB030950, | NM_001066.2 | Hs.256278 | tumor necrosis factor |
| | AB030951, AB030952, AY148473, | | | receptor superfamily, |
| | BC011844, BC042167, BC052977, | | | member 1B |
| | M32315, M35857, M55994, | | | |
| | NM_001066, S63368, U52165 | | | |
| 9924 | AB014610, AB014610, AB107585, | NM_014871.2 | Hs.273397 | ubiquitin specific protease |
| | AK001232, BC024043, BX648106 | | | 52 |
| 3265 | AF493916, AF493916, AJ437024, | NM_176795.1 | Hs.37003 | v-Ha-ras Harvey rat |
| | BC006499, J00277, NM_176795 | | | sarcoma viral oncogene |
| | | | | homolog |
| 7508 | BC016620, BC016620, D21089, | NM_004628.2 | Hs.320 | xeroderma pigmentosum, |
| | NM_004628, X65024 | | | complementation group C |
| 7748 | AF003540, AF003540, AK095720, | NM_007152.1 | Hs.104382 | zinc finger protein 195 |
| | AL833722, NM_007152 | | | |
| 10793 | AK090648, AK090648, AL832810, | NM_021148.1 | Hs.386264 | zinc finger protein 273 |
| | BC063818, NM_021148, X78932 | | | |
| 25799 | AF060503, AF060503, AK023989, | NM_014347.1 | Hs.296365 | zinc finger protein 324 |
| | AK092341, BC007717, NM_014347 | | | |
| 25799 | AF060503, AF060503, AK023989, | NM_014347.1 | Hs.515660 | zinc finger protein 324 |
| | AK092341, BC007717, NM_014347 | | | |
| 7633 | AK054606, AK054606, BC062309, | NM_007135.1 | Hs.512719 | zinc finger protein 79 |
| | NM_007135, X65232 | | | (pT7) |
| 7633 | AK054606, AK054606, BC062309, | NM_007135.1 | Hs.512719 | zinc finger protein 79 |
| | NM_007135, X65232 | | | (pT7) |
| 29066 | AF161540, AF161540, AK000325, | NM_014153.2 | Hs.371856 | zinc-finger protein |
| | AK001869, AK026827, AK026956, | | | AY163807 |
| | AK091803, AY163807, BC012575, | | | |
| | BC036857, BC046363 | | | |

The selected genes may be categorized e.g. by using the GeneOntology tool (http://www.geneontology.org), as providing a wide range of biological functions: regulation of transcription, cell death, cell growth and proliferation, cell cycle related, enzymes, polymerase and proteases, immune system related protein, signal transduction, transporters, cell adhesion, development related, and many unknowns (see Table 4).

The selected genes may be categorized as providing a wide range of biological functions: regulation of transcription, cell death, cell growth and proliferation, cell cycle related, enzymes, polymerase and proteases, immune system related protein, signal transduction, transporters, cell adhesion, development related, and many unknowns (see Table 4).

TABLE 4
Categories of genes among the 215 candidate predictor genes

| CATEGORY OF GENE | NUMBER FOUND |
|---|---|
| regulation of transcription | 19 |
| transcription, DNA-dependent | 18 |
| immune response | 17 |
| DNA repair | 13 |
| mitotic cell cycle | 12 |
| regulation of cell cycle | 12 |
| Apoptosis | 11 |
| DNA replication and chromosome cycle | 10 |
| negative regulation of cell proliferation | 7 |
| Phosphorylation | 7 |
| protein amino acid phosphorylation | 7 |
| regulation of apoptosis | 7 |
| DNA recombination | 6 |
| amino acid metabolism | 6 |
| enzyme linked receptor protein signaling | 6 |
| pathway | |
| positive regulation of programmed cell death | 6 |
| coenzyme biosynthesis | 5 |
| Dephosphorylation | 5 |
| glutathione biosynthesis | 5 |
| glutathione metabolism | 5 |
| protein amino acid dephosphorylation | 5 |
| M phase | 4 |
| humoral immune response | 4 |
| positive regulation of cell proliferation | 4 |
| protein catabolism | 4 |
| proteolysis and peptidolysis | 4 |
| antimicrobial humoral response | 3 |
| cellular defense response | 3 |
| humoral defense mechanism (sensu | 3 |
| Vertebrata) | |
| organelle organization and biogenesis | 3 |
| protein biosynthesis | 3 |
| protein kinase cascade | 3 |
| Unclassified | 125 |

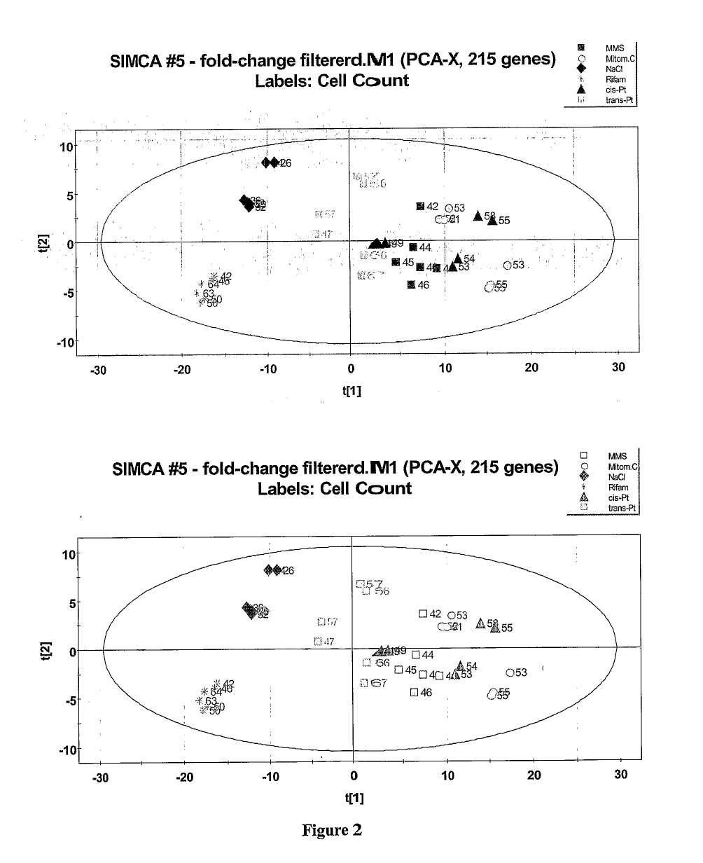

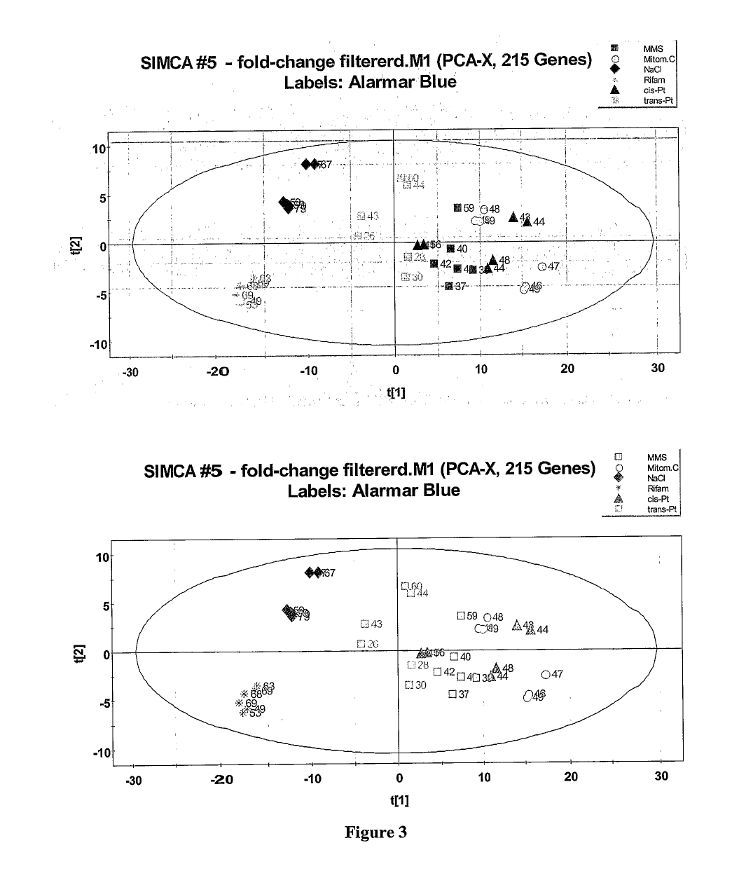

The results of principal component analysis (PCA) of these 215 genes are displayed in FIGS. 2 and 3. FIG. 2 gives numerical values for cell count next to each point. FIG. 3 gives numerical values for Alamar Blue next to each point. In FIGS. 2 and 3, points from NaCl and some points from tPt are in the upper left quadrant; points from Rif are in the lower left quadrant. Most points from MMS are in the lower right quadrant; half the points from MMC are in the upper right quadrant and half are in the lower right quadrant. One third of the points for cPt are in the upper right quadrant and two-thirds are in the lower right quadrant. The remaining points for tPt are close to t[1]=0. From these results it is seen that a clear distinction between cytotoxic and genotoxic compounds is discernible; this is however expected due to the filtering used to select the genes. Rifampicin and NaCl treated samples form homogenous clusters which are clearly separated from the rest of the samples.

### Example 3

### Identification of Highly Predictive Genes Using PLS-DA

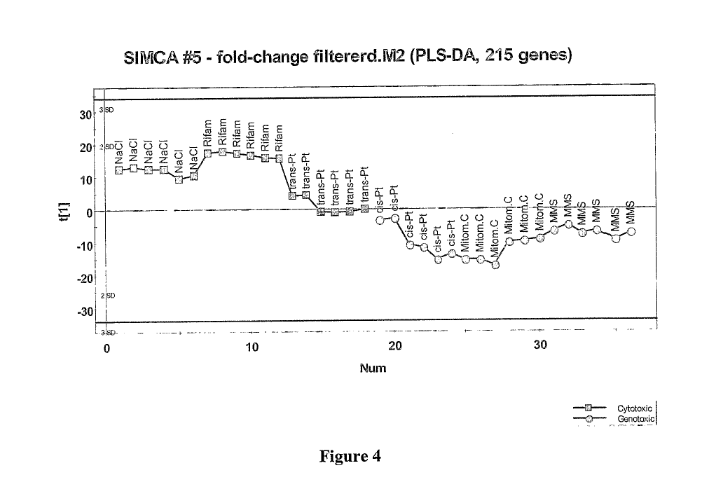

Partial least squares discriminant analysis (PLS-DA) was applied to the set of 215 candidate genes identified in Example 2. This analysis provides the discriminant function that best separates the cytotoxic and the genotoxic compounds. The score plot of the first component t[1] based on these 215 genes is displayed in FIG. 4 which shows a good separation between the two classes of compounds, with each sample for NaCl, Rif, and tPt above or at t[1]=0, and all samples for cPt, MMC, and MMS below t[1]=0. However, two samples of the cis-Platinum group are located quite closely to the trans-Platinum samples. The investigation of the differential gene pattern by PLS-DA revealed 23 genes that contribute most strongly to the distinction between the cytotoxic and genotoxic samples. These genes are compiled in Tables 5A and 5B together with their means, coefficient of variation, fold-change and p-value of students t-test.

TABLE 5A
23 predictor genes resulting from PLS-DA

| | | Mean | CV (%) | Mean | CV(%) | Ratio | |
|---|---|---|---|---|---|---|---|
| LOCUS-LINK | REFSEQ | Cyto | Cyto | Geno | Geno | Geno:Cyto | t-test p-value |
| 79733 | NM_024680.2 | 111 | 42 | 282 | 31 | 2.5 | 7.87E−08 |
| 11147 | NM_007071.1 | 269 | 39 | 514 | 17 | 1.9 | 1.01E−08 |
| 23354 | XM_049237.6 | 120 | 24 | 198 | 15 | 1.7 | 2.68E−09 |
| 123803 | NM_173474.2 | 178 | 13 | 259 | 16 | 1.5 | 5.42E−08 |
| 9779 | | 394 | 39 | 665 | 20 | 1.7 | 2.24E−06 |
| 11257 | NM_007233.1 | 115 | 24 | 164 | 19 | 1.4 | 1.92E−05 |
| 30851 | NM_014604.1 | 150 | 32 | 336 | 25 | 2.2 | 1.09E−08 |
| 30851 | NM_014604.1 | 144 | 24 | 232 | 19 | 1.6 | 1.93E−07 |
| 59 | NM_001613.1 | 281 | 21 | 503 | 21 | 1.8 | 2.71E−08 |
| 780 | NM_001954.3, | 137 | 36 | 229 | 24 | 1.7 | 6.97E−06 |
| | NM_001954.3, | | | | | | |
| | NM_013993.1 | | | | | | |
| 84263 | NM_032303.2 | 289 | 27 | 494 | 15 | 1.7 | 1.96E−09 |
| 93129 | NM_152288.1 | 120 | 22 | 191 | 13 | 1.6 | 1.06E−09 |
| 3795 | NM_000221.1, | 53 | 33 | 74 | 17 | 1.4 | 2.12E−04 |
| | NM_000221.1 | | | | | | |
| 55367 | NM_018494.2, | 228 | 22 | 380 | 19 | 1.7 | 4.54E−08 |
| | NM_018494.2, | | | | | | |
| | NM_145886.1 | | | | | | |
| 8493 | NM_003620.2 | 54 | 30 | 94 | 19 | 1.7 | 6.59E−08 |
| 29901 | NM_013299.1 | 38 | 34 | 57 | 16 | 1.5 | 8.34E−06 |
| 26191 | NM_012411.2, | 68 | 36 | 109 | 14 | 1.6 | 1.50E−06 |
| | NM_012411.2 | | | | | | |
| 9252 | NM_004755.2, | 136 | 23 | 254 | 15 | 1.9 | 2.09E−11 |
| | NM_004755.2 | | | | | | |
| 23410 | NM_012239.3 | 215 | 21 | 307 | 16 | 1.4 | 1.36E−06 |
| 6382 | NM_002997.3 | 116 | 13 | 217 | 29 | 1.9 | 2.46E−06 |
| 7040 | NM_000660.1 | 65 | 23 | 93 | 19 | 1.4 | 1.63E−05 |
| 7133 | NM_001066.2 | 42 | 28 | 69 | 17 | 1.6 | 7.09E−08 |
| 29066 | NM_014153.2 | 324 | 20 | 554 | 16 | 1.7 | 6.90E−10 |

TABLE 5B
23 predictor genes resulting from PLS-DA

| LOCUS- | | | | |
|---|---|---|---|---|
| LINK | GENBANK | REFSEQ | UNIGENE | GENENAME |
| 79733 | AK026964, AK026964, AK055206, | NM_024680.2 | Hs.94292 | FLJ23311 protein |
| | BC028244, BU164108, BX504614, | | | |
| | CB959621 | | | |
| 11147 | AF126163, AF126163, AF126164, | NM_007071.1 | Hs.142245 | HERV-H LTR- |
| | BC010922 | | | associating 3 |
| 23354 | AB020648, AB020648, BC013947 | XM_049237.6 | Hs.7426 | KIAA0841 |
| 123803 | AF092440, AF092440, BC017336 | NM_173474.2 | Hs.351573 | N-terminal asparagine |
| | | | | amidase |
| 9779 | AK097990, AK097990, BC013145, | | Hs.115740 | TBC1 domain family, |
| | D86965 | | | member 5 |
| 11257 | AB007455, AB007455, AB007456, | NM_007233.1 | Hs.274329 | TP53 activated protein 1 |
| | AB007457, BC002709 | | | |
| 30851 | AF028823, AF028823, AF168787, | NM_014604.1 | Hs.12956 | Tax interaction protein 1 |
| | AF234997, AF277318, AK001327, | | | |
| | BC023980, NM_014604 | | | |
| 30851 | AF028823, AF028823, AF168787, | NM_014604.1 | Hs.12956 | Tax interaction protein 1 |
| | AF234997, AF277318, AK001327, | | | |
| | BC023980, NM_014604 | | | |
| 59 | BC017554, BC017554, D00618, | NM_001613.1 | Hs.208641 | actin, alpha 2, smooth |
| | J05192, K01741, K01742, K01743, | | | muscle, aorta |
| | K01744, K01745, K01746, K01747, | | | |
| | M33216, NM_001613, X13839 | | | |
| 780 | AK130776, AK130776, BC008716, | NM_001954.3, | Hs.423573 | discoidin domain |
| | BC013400, L11315, L20817, | NM_001954.3, | | receptor family, |
| | L57508, NM_001954, NM_013993, | NM_013993.1 | | member 1 |
| | NM_013994, U48705, X74979, | | | |
| | X98208, X99031, Z29093 | | | |
| 84263 | AK090940, AK090940, AL833735, | NM_032303.2 | Hs.388160 | hypothetical protein |
| | AY093428, BC004331, BC036620, | | | MGC10940 |
| | BC047074 | | | |
| 93129 | BC006126, BC006126, BC015555, | NM_152288.1 | Hs.333488 | hypothetical protein |
| | BC016150, BC022786 | | | MGC13024 |
| 3795 | AK130033, AK130033, BC006233, | NM_000221.1, | Hs.412228 | ketohexokinase |
| | BX648873, NM_000221, | NM_000221.1 | | (fructokinase) |
| | NM_006488, X78677, X78678, | | | |
| | Y09336, Y09340, Y09341 | | | |
| 55367 | AF229178, AF229178, AF274972, | NM_018494.2, | Hs.438986 | leucine-rich and death |
| | AK074893, AL833849, BC014904, | NM_018494.2, | | domain containing |
| | NM_018494, NM_145886 | NM_145886.1 | | |
| 8493 | AA326266, AA326266, AU280469, | NM_003620.2 | Hs.286073 | protein phosphatase 1D |
| | BC016480, BC032826, BC033893, | | | magnesium-dependent, |
| | BC042418, BC060877, BT009780, | | | delta isoform |
| | NM_003620, U78305 | | | |
| 29901 | BC007448, BC007448, | NM_013299.1 | Hs.23642 | protein predicted by |
| | NM_013299 | | | clone 23627 |
| 26191 | AF001846, AF001846, AF077031, | NM_012411.2, | Hs.87860 | protein tyrosine |
| | AF150732, AL137856, BC017785, | NM_012411.2 | | phosphatase, non- |
| | NM_012411, NM_015967, U69700 | | | receptor type 22 |
| | | | | (lymphoid) |
| 9252 | AF074393, AF074393, AF080000, | NM_004755.2, | Hs.109058 | ribosomal protein S6 |
| | AF090421, AL050099, BC017187, | NM_004755.2 | | kinase, 90 kDa, |
| | BF593074, BG699153, | | | polypeptide 5 |
| | NM_004755, NM_182398 | | | |
| 23410 | AF083108, AF083108, AL137276, | NM_012239.3 | Hs.511950 | sirtuin (silent mating |
| | BC001042, NM_012239, U73637 | | | type information |
| | | | | regulation 2 homolog) |
| | | | | 3 (S. cerevisiae) |
| 6382 | AJ551176, AJ551176, BC008765, | NM_002997.3 | Hs.82109 | syndecan 1 |
| | J05392, NM_002997, X60306, | | | |
| | Z48199 | | | |
| 7040 | BC000125, BC000125, BC001180, | NM_000660.1 | Hs.1103 | transforming growth |
| | BC022242, BT007245, M38449, | | | factor, beta 1 |
| | NM_000660, X02812, X05839 | | | (Camurati-Engelmann |
| | | | | disease) |
| 7133 | AB030949, AB030949, AB030950, | NM_001066.2 | Hs.256278 | tumor necrosis factor |
| | AB030951, AB030952, AY148473, | | | receptor superfamily, |
| | BC011844, BC042167, BC052977, | | | member 1B |
| | M32315, M35857, M55994, | | | |
| | NM_001066, S63368, U52165 | | | |
| 29066 | AF161540, AF161540, AK000325, | NM_014153.2 | Hs.371856 | zinc-finger protein |
| | AK001869, AK026827, AK026956, | | | AY163807 |
| | AK091803, AY163807, BC012575, | | | |
| | BC036857, BC046363 | | | |

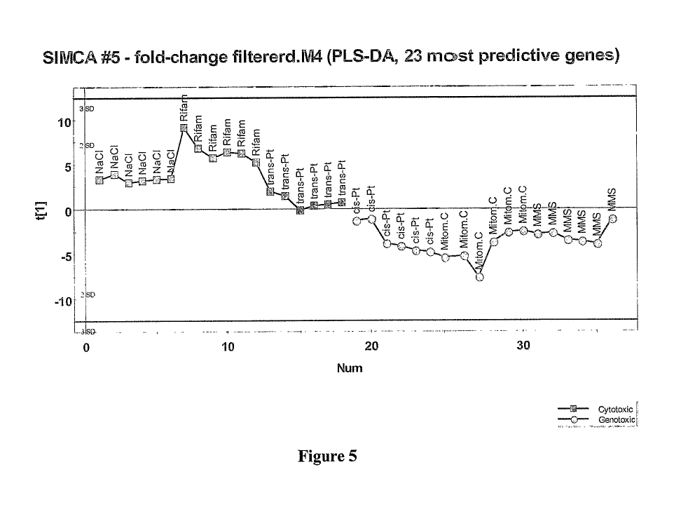

The score plots of the PLS-DA model including these 23 genes is shown in FIG. 5. Separation of the two classes is comparable to that of the model with 215 genes (FIG. 4). The similarity between FIGS. 4 and 5 suggests strongly that the 23 genes identified include genes that are most responsible for the discriminant function between cytotoxicity and genotoxicity.

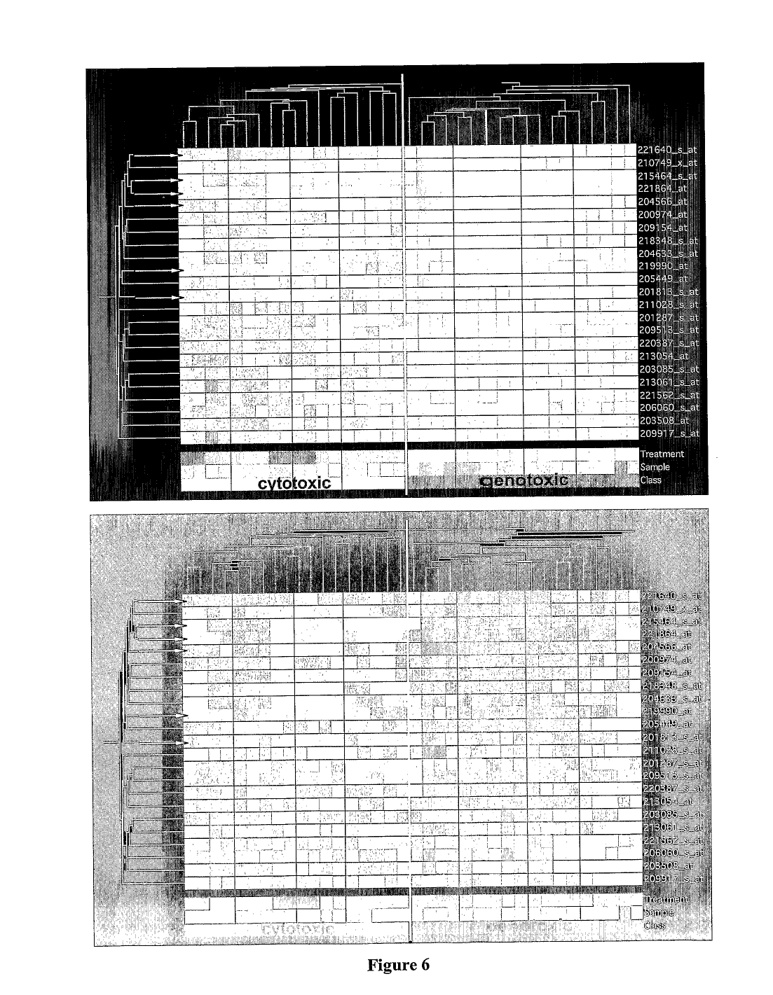

FIG. 6 shows a cluster diagram using the results from these 23 genes. It is seen at the top that two major clusters are clearly delineated; indeed these clusters separate the samples into the expected cytotoxic and genotoxic classes (see the captions on the lowest line in FIG. 6).

### Example 4

### Identification of Highly Predictive Genes Using k-Nearest Neighbor Analysis

The 215 candidate genes identified by the filter screen (Example 2) were analyzed by the GeneSpring predictor tool based on k nearest neighbor analysis (KNN). Due to the different normalization of the data between SIMCA-P and GeneSpring it was expected that the predictor genes identified by KNN might differ from those found by PLS-DA

The list of 26 of the 27 genes that carry the highest predictive strength as determined by KNN are listed in Table 6. The 27^{th} gene (probe set) on the GeneChip has no identifying information associated with it. These genes were able to classify all samples correctly according to their genotoxicity or cytotoxicity, respectively.

TABLE 6
26 predictor genes resulting from GeneSpring KNN

| LOCUS- | | | | |
|---|---|---|---|---|
| LINK | GENBANK | REFSEQ | UNIGENE | GENENAME |
| 79733 | AK026964, AK026964, AK055206, BC028244, | NM_024680.2 | Hs.94292 | FLJ23311 protein |
| | BU164108, BX504614, CB959621 | | | |
| 30851 | AF028823, AF028823, AF168787, AF234997, | NM_014604.1 | Hs.12956 | Tax interaction |
| | AF277318, AK001327, BC023980, NM_014604 | | | protein 1 |
| 30851 | AF028823, AF028823, AF168787, AF234997, | NM_014604.1 | Hs.12956 | Tax interaction |
| | AF277318, AK001327, BC023980, NM_014604 | | | protein 1 |
| 634 | AC004785, AC004785, AL833584, BC014473, | NM_001712.2 | Hs.512682 | carcinoembryonic |
| | BC024164, D12502, D90311, D90312, D90313, | | | antigen-related cell |
| | J03858, M69176, M72238, M76742, NM_001712, | | | adhesion molecule 1 |
| | S71326, X14831, X16354, X16356 | | | (biliary glycoprotein) |
| 634 | AC004785, AC004785, AL833584, BC014473, | NM_001712.2 | Hs.512682 | carcinoembryonic |
| | BC024164, D12502, D90311, D90312, D90313, | | | antigen-related cell |
| | J03858, M69176, M72238, M76742, NM_001712, | | | adhesion molecule 1 |
| | S71326, X14831, X16354, X16356 | | | (biliary glycoprotein) |
| 780 | AK130776, AK130776, BC008716, BC013400, | NM_001954.3, | Hs.423573 | discoidin domain |
| | L11315, L20817, L57508, NM_001954, | NM_001954.3, | | receptor family, |
| | NM_013993, NM_013994, U48705, X74979, | NM_013993.1 | | member 1 |
| | X98208, X99031, Z29093 | | | |
| 780 | AK130776, AK130776, BC008716, BC013400, | NM_001954.3, | Hs.423573 | discoidin domain |
| | L11315, L20817, L57508, NM_001954, | NM_001954.3, | | receptor family, |
| | NM_013993, NM_013994, U48705, X74979, | NM_013993.1 | | member 1 |
| | X98208, X99031, Z29093 | | | |
| 780 | AK130776, AK130776, BC008716, BC013400, | NM_001954.3, | Hs.423573 | discoidin domain |
| | L11315, L20817, L57508, NM_001954, | NM_001954.3, | | receptor family, |
| | NM_013993, NM_013994, U48705, X74979, | NM_013993.1 | | member 1 |
| | X98208, X99031, Z29093 | | | |
| 9156 | AC004783, AC004783, AF042282, | NM_003686.3, | Hs.47504 | exonuclease 1 |
| | AF060479, AF084974, AF091740, AF091742, | NM_003686.3, | | |
| | AF091754, AL080139, BC007491, BM465399, | NM_006027.3 | | |
| | CD644038, NM_003686, NM_006027 | | | |
| 55215 | AB058697, AB058697, AK001581, AK027564, | NM_018193.1, | Hs.334828 | hypothetical protein |
| | AK055176, BC004277, BC021859, NM_018193 | NM_018193.1 | | FLJ10719 |
| 80152 | AK023173, AK023173, AK055237, AK056097, | NM_025082.1 | Hs.288382 | hypothetical protein |
| | BC007642, BC007864, BC015202, BC042204, | | | FLJ13111 |
| | BX648617 | | | |
| 54884 | AK000303, AK000303, AK075261, AL833237, | NM_017750.2 | Hs.440401 | hypothetical protein |
| | AY358568, BC011418 | | | FLJ20296 |
| 127544 | AK074486, AK074486, BC020595, BC062374 | NM_153341.1 | Hs.511807 | hypothetical protein |
| | | | | FLJ90005 |
| 93129 | BC006126, BC006126, BC015555, BC016150, | NM_152288.1 | Hs.333488 | hypothetical protein |
| | BC022786 | | | MGC13024 |
| 3594 | AJ297688, AJ297688, AJ297689, AJ297690, | NM_005535.1, | Hs.223894 | interleukin 12 |
| | AJ297691, AJ297692, AJ297693, AJ297694, | NM_005535.1 | | receptor, beta 1 |
| | AJ297695, AJ297696, AJ297697, AJ297698, | | | |
| | AJ297699, AJ297700, AJ297701, BC029121, | | | |
| | BX647221, NM_005535, NM_153701, U03187 | | | |
| 55367 | AF229178, AF229178, AF274972, AK074893, | NM_018494.2, | Hs.438986 | leucine-rich and |
| | AL833849, BC014904, NM_018494, NM_145886 | NM_018494.2, | | death domain |
| | | NM_145886.1 | | containing |
| 55367 | AF229178, AF229178, AF274972, AK074893, | NM_018494.2, | Hs.438986 | leucine-rich and |
| | AL833849, BC014904, NM_018494, NM_145886 | NM_018494.2, | | death domain |
| | | NM_145886.1 | | containing |
| 3978 | M36067, M36067, NM_000234 | NM_000234.1 | Hs.1770 | ligase I, DNA, ATP- |
| | | | | dependent |
| 23612 | AF151100, AF151100, AK075179, BC014390 | NM_012396.1 | Hs.268557 | pleckstrin homology- |
| | | | | like domain, family |
| | | | | A, member 3 |
| 10714 | BC020587, BC020587, BC032636, BC041703, | NM_006591.1, | Hs.82502 | polymerase (DNA- |
| | D26018, NM_006591, XM_166243 | NM_006591.1 | | directed), delta 3, |
| | | | | accessory subunit |
| 92335 | AF308302, AF308302, AK074771, AK075005, | NM_153335.3 | Hs.279731 | protein kinase LYK5 |
| | AL832407, AY290821, BC043641, BK001542 | | | |
| 8493 | AA326266, AA326266, AU280469, BC016480, | NM_003620.2 | Hs.286073 | protein phosphatase |
| | BC032826, BC033893, BC042418, BC060877, | | | 1D magnesium- |
| | BT009780, NM_003620, U78305 | | | dependent, delta |
| | | | | isoform |
| 9252 | AF074393, AF074393, AF080000, AF090421, | NM_004755.2, | Hs.109058 | ribosomal protein S6 |
| | AL050099, BC017187, BF593074, BG699153, | NM_004755.2 | | kinase, 90 kDa, |
| | NM_004755, NM_182398 | | | polypeptide 5 |
| 6382 | AJ551176, AJ551176, BC008765, J05392, | NM_002997.3 | Hs.82109 | syndecan 1 |
| | NM_002997, X60306, Z48199 | | | |
| 10628 | BX537824, BX537824, NM_006472 | NM_006472.1 | Hs.179526 | thioredoxin |
| | | | | interacting protein |
| 7508 | BC016620, BC016620, D21089, NM_004628, | NM_004628.2 | Hs.320 | xeroderma |
| | X65024 | | | pigmentosum, |
| | | | | complementation |
| | | | | group C |

### Example 5

### Predictor Genes Independent of Method of Analysis

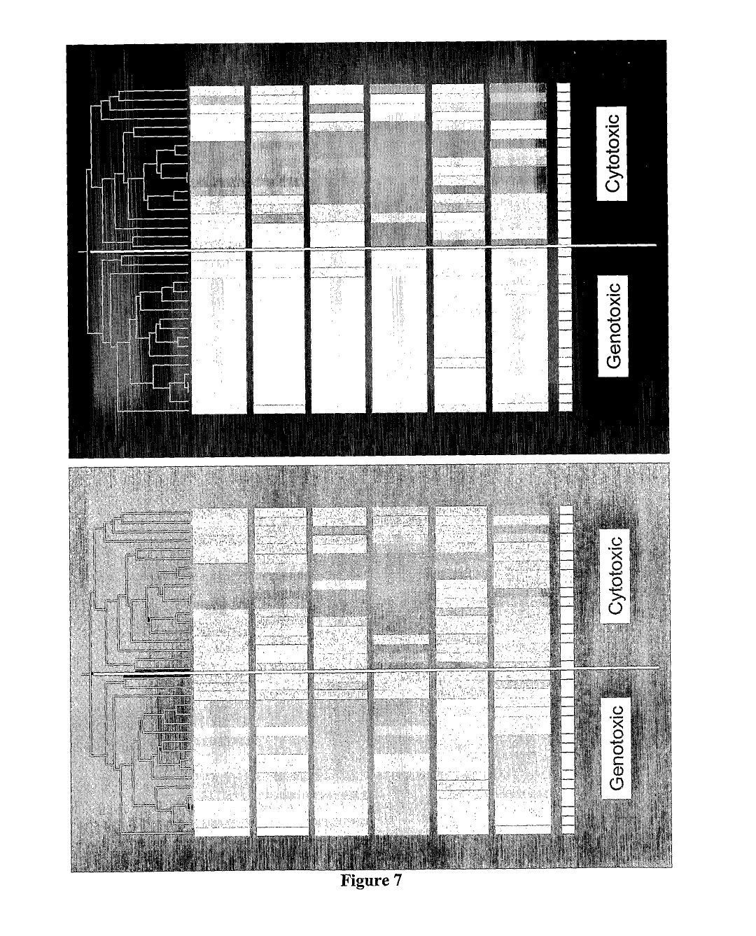

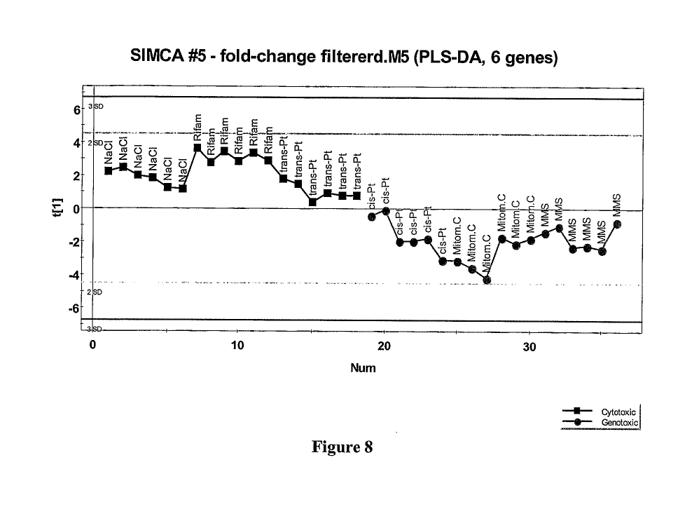

Six genes were found to be common to the predictor gene sets derived from both PLS-DA and KNN; these are identified in Table 7. FIG. 6 includes six arrows on the left that identify the six genes in the cluster diagram originating from the PLS-DA analysis. In order to demonstrate the effectiveness of this reduced gene set, predictive models using PLS-DA and KNN analyses were built containing these six only. This reduced gene set was able to discriminate between the two classes of toxicity without any misclassification. FIG. 7 shows the results of condition clustering (GeneSpring) which shows that the samples are segregated into two principal classes (see dendrogram on the left), which are precisely the genotoxic and cytotoxic samples (FIG. 7, right). This result demonstrates clearly the separability of the two classes of toxicity. The same result is confirmed by PLS-DA as shown in FIG. 8. The separation of the two classes of samples is comparable to that found with all 215 genes (FIG. 4) as well as with the 23 genes in Tables 5A and 5B (FIG. 5).

TABLE 7
6 genes common to PLS-DA and KNN predictor lists

| AFFYMETRIX | LOCUS- | | | |
|---|---|---|---|---|
| ID | LINK | REFSEQ | DESCRIPTION | CLASSIFICATION |
| 221640_s_at | 55367 | NM_018494.2, | Leucine-rich and death domain | Cell Death |
| | | NM_018494.2, | containing | |
| | | NM_145886.1 | | |
| 204566_at | 8493 | NM_003620.2 | Protein phosphatase 1D | Enzymes |
| | | | magnesium-dependent, delta | |
| | | | isoform | |
| 215464_s_at | 30851 | NM_014604.1 | Tax interaction protein 1 | Structural Protein |
| 201813_s_at | | | TBC1 domain family, member 5 | Unknown function |
| 219990_at | 79733 | NM_024680.2 | hypothetical protein FLJ23311 | Unknown function |
| 221864_at | 93129 | NM_152288.1 | hypothetical protein | Unknown function |
| | | | MGC13024 | |

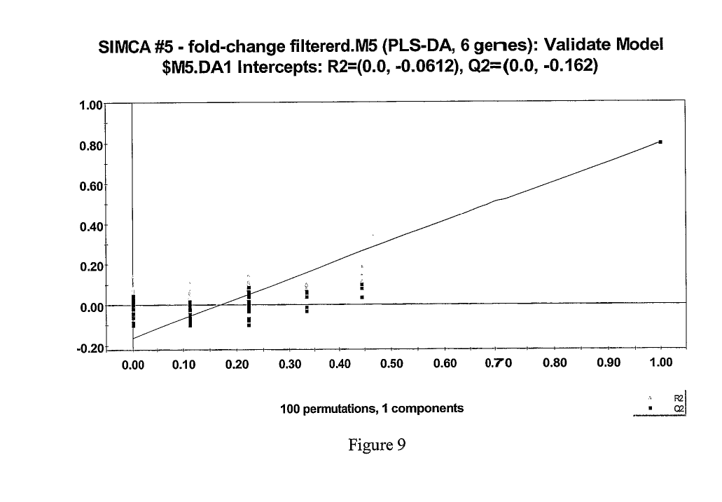

The significance of the predictive power of the six genes model based on PLS-DA can be confirmed by random permutation which compares the results obtained with the true class membership with the results obtained after shuffling the class membership of the samples randomly; this was done one hundred times. The validation results are displayed in FIG. 9. The original data are located at x=1, y=0.8; the data with randomly shuffled toxicity class membership are displayed at several values of x<0.45 indicating that the permutated data were not very similar to the original ones. R2 is a measure of “goodness of fit” and Q2 is a measure of “goodness of prediction”. Both values are significantly higher for the original data compared to random response permutations. Negative intercept values of R2 and Q2 (−0.0612 and −0.162) are significant. The intercept of the regression lines is an indicator of the power of the model. It was −0.0612 for R² and −0.162 for Q² which points towards a high predictive power being far away from random.

The results presented in Examples 3-5 show that two independent methods of statistical analysis resulted in two sets of 23 and 27 predictor genes, respectively. Significantly, the set of six genes common to both sets was also able to uniquely separate the two classes of model compounds according to their toxicity without any loss of predictive power, in spite of the relatively small size of the classes.

In addition, the present methods are sensitive enough to discriminate between ambiguous training samples, such as tPt and cPt. Trans-platinum has long been considered non-genotoxic, because in contrast to cis-platinum it does not show any anti-tumor activity. However, some older publications have noted that while trans-platinum is not a typical genotoxin, it may lead to some weakly positive effects at higher concentrations. Thus in spite of the widely disparate concentrations used in the Examples (trans-platinum: 33 μM, cis-platinum: 1.3 μM), the present methods succeeded in resolving them into their model classes without ambiguity. Alternatively, since cis- and trans-platinum are isomers which are only about 99% pure, it is possible that a slight impurity in trans-platinum consisting of cis-platinum, applied at the higher concentration of the former, might explain why both trans-platinum and cis-platinum are located close to the separation line.

### Example 6

### Use of Extended Sets of Compounds to Identify Predictor Gene Sets

Experiments such as those described in the Materials and Methods are carried out. In addition to the original set of three cytotoxic compounds and three genotoxic compounds used in Examples 1-5, or instead of those compounds, the genotoxic and nongenotoxic compounds shown in Table 8 are used. The genotoxic compounds generally have the characteristic of being direct-acting mutagens or clastogens.

TABLE 8

| Class | Compound or Drug |
|---|---|
| Control | |
| Genotoxic | Ethyl nitroso urea |
| | Methyl nitroso urea |
| | 4-nitroquinoline n-oxyde |
| | N-methyl-N′-nitro-N- |
| | nitrosoguanidine |
| | Dimethyl sulfate |
| | Styrene oxide |
| | Diepoxy butane |
| | Bleomycin |
| | Doxorubicin/Adriamycin. |
| | Daunorubicin |
| | Actinomycin D |
| | 4-(methylnitrosamino)-1-(3- |
| | pyridyl)-1-butanone |
| | Benzo[a]pyrene diole epoxide |
| | Mitoxantron |
| Non-genotoxic | Diflunisal |
| | Flufenamic acid |
| | Oxazepam |
| | Dexamethasone |
| | Benazepril |
| | Ranitidine |
| | Verapamil |
| | N-Acetylcysteine |
| | Tacrolimus |

For each genotoxic and nongenotoxic compound, the concentration corresponding to 50% effectiveness in toxicity is obtained from the literature or evaluated experimentally. Human cells, such as TK6 cells, are cultured as described in Materials and Methods with the 50%-toxic dose of each compound. RNA is isolated from each sample and hybridized to an appropriate human gene probe set arrayed on a substrate. As described above, an Affymetrix HG-U133A PLUS 2 gene chip may be used; alternatively any equivalent array displaying probes originating from a significant portion the human genome may be used, as may or any other method that allows specific quantification of transcripts such as PCR. Hybridization results are scanned and evaluated by the procedures described in Materials and Methods, and in Examples 1-3. Predictor (discriminatory) gene sets of varying sizes and containing a variety of component genes are identified.

### Example 7

### Determination of Genotoxicity of a Candidate Compound

A candidate compound is identified by appropriate research and development activities. The effective dosage for 50% toxicity is evaluated by dilution experiments (Example 1) applied to a human cell line, such as TK6 cells, in several replicates. The cells are cultured for an appropriate period of time (e.g., 24 hours) as described in Materials and Methods, and the total RNA is extracted from each sample. Control cells are also cultured and control RNA isolated. Each sample of RNA is hybridized to a suitable human gene array that includes at least probes from a predictor gene set identified herein (see Examples 2-6); in addition an internal standard probe such as that for beta actin or glyceraldehydes phosphate dehydrogenase may be included on the array employed in this Example. More generally an array such as described in Materials and Methods or equivalent as described in Example 6 may be used. The hybridization results are evaluated by a statistical method described in Materials and Methods and Examples 2-4. The results for the RNA samples obtained from cells treated with the candidate compound are classified by comparison to patterns found from the known model compounds. If the results from the candidate compound resemble those obtained with nongenotoxic compounds, it is concluded that the candidate compound is likely not genotoxic. If the results from the candidate resemble those obtained with genotoxic compounds, it is concluded that the candidate compound is likely genotoxic.

### Example 8

### Development of a Predictive Model of Genotoxicity

This example further characterizes the method of establishing a predictive model for genotoxicity. The experimental protocol was the same as that described above. However, additional compounds known to be genotoxic or non-genotoxic were used as reference compounds. The complete set of known genotoxic or non-genotoxic compounds is shown in Table 9 below.

TABLE 9
Reference compounds of known toxicity being
used for biomarker identification

| non-genotoxic (non-gtx) | | | genotoxic (gtx) | | |
|---|---|---|---|---|---|
| Number | Agent | Code | X Number | Agent | Code |
| 7 | Diflunisal | Dif | 5 | Actinomycin-D | AMD |
| 8 | Flufenamic acid | Fluf | 6 | Bleomycin | Bleo |
| 3 | KCl | KCl | 6 | cis-Platin | cPt |
| 4 | N-Acetylcysteine | NAC | 4 | Daunorubicin | Dau |
| 6 | NaCl | NaCl | 3 | Doxorubicin | Doxo |
| 4 | Ranitidine | Ran | 3 | ENU/Ethyl | ENU |
| | | | | nitroso urea | |
| 6 | Rifampicin | Rif | 6 | Methylmethane | MMS |
| | | | | sulfonate | |
| 6 | trans-Platin | tPt | 6 | Mitomycin C | MMC |
| 8 | Verapamil | Vera | 4 | Mitoxantrone | MXT |
| | | | 3 | Styrene oxide | SO |
| 52 | total | 9 | 46 | total | 10 |

MAS 5 processed data were statistically analyzed as described in the section entitled “Methods and Materials”. Briefly, normalization involved per chip: normalization on sample median and Per gene: normalization on gene median of all samples (GeneSpring 7.2).

Pre-filtering of genes involved a filter on flags: probe set needs to show present or marginal flags in at least 50% of samples and a filter on intensities: probe set must have intensities>50 in at least 50% of samples. This resulted in 18′512 probe sets (Genespring 7.2). Statistical filtering was performed using the Welch-t-test (Genespring 7.2).

Results

Predictive Modeling by PLS-DA

Generally, normalized values as described above were used for modelling. The normalized values were log-transformed (base 10) and Pareto scaled.

Pre-Test with all 98 Samples

TABLE 10
Testing the predictive power of the data (all 98 samples)

| Model | Components | R²X | R²Y | Q² | # Probe Sets |
|---|---|---|---|---|---|
| M1 | 2 | 0.336 | 0.867 | 0.833 | 18′512 |
| M2 | 2 | 0.628 | 0.952 | 0.942 | 455 |
| M3 | 2 | 0.741 | 0.952 | 0.943 | 117 |
| M4 | 2 | 0.801 | 0.958 | 0.951 | 39 |
| M8 | 2 | 0.838 | 0.962 | 0.958 | 24 |
| M9 | 2 | 0.865 | 0.958 | 0.955 | 18 |
| M5 | 2 | 0.884 | 0.954 | 0.950 | 12 |
| M6 | 2 | 0.920 | 0.936 | 0.934 | 6 |
| M7 | 2 | 0.983 | 0.869 | 0.867 | 3 |

R²X: fraction of sum of squares (SS) of all the X's explained by all components
R²Y: fraction sum of squares (SS) of all the Y's explained by all components
Q²: fraction of total variation of the Y's that can be predicted according to cross-validation

According to Table 10, the maximum of predictive power (Q2) is reached with about 24 probe sets. The predictive genes in models M1-M9 correlate highly with the top ranking genes of the above mentioned Welch t-test.

Modeling with Calibration Samples only

The set of 98 samples were split randomly into a calibration set of 74 samples and a validation set consisting of 24 samples. Samples treated with trans-platinum were not included in the calibration samples because of a possible contamination; the gene expression pattern of most of the trans-platinum samples indicated genotoxicity rather than pure cytotoxicity as one would expect according to literature. However, all trans-platinum samples were member of the validation samples. The 100 top-ranking probe sets according to Welch t-test were used as a starting set of features for predictive modelling.

In total, three biomarker (BM1-BM3) with almost equal predictive power could be constructed from these 100 candidate genes (See Table 11). Each biomarker consists of a set of independent genes and there is no overlap of genes (probe sets) among the different biomarkers.

TABLE 11
Predictive power of the three biomarkers

| Model | Components | R²X | R²Y | Q² | # Probe Sets |
|---|---|---|---|---|---|
| BM1 | 2 | 0.777 | 0.961 | 0.944 | 30 |
| BM2 | 2 | 0.773 | 0.938 | 0.926 | 33 |
| BM3 | 2 | 0.776 | 0.916 | 0.902 | 37 |

R²X: fraction of sum of squares (SS) of all the X's explained by all components
R²Y: fraction sum of squares (SS) of all the Y's explained by all components
Q²: fraction of total variation of the Y's that can be predicted according to cross-validation

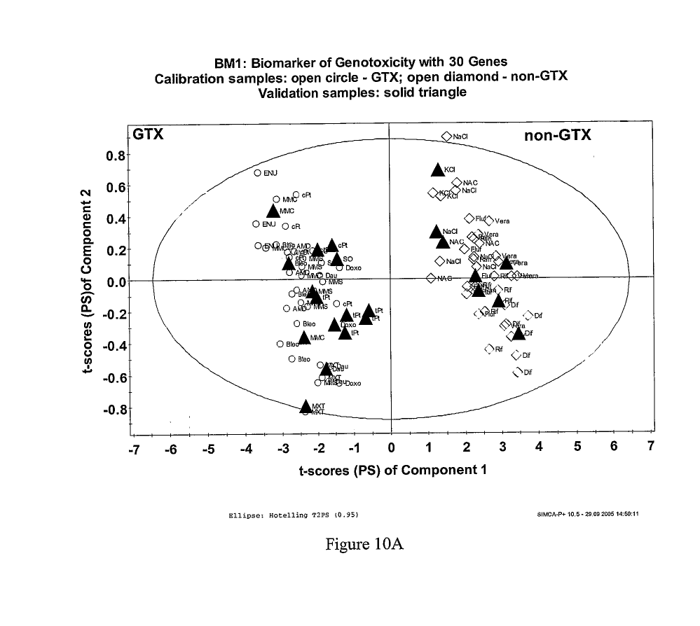

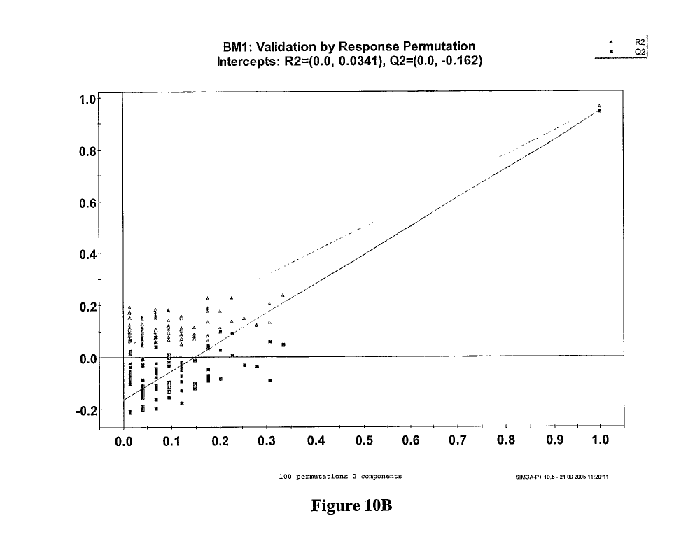

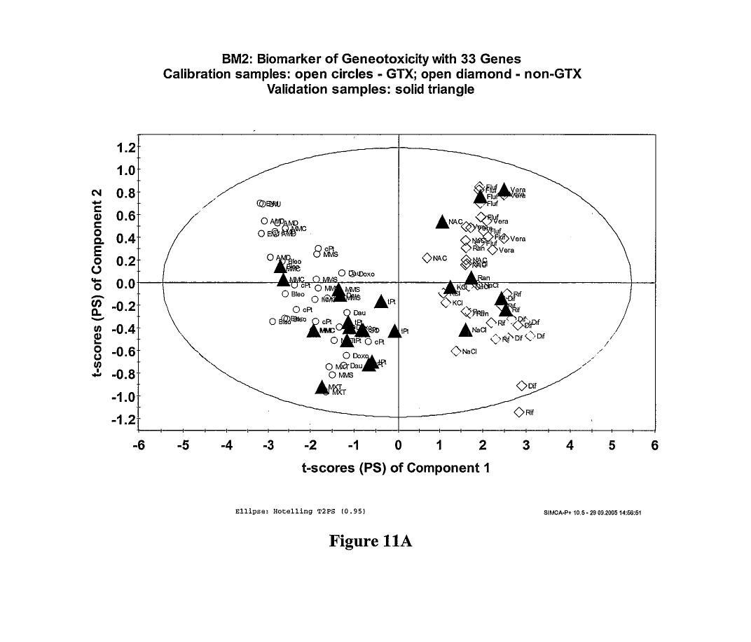

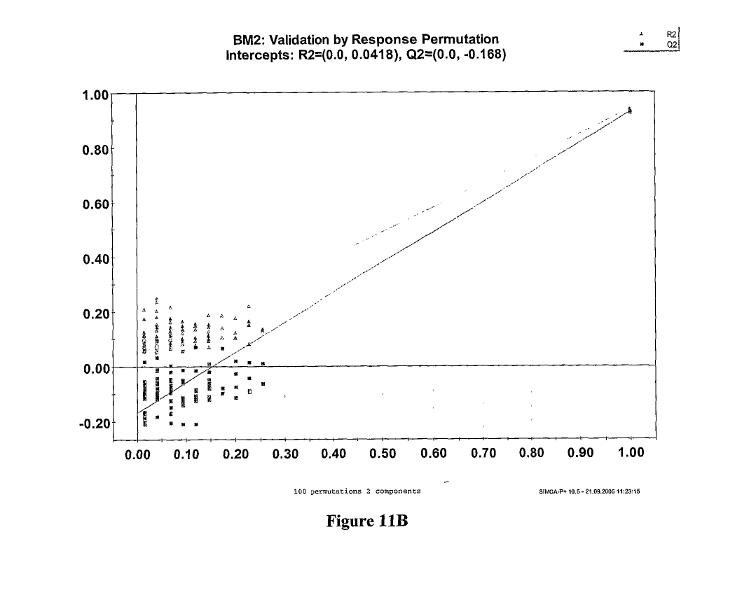

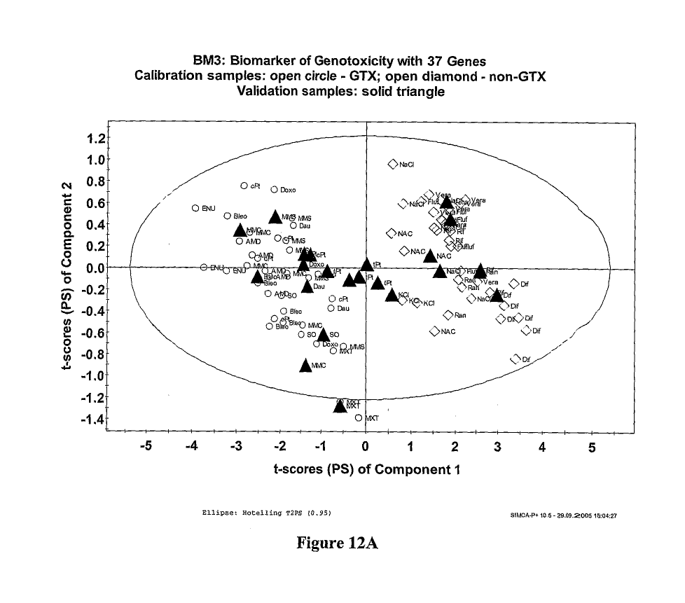

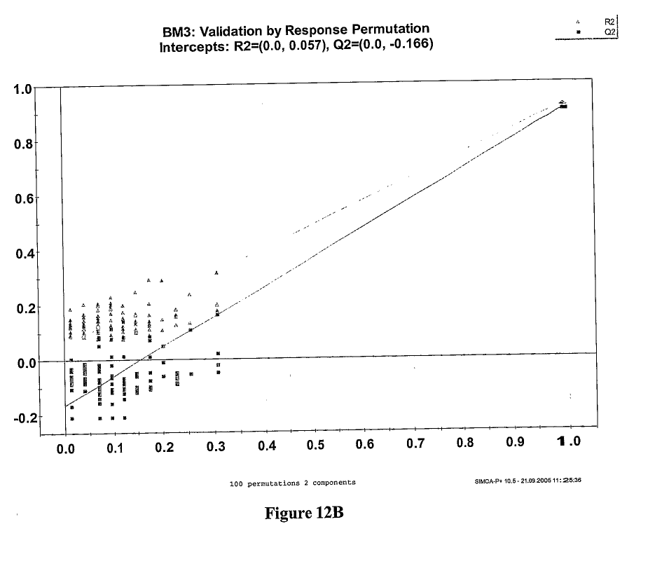

In terms of Q2 the performance of BM1 is better than BM2, and performance of BM2 is better than BM3 which is as expected. However, the difference is only marginal and of no practical importance. Validation by response permutation confirmed also a similar performance of the three biomarkers (see FIGS. 10A-12B).

All genes are listed in Table 12 including the biomarker they belong to, genbank accession number, Affymetrix probe set number, gene symbol and description, as well as median gene expression intensities of non-genotoxic and genotoxic samples, fold-change, and Welch t-test p-value. Performance parameters of the three biomarkers are summarize in Table 12:

The classification of biomarker gene responses for BM1-BM3 to a genotoxic or a non-genotoxic compounds are shown in FIGS. 10A-12B and Tables 12.

TABLE 12
Predictive probe sets (genes) of three biomarkers of Genotoxicity (BM1-BM3).

| | | | | | | Median | | | Welch t- |
|---|---|---|---|---|---|---|---|---|---|
| | | | | | | non- | | | test |
| Model | VIP | Probe Set | Symbol | Gene Name | Genebank | GTX | GTX | FC | p-value |
| BM1 | 0.94 | 209375_at | XPC | Xeroderma pigmentosum, complementation | D21089 | 415 | 1110 | 2.7 | 3.84E−25 |
| | | | | group C | | | | | |
| BM1 | 1.15 | 207813_s_at | FDXR | Ferredoxin reductase | NM_004110 | 398 | 1674 | 4.2 | 3.11E−24 |
| BM1 | 0.95 | 209584_x_at | APOBEC3C | Apolipoprotein B mRNA editing enzyme, | AF165520 | 702 | 1823 | 2.6 | 3.58E−23 |
| | | | | catalytic polypeptide-like 3C | | | | | |
| BM1 | 1.05 | 229711_s_at | MGC5370 | Hypothetical protein MGC5370 | AA902480 | 780 | 2595 | 3.3 | 1.16E−21 |
| BM1 | 1.04 | 203409_at | DDB2 | Damage-specific DNA binding protein 2, 48 kDa | NM_000107 | 716 | 2206 | 3.1 | 2.84E−21 |
| BM1 | 1.19 | 238733_at | | Transcribed locus | AI422414 | 74 | 323 | 4.4 | 2.91E−20 |
| BM1 | 0.99 | 226435_at | PAPLN | Papilin, proteoglycan-like sulfated glycoprotein | AU145309 | 45 | 119 | 2.6 | 6.42E−20 |
| BM1 | 1.59 | 202838_at | FUCA1 | Fucosidase, alpha-L-1, tissue | NM_000147 | 15 | 185 | 12.7 | 1.63E−19 |
| BM1 | 1.14 | 217542_at | CPM | Carboxypeptidase M | BE930512 | 124 | 428 | 3.4 | 5.77E−19 |
| BM1 | 1.33 | 210609_s_at | TP53I3 | Tumor protein p53 inducible protein 3 | BC000474 | 218 | 1709 | 7.8 | 1.05E−18 |
| BM1 | 1.02 | 202284_s_at | CDKN1A | Cyclin-dependent kinase inhibitor 1A (p21, | NM_000389 | 1011 | 3933 | 3.9 | 1.98E−18 |
| | | | | Cip1) | | | | | |
| BM1 | 0.80 | 212120_at | PIGF | Phosphatidylinositol glycan, class F | BE897886 | 1072 | 491 | 0.5 | 2.53E−17 |
| BM1 | 0.79 | 212196_at | IL6ST | Interleukin 6 signal transducer (gp130, oncostatin | AW242916 | 263 | 155 | 0.6 | 2.94E−17 |
| | | | | M receptor) | | | | | |
| BM1 | 0.83 | 218910_at | FLJ10375 | Hypothetical protein FLJ10375 | NM_018075 | 531 | 295 | 0.6 | 2.94E−17 |
| BM1 | 0.74 | 233656_s_at | VPS54 | Vacuolar protein sorting 54 (yeast) | AL359939 | 659 | 410 | 0.6 | 4.05E−16 |
| BM1 | 0.86 | 203164_at | SLC33A1 | hv89d09.x1 NCI_CGAP_Lu24 Homo sapiens | BE464756 | 538 | 265 | 0.5 | 5.21E−16 |
| | | | | cDNA clone IMAGE: 3180593 3′, mRNA | | | | | |
| | | | | sequence. | | | | | |
| BM1 | 0.85 | 212195_at | IL6ST | Interleukin 6 signal transducer (gp130, oncostatin | AL049265 | 878 | 502 | 0.6 | 5.30E−16 |
| | | | | M receptor) | | | | | |
| BM1 | 0.73 | 212723_at | PTDSR | Phosphatidylserine receptor | AK021780 | 558 | 342 | 0.6 | 1.42E−15 |
| BM1 | 1.16 | 200974_at | TXNIP | synonym: ACTSA; alpha-cardiac actin; | AA812232 | 268 | 1021 | 3.8 | 1.86E−15 |
| | | | | go_component: actin filament [goid 0005884] | | | | | |
| | | | | [evidence IEA]; go_component: striated muscle | | | | | |
| | | | | thin filament [goid 0005865] [evidence NAS]; | | | | | |
| | | | | go_function: motor activity [goid 0003774] | | | | | |
| | | | | [evidence IEA]; go_function: structural | | | | | |
| | | | | constituent of muscle [goid 0008307] [evidence | | | | | |
| | | | | NAS]; go_function: structural constituent of | | | | | |
| | | | | cytoskeleton [goid 0005200] [evidence IEA]; | | | | | |
| | | | | go_process: muscle development [goid 0007517] | | | | | |
| | | | | [evidence NAS]; Homo sapiens actin, alpha 2, | | | | | |
| | | | | smooth muscle, aorta (ACTA2), mRNA. | | | | | |
| BM1 | 0.83 | 1554256_a_at | IDH1 | hypothetical protein FLJ11383 | BC012846 | 1881 | 902 | 0.5 | 2.60E−15 |
| BM1 | 0.85 | 214449_s_at | RHOQ | Ras homolog gene family, member Q | NM_012249 | 504 | 208 | 0.4 | 2.81E−15 |
| BM1 | 0.79 | 201009_s_at | IDH1 | Thioredoxin interacting protein | NM_005896 | 2132 | 1176 | 0.6 | 3.84E−15 |
| BM1 | 0.83 | 215283_at | LOC339290 | Hypothetical protein LOC339290 | U79248 | 102 | 47 | 0.5 | 4.00E−15 |
| BM1 | 0.79 | 207738_s_at | NCKAP1 | NCK-associated protein 1 | NM_013436 | 725 | 384 | 0.5 | 8.30E−15 |
| BM1 | 0.84 | 218466_at | TBC1D17 | TBC1 domain family, member 17 | NM_024682 | 194 | 100 | 0.5 | 1.14E−14 |
| BM1 | 1.08 | 201340_s_at | ENC1 | Ectodermal-neural cortex (with BTB-like | NM_003633 | 353 | 1096 | 3.1 | 1.80E−14 |
| | | | | domain) | | | | | |
| BM1 | 1.05 | 201008_s_at | TXNIP | Thioredoxin interacting protein | AI439556 | 281 | 859 | 3.1 | 2.19E−14 |
| BM1 | 0.81 | 212117_at | PIGF | Phosphatidylinositol glycan, class F | BF978689 | 875 | 355 | 0.4 | 2.25E−14 |
| BM1 | 0.79 | 212122_at | PIGF | Phosphatidylinositol glycan, class F | AW771590 | 129 | 57 | 0.4 | 4.31E−14 |
| BM1 | 1.50 | 1554148_a_at | FLJ11383 | solute carrier family 33 (acetyl-CoA transporter), | BC008300 | 11 | 100 | 9.0 | 5.88E−14 |
| | | | | member 1 | | | | | |
| BM2 | 1.18 | 238935_at | RPS27L | EST370545 MAGE resequences, MAGE Homo | AW958475 | 305 | 710 | 2.3 | 2.35E−21 |
| | | | | sapiens cDNA, mRNA sequence. | | | | | |
| BM2 | 1.08 | 216705_s_at | ADA | H. sapiens adenosine deaminase (ADA) gene 5′ | X02189 | 809 | 1869 | 2.3 | 2.84E−21 |
| | | | | flanking region and exon 1 (and joined CDS). | | | | | |
| BM2 | 1.06 | 219099_at | C12orf5 | go_function: catalytic activity [goid 0003824] | NM_020375 | 818 | 1679 | 2.1 | 3.10E−20 |
| | | | | [evidence IEA]; go_process: metabolism [goid | | | | | |
| | | | | 0008152] [evidence IEA]; Homo sapiens | | | | | |
| | | | | chromosome 12 open reading frame 5 (C12orf5), | | | | | |
| | | | | mRNA. | | | | | |
| BM2 | 1.17 | 222879_s_at | POLH | Polymerase (DNA directed), eta | AF158185 | 84 | 242 | 2.9 | 4.96E−20 |
| BM2 | 0.86 | 1555037_a_at | KDELR2 | isocitrate dehydrogenase 1 (NADP+), soluble | BE962456 | 578 | 371 | 0.6 | 6.42E−20 |
| BM2 | 1.19 | 225160_x_at | CPM | Carboxypeptidase M | AI952357 | 1016 | 2744 | 2.7 | 8.99E−20 |
| BM2 | 1.04 | 208890_s_at | PLXNB2 | Plexin B2 | BC004542 | 677 | 1504 | 2.2 | 1.66E−19 |
| BM2 | 1.06 | 233852_at | POLH | Polymerase (DNA directed), eta | AK025631 | 151 | 344 | 2.3 | 1.64E−18 |
| BM2 | 1.06 | 219361_s_at | FLJ12484 | Hypothetical protein FLJ12484 | NM_022767 | 320 | 700 | 2.2 | 1.66E−18 |
| BM2 | 1.09 | 214995_s_at | KIAA0907 | KIAA0907 protein | BF508948 | 234 | 519 | 2.2 | 2.37E−17 |
| BM2 | 1.13 | 235534_at | | Transcribed locus | AI624156 | 80 | 190 | 2.4 | 3.63E−17 |
| BM2 | 1.09 | 204205_at | APOBEC3G; | synonyms: ARP9, CEM15, MDS019, FLJ12740, | NM_021822 | 643 | 1596 | 2.5 | 4.85E−17 |
| | | | ARP9; | bK150C2.7, dJ494G10.1; phorbolin-like protein | | | | | |
| | | | CEM15; | MDS019; go_component: nucleus [goid | | | | | |
| | | | MDS019; | 0005634] [evidence IEA]; go_function: zinc ion | | | | | |
| | | | FLJ12740; | binding [goid 0008270] [evidence IEA]; | | | | | |
| | | | bK150C2.7; | go_function: hydrolase activity [goid 0016787] | | | | | |
| | | | dJ494G10.1 | [evidence IEA]; go_function: hydrolase activity, | | | | | |
| | | | | acting on carbon-nitrogen (but not peptide) | | | | | |
| | | | | bonds, in cyclic amidines [goid 0016814] | | | | | |
| | | | | [evidence IEA]; Homo sapiens apolipoprotein B | | | | | |
| | | | | mRNA editing enzyme, catalytic polypeptide- | | | | | |
| | | | | like 3G (APOBEC3G), mRNA. | | | | | |
| BM2 | 0.82 | 227534_at | C9orf21 | wb67g03.x1 NCI_CGAP_GC6 Homo sapiens | AI655189 | 655 | 420 | 0.6 | 9.65E−17 |
| | | | | cDNA clone IMAGE: 2310772 3′, mRNA | | | | | |
| | | | | sequence. | | | | | |
| BM2 | 1.23 | 221640_s_at | LRDD | Leucine-rich repeats and death domain | AF274972 | 144 | 444 | 3.1 | 1.79E−16 |
| | | | | containing | | | | | |
| BM2 | 0.86 | 235980_at | KCNMB3 | Potassium large conductance calcium-activated | AA767763 | 131 | 83 | 0.6 | 3.68E−16 |
| | | | | channel, subfamily M beta member 3 | | | | | |
| BM2 | 0.91 | 222978_at | SURF4; | Homo sapiens cDNA: FLJ22993 fis, clone | AK026646 | 1748 | 1090 | 0.6 | 5.30E−16 |
| | | | ERV29; | KAT11914. | | | | | |
| | | | FLJ22993 | | | | | | |
| BM2 | 0.86 | 227665_at | MCART1 | Mitochondrial carrier triple repeat 1 | BE968576 | 274 | 186 | 0.7 | 6.88E−16 |
| BM2 | 1.08 | 209154_at | TAX1BP3 | Tax1 (human T-cell leukemia virus type I) | AF234997 | 469 | 1456 | 3.1 | 1.15E−15 |
| | | | | binding protein 3 | | | | | |
| BM2 | 1.14 | 218346_s_at | SESN1 | Sestrin 1 | NM_014454 | 99 | 243 | 2.5 | 1.52E−15 |
| BM2 | 0.76 | 212118_at | RFP | Ret finger protein | AL523814 | 374 | 261 | 0.7 | 1.70E−15 |
| BM2 | 0.82 | 203077_s_at | SMAD2 | SMAD, mothers against DPP homolog 2 | NM_005901 | 362 | 245 | 0.7 | 2.81E−15 |
| | | | | (Drosophila) | | | | | |
| BM2 | 0.81 | 209210_s_at | PLEKHC1; | H. sapiens mitogen inducible gene mig-2, | Z24725 | 769 | 559 | 0.7 | 2.81E−15 |
| | | | MIG2; | complete CDS. | | | | | |
| | | | KIND2; mig- | | | | | | |
| | | | 2; UNC112 | | | | | | |
| BM2 | 0.93 | 226750_at | FLJ10378 | FLJ10378 protein | AI767732 | 393 | 229 | 0.6 | 3.57E−15 |
| BM2 | 0.81 | 227983_at | MGC7036 | Hypothetical protein MGC7036 | AI810244 | 2588 | 1856 | 0.7 | 3.57E−15 |
| BM2 | 0.78 | 217823_s_at | UBE2J1 | Ubiquitin-conjugating enzyme E2, J1 (UBC6 | AL562528 | 1039 | 731 | 0.7 | 3.84E−15 |
| | | | | homolog, yeast) | | | | | |
| BM2 | 0.87 | 212428_at | KIAA0368 | KIAA0368 | AW001101 | 840 | 542 | 0.6 | 4.00E−15 |
| BM2 | 0.87 | 212722_s_at | PTDSR | Phosphatidylserine receptor | AK021780 | 371 | 236 | 0.6 | 4.86E−15 |
| BM2 | 0.83 | 207564_x_at | OGT | O-linked N-acetylglucosamine (GlcNAc) | NM_003605 | 406 | 275 | 0.7 | 1.41E−14 |
| | | | | transferase (UDP-N- | | | | | |
| | | | | acetylglucosamine:polypeptide-N- | | | | | |
| | | | | acetylglucosaminyl transferase) | | | | | |
| BM2 | 1.35 | 217373_x_at | MDM2 | Mdm2, transformed 3T3 cell double minute 2, | AJ276888 | 84 | 307 | 3.6 | 1.64E−14 |
| | | | | p53 binding protein (mouse) | | | | | |
| BM2 | 0.74 | 223325_at | LOC51061 | Hypothetical protein LOC51061 | AF131780 | 327 | 254 | 0.8 | 1.90E−14 |
| BM2 | 0.82 | 208093_s_at | NDEL1 | NudE nuclear distribution gene E homolog like 1 | NM_030808 | 647 | 453 | 0.7 | 1.93E−14 |
| | | | | (A. nidulans) | | | | | |
| BM2 | 0.90 | 226150_at | HTPAP | HTPAP protein | BF111651 | 1392 | 829 | 0.6 | 2.44E−14 |
| BM2 | 1.33 | 201287_s_at | ENC1 | Syndecan 1 | AF010314 | 58 | 201 | 3.4 | 3.63E−14 |
| BM3 | 0.93 | 224951_at | LASS5 | LAG1 longevity assurance homolog 5 | BE348305 | 360 | 642 | 1.8 | 1.71E−20 |
| | | | | (S. cerevisiae) | | | | | |
| BM3 | 1.05 | 218403_at | HSPC132 | Hypothetical protein HSPC132 | NM_016399 | 1335 | 2403 | 1.8 | 3.20E−19 |
| BM3 | 1.08 | 227964_at | FKSG44 | FKSG44 gene | BF435621 | 573 | 1180 | 2.1 | 3.42E−19 |
| BM3 | 1.00 | 204639_at | ADA | Adenosine deaminase | NM_000022 | 1252 | 2617 | 2.1 | 3.55E−19 |
| BM3 | 1.11 | 218634_at | PHLDA3; | synonym: TIH1; pleckstrin homology-like | NM_012396 | 241 | 514 | 2.1 | 7.13E−18 |
| | | | TIH1 | domain, family A, member 2; go_process: | | | | | |
| | | | | morphogenesis [goid 0009653] [evidence TAS] | | | | | |
| | | | | [pmid 10594239]; Homo sapiens pleckstrin | | | | | |
| | | | | homology-like domain, family A, member 3 | | | | | |
| | | | | (PHLDA3), mRNA. | | | | | |
| BM3 | 0.92 | 201341_at | ARL1 | Ectodermal-neural cortex (with BTB-like | BE890745 | 407 | 267 | 0.7 | 1.04E−17 |
| | | | | domain) | | | | | |
| BM3 | 0.88 | 225734_at | FBXO22 | F-box protein 22 | AW294765 | 503 | 822 | 1.6 | 1.17E−17 |
| BM3 | 1.11 | 223342_at | RRM2B | Ribonucleotide reductase M2 B (TP53 inducible) | AB036063 | 286 | 554 | 1.9 | 1.35E−17 |
| BM3 | 0.99 | 1552474_a_at | GAMT | Guanidinoacetate N-methyltransferase | NM_138924 | 378 | 751 | 2.0 | 2.53E−17 |
| BM3 | 0.91 | 222477_s_at | TM7SF3 | transmembrane 7 superfamily member 3 | BC005176 | 1019 | 1855 | 1.8 | 2.94E−17 |
| BM3 | 1.01 | 201193_at | BTG2 | Isocitrate dehydrogenase 1 (NADP+), soluble | NM_006763 | 508 | 912 | 1.8 | 5.47E−17 |
| BM3 | 0.99 | 223207_x_at | PHPT1 | Phosphohistidine phosphatase 1 | AF285119 | 1162 | 2256 | 1.9 | 5.97E−17 |
| BM3 | 1.08 | 218124_at | FLJ20296 | Hypothetical protein FLJ20296 | NM_017750 | 223 | 402 | 1.8 | 1.03E−15 |
| BM3 | 1.00 | 210749_x_at | DDR1 | Discoidin domain receptor family, member 1 | L11315 | 337 | 599 | 1.8 | 1.35E−15 |
| BM3 | 0.88 | 230294_at | | Transcribed locus | AV714462 | 78 | 128 | 1.6 | 2.60E−15 |
| BM3 | 1.08 | 205354_at | GAMT | Guanidinoacetate N-methyltransferase | NM_000156 | 233 | 504 | 2.2 | 3.04E−15 |
| BM3 | 0.98 | 1007_s_at | | U48705 /FEATURE = mRNA | U48705 mRNA | 461 | 830 | 1.8 | 3.44E−15 |
| | | | | /DEFINITION = HSU48705 Human receptor | | | | | |
| | | | | tyrosine kinase DDR gene, complete cds | | | | | |
| BM3 | 1.03 | 217974_at | TM7SF3 | Transmembrane 7 superfamily member 3 | NM_016551 | 103 | 210 | 2.0 | 3.84E−15 |
| BM3 | 1.09 | 244616_x_at | MGC5370 | 601565341F1 NIH_MGC_21 Homo sapiens | BE732830 | 110 | 251 | 2.3 | 3.84E−15 |
| | | | | cDNA clone IMAGE: 3839914 5′, mRNA | | | | | |
| | | | | sequence. | | | | | |
| BM3 | 0.83 | 225737_s_at | FBXO22 | F-box protein 22 | BE966247 | 405 | 679 | 1.7 | 3.99E−15 |
| BM3 | 0.97 | 224391_s_at | CSE-C | Cytosolic sialic acid 9-O-acetylesterase homolog | AF303378 | 142 | 256 | 1.8 | 4.08E−15 |
| BM3 | 1.14 | 201236_s_at | SDC1 | BTG family, member 2 | NM_002997 | 164 | 446 | 2.7 | 4.64E−15 |
| BM3 | 1.17 | 215407_s_at | ASTN2 | Astrotactin 2 | AK024064 | 76 | 196 | 2.6 | 5.27E−15 |
| BM3 | 0.81 | 227295_at | IKIP | IKK interacting protein | AW182575 | 474 | 729 | 1.5 | 6.23E−15 |
| BM3 | 0.93 | 222977_at | SURF4 | Surfeit 4 | AL518882 | 753 | 545 | 0.7 | 8.06E−15 |
| BM3 | 1.00 | 203269_at | NSMAF | Neutral sphingomyelinase (N-SMase) activation | NM_003580 | 1178 | 895 | 0.8 | 9.28E−15 |
| | | | | associated factor | | | | | |
| BM3 | 0.78 | 201657_at | LAPTM5 | ADP-ribosylation factor-like 1 | NM_006762 | 2414 | 3540 | 1.5 | 1.12E−14 |
| BM3 | 0.95 | 207812_s_at | GORASP2 | Golgi reassembly stacking protein 2, 55 kDa | NM_015530 | 1473 | 1007 | 0.7 | 1.44E−14 |
| BM3 | 1.13 | 219019_at | LRDD | Leucine-rich repeats and death domain | NM_018494 | 204 | 404 | 2.0 | 1.44E−14 |
| | | | | containing | | | | | |
| BM3 | 1.00 | 230122_at | MLLT10 | Myeloid/lymphoid or mixed-lineage leukemia | BE219716 | 160 | 120 | 0.7 | 1.44E−14 |
| | | | | (trithorax homolog, Drosophila); translocated to, | | | | | |
| | | | | 10 | | | | | |
| BM3 | 1.03 | 226430_at | LOC253981 | Hypothetical protein LOC253981 | AI394438 | 87 | 183 | 2.1 | 1.60E−14 |
| BM3 | 1.08 | 219014_at | PLAC8 | Placenta-specific 8 | NM_016619 | 1630 | 3287 | 2.0 | 1.67E−14 |
| BM3 | 0.96 | 200736_s_at | ACTA2; | Glutathione peroxidase 1 | NM_001613 | 674 | 1293 | 1.9 | 1.93E−14 |
| | | | ACTSA | | | | | | |
| BM3 | 0.99 | 200699_at | GPX1 | KDEL (Lys-Asp-Glu-Leu) endoplasmic | NM_000581 | 2864 | 4986 | 1.7 | 2.08E−14 |
| | | | | reticulum protein retention receptor 2 | | | | | |
| BM3 | 0.99 | 203457_at | STX7 | Syntaxin 7 | NM_003569 | 92 | 62 | 0.7 | 2.61E−14 |
| BM3 | 1.04 | 201721_s_at | PRKAB1 | Lysosomal-associated multispanning membrane | BC001007 | 379 | 724 | 1.9 | 4.08E−14 |
| | | | | protein-5 | | | | | |
| BM3 | 0.92 | 204369_at | PIK3CA | Phosphoinositide-3-kinase, catalytic, alpha | NM_006218 | 637 | 438 | 0.7 | 5.47E−14 |
| | | | | polypeptide | | | | | |

In conclusion, the data from the initial study (Examples 1-7) and the present study (Example 8) confirm the establishment of a rapid method for screening genotoxic and non-genotoxic compounds using a predictor model based on an alteration in gene expression of selected biomarker genes.

The initial biomarker of genotoxicity was based on 6 reference compounds of know toxicity, these being: rifampicin, NaCl, trans-platinum as non-genotoxic compounds, and methylmethan sulfonate, mitomycin C, and cis-platinum as known genotoxic compounds. 215 candidate genes were identified and subjected to supervised learning algorithms, such as Partial Least Squares—Discriminant Analysis (PLS-DA) and K-Nearest Neighbor (KNN) resulting in a predictive PLS-DA model of 23 genes and a predictive KNN model of 27 gene with six genes common to both models.

The three biomarkers of the present analysis are based on 9 non-genotoxic and 10 genotoxic compounds including the ones from the initial analysis. A statistical comparison (Welch t-test) of genotoxic versus non-genotoxic samples yielded 4911 candidate genes with a FDR of 0.1%. 118 of the 215 candidate genes are also among the 4911 new candidate genes. The overlap between the 100 genes of biomarkers BM1-3 and the 27 KNN predictor genes is 9, and the overlap with the 23 PLS-DA predictor genes is 5. Table 13 summaries the data from Experiments 1-7 and Experiment 8.

In conclusion, it can be stated that the predictor genes of the initial biomarkers are still good predictor when applied to the extended data set which included a greater variety of genotoxic and non-genotoxic compounds. However, a feature extraction based on the extended data set provides a more powerful set of predictor genes for genotoxicity.

| | | | | Extended | Initial | | | | Welch t- |
|---|---|---|---|---|---|---|---|---|---|
| | | | | Analysis | Analysis | non-GTX | GTX | | test |
| UNIGENE | Repeats | SYMBOL | GENENAME | Biomarker | Biomarker | Median | Median | FC | p-value |
| Hs.320 | 1 | XPC | xeroderma pigmentosum, | BM1 | KNN | 415 | 1110 | 2.68 | 5.98E−27 |
| | | | complementation group C | | | | | | |
| Hs.69745 | 1 | FDXR | ferredoxin reductase | BM1 | | 398 | 1674 | 4.21 | 4.84E−26 |
| Hs.441124 | 3 | APOBEC3C | apolipoprotein B mRNA | BM1; BM2 | | 702 | 1823 | 2.60 | 5.57E−25 |
| | | | editing enzyme, catalytic | | | | | | |
| | | | polypeptide-like 3C | | | | | | |
| Hs.108957 | 2 | RPS27L | ribosomal protein S27-like | BM2 | | 305 | 710 | 2.33 | 3.66E−23 |
| Hs.446564 | 1 | DDB2 | damage-specific DNA | BM1 | | 716 | 2206 | 3.08 | 4.41E−23 |
| | | | binding protein 2, 48 kDa | | | | | | |
| Hs.458450 | 1 | LASS5 | LAG1 longevity assurance | BM3 | | 360 | 642 | 1.78 | 2.67E−22 |
| | | | homolog 5 (S. cerevisiae) | | | | | | |
| EST | 1 | | EST | BM1 | | 74 | 323 | 4.35 | 4.53E−22 |
| Hs.24792 | 1 | C12orf5 | chromosome 12 open | BM2 | | 818 | 1679 | 2.05 | 4.82E−22 |
| | | | reading frame 5 | | | | | | |
| Hs.155573 | 2 | POLH | polymerase (DNA directed), | BM2 | | 84 | 242 | 2.89 | 7.71E−22 |
| | | | eta | | | | | | |
| Hs.11223 | 2 | IDH1 | isocitrate dehydrogenase 1 | BM2; BM3 | | 1881 | 902 | −2.09 | 9.99E−22 |
| | | | (NADP+), soluble | | | | | | |
| Hs.458428 | 1 | PAPLN | papilin, proteoglycan-like | BM1 | | 45 | 119 | 2.62 | 9.99E−22 |
| | | | sulfated glycoprotein | | | | | | |
| Hs.576 | 1 | FUCA1 | fucosidase, alpha-L-1, | BM1 | | 15 | 185 | 12.68 | 2.54E−21 |
| | | | tissue | | | | | | |
| Hs.278311 | 2 | PLXNB2 | plexin B2 | BM2 | | 677 | 1504 | 2.22 | 2.58E−21 |
| Hs.69499 | 1 | HSPC132 | hypothetical protein | BM3 | | 1335 | 2403 | 1.80 | 4.99E−21 |
| | | | HSPC132 | | | | | | |
| Hs.362974 | 1 | FKSG44 | hypothetical protein | BM3 | | 573 | 1180 | 2.06 | 5.32E−21 |
| | | | FKSG44 | | | | | | |
| Hs.407135 | 2 | ADA | adenosine deaminase | BM2; BM3 | | 1252 | 2617 | 2.09 | 5.52E−21 |
| Hs.168732 | 4 | MGC5370 | hypothetical protein | BM1; BM2; BM3 | | 124 | 428 | 3.45 | 8.97E−21 |
| | | | MGC5370 | | | | | | |
| Hs.50649 | 1 | TP53I3 | tumor protein p53 inducible | BM1 | | 218 | 1709 | 7.83 | 1.63E−20 |
| | | | protein 3 | | | | | | |
| Hs.436102 | 1 | FLJ12484 | hypothetical protein | BM2 | | 320 | 700 | 2.19 | 2.58E−20 |
| | | | FLJ12484 | | | | | | |
| Hs.370771 | 1 | CDKN1A | cyclin-dependent kinase | BM1 | | 1011 | 3933 | 3.89 | 3.08E−20 |
| | | | inhibitor 1A (p21, Cip1) | | | | | | |
| Hs.268557 | 1 | PHLDA3 | pleckstrin homology-like | BM3 | | 241 | 514 | 2.13 | 1.11E−19 |
| | | | domain, family A, member 3 | | | | | | |
| Hs.438891 | 2 | FBXO22 | F-box only protein 22 | BM3 | | 503 | 822 | 1.63 | 1.82E−19 |
| Hs.512592 | 1 | RRM2B | ribonucleotide reductase M2 | BM3 | | 286 | 554 | 1.94 | 2.10E−19 |
| | | | B (TP53 inducible) | | | | | | |
| Hs.24656 | 1 | KIAA0907 | KIAA0907 protein | BM2 | | 234 | 519 | 2.21 | 3.69E−19 |
| Hs.81131 | 2 | GAMT | guanidinoacetate N- | BM3 | | 378 | 751 | 1.99 | 3.93E−19 |
| | | | methyltransferase | | | | | | |
| Hs.426142 | 1 | PIGF | phosphatidylinositol glycan, | BM1 | | 1072 | 491 | −2.18 | 3.93E−19 |
| | | | class F | | | | | | |
| Hs.476055 | 1 | FLJ10375 | hypothetical protein | BM1 | | 531 | 295 | −1.80 | 4.57E−19 |
| | | | FLJ10375 | | | | | | |
| EST | 1 | | EST | BM2 | | 80 | 190 | 2.38 | 5.65E−19 |
| Hs.409834 | 1 | PHP14 | phosphohistidine | BM3 | | 1162 | 2256 | 1.94 | 9.29E−19 |
| | | | phosphatase | | | | | | |
| Hs.44640 | 1 | C9orf21 | chromosome 9 open | BM2 | | 655 | 420 | −1.56 | 1.50E−18 |
| | | | reading frame 21 | | | | | | |
| Hs.120905 | 1 | KCNMB3 | potassium large | BM2 | | 131 | 83 | −1.58 | 5.73E−18 |
| | | | conductance calcium- | | | | | | |
| | | | activated channel, subfamily | | | | | | |
| | | | M beta member 3 | | | | | | |
| Hs.48499 | 1 | VPS54 | vacuolar protein sorting 54 | BM1 | | 659 | 410 | −1.61 | 6.30E−18 |
| | | | (yeast) | | | | | | |
| Hs.285176 | 1 | SLC33A1 | solute carrier family 33 | BM1 | | 538 | 265 | −2.03 | 8.11E−18 |
| | | | (acetyl-CoA transporter), | | | | | | |
| | | | member 1 | | | | | | |
| Hs.71968 | 2 | IL6ST | interleukin 6 signal | BM1 | | 878 | 502 | −1.75 | 8.25E−18 |
| | | | transducer (gp130, | | | | | | |
| | | | oncostatin M receptor) | | | | | | |
| Hs.46791 | 1 | MCART1 | mitochondrial carrier triple | BM2 | | 274 | 186 | −1.47 | 1.07E−17 |
| | | | repeat 1 | | | | | | |
| Hs.440401 | 1 | FLJ20296 | hypothetical protein | BM3 | | 223 | 402 | 1.80 | 1.61E−17 |
| | | | FLJ20296 | | | | | | |
| Hs.12956 | 2 | TIP-1 | Tax interaction protein 1 | BM2 | KNN; PLS- | 469 | 1456 | 3.11 | 1.79E−17 |
| | | | | | DA | | | | |
| Hs.14125 | 1 | SESN1 | sestrin 1 | BM2 | | 99 | 243 | 2.46 | 2.37E−17 |
| Hs.440382 | 1 | RFP | ret finger protein | BM2 | | 374 | 261 | −1.44 | 2.65E−17 |
| Hs.208641 | 1 | ACTA2 | actin, alpha 2, smooth | BM1 | PLS-DA | 674 | 1293 | 1.92 | 2.89E−17 |
| | | | muscle, aorta | | | | | | |
| Hs.436455 | 1 | FLJ11383 | hypothetical protein | BM1 | | 11 | 100 | 9.03 | 4.05E−17 |
| | | | FLJ11383 | | | | | | |
| EST | 1 | | EST | BM3 | | 78 | 128 | 1.64 | 4.05E−17 |
| Hs.110741 | 1 | MADH2 | MAD, mothers against | BM2 | | 362 | 245 | −1.48 | 4.37E−17 |
| | | | decapentaplegic homolog 2 | | | | | | |
| | | | (Drosophila) | | | | | | |
| Hs.270411 | 1 | PLEKHC1 | pleckstrin homology domain | BM2 | | 769 | 559 | −1.38 | 4.37E−17 |
| | | | containing, family C (with | | | | | | |
| | | | FERM domain) member 1 | | | | | | |
| Hs.423573 | 4 | DDR1 | discoidin domain receptor | BM3 | KNN; PLS- | 461 | 830 | 1.80 | 5.35E−17 |
| | | | family, member 1 | | DA | | | | |
| Hs.151973 | 1 | FLJ10378 | FLJ10378 protein | BM2 | | 393 | 229 | −1.72 | 5.55E−17 |
| Hs.488173 | 1 | MGC7036 | hypothetical protein | BM2 | | 2588 | 1856 | −1.39 | 5.55E−17 |
| | | | MGC7036 | | | | | | |
| Hs.512682 | 2 | CEACAM1 | carcinoembryonic antigen- | | KNN | 23 | 93 | 4.05 | 5.80E−17 |
| | | | related cell adhesion | | | | | | |
| | | | molecule 1 (biliary | | | | | | |
| | | | glycoprotein) | | | | | | |
| Hs.10071 | 2 | TM7SF3 | transmembrane 7 | BM3 | | 103 | 210 | 2.04 | 5.89E−17 |
| | | | superfamily member 3 | | | | | | |
| Hs.184325 | 1 | UBE2J1 | ubiquitin-conjugating | BM2 | | 1039 | 731 | −1.42 | 5.89E−17 |
| | | | enzyme E2, J1 (UBC6 | | | | | | |
| | | | homolog, yeast) | | | | | | |
| Hs.445255 | 1 | KIAA0368 | KIAA0368 | BM2 | | 840 | 542 | −1.55 | 6.13E−17 |
| AK056929, | 1 | LOC339290 | hypothetical protein | BM1 | | 102 | 47 | −2.18 | 6.13E−17 |
| AK056929, | | | LOC339290 | | | | | | |
| BC027873, | | | | | | | | | |
| BC041875, | | | | | | | | | |
| BX648984, | | | | | | | | | |
| All | | | | | | | | | |
| Genbank | | | | | | | | | |
| Accessions | | | | | | | | | |
| Hs.10056 | 1 | CSE-C | cytosolic sialic acid 9-O- | BM3 | | 142 | 256 | 1.80 | 6.26E−17 |
| | | | acetylesterase homolog | | | | | | |
| Hs.75462 | 2 | BTG2 | BTG family, member 2 | BM3 | | 508 | 912 | 1.80 | 7.12E−17 |
| Hs.72660 | 2 | PTDSR | phosphatidylserine receptor | BM1; BM2 | | 371 | 236 | −1.57 | 7.46E−17 |
| Hs.30898 | 1 | ASTN2 | astrotactin 2 | BM3 | | 76 | 196 | 2.57 | 8.08E−17 |
| Hs.406199 | 1 | IKIP | IKK interacting protein | BM3 | | 474 | 729 | 1.54 | 9.56E−17 |
| Hs.284296 | 2 | SURF4 | surfeit 4 | BM2; BM3 | | 753 | 545 | −1.38 | 1.24E−16 |
| Hs.278411 | 1 | NCKAP1 | NCK-associated protein 1 | BM1 | | 725 | 384 | −1.89 | 1.27E−16 |
| Hs.372000 | 1 | NSMAF | neutral sphingomyelinase | BM3 | | 1178 | 895 | −1.32 | 1.43E−16 |
| | | | (N-SMase) activation | | | | | | |
| | | | associated factor | | | | | | |
| Hs.372616 | 1 | ARL1 | ADP-ribosylation factor-like 1 | BM3 | | 407 | 267 | −1.53 | 1.72E−16 |
| Hs.325860 | 1 | TBC1D17 | TBC1 domain family, | BM1 | | 194 | 100 | −1.95 | 1.74E−16 |
| | | | member 17 | | | | | | |
| Hs.405410 | 1 | OGT | O-linked N- | BM2 | | 406 | 275 | −1.47 | 2.16E−16 |
| | | | acetylglucosamine (GlcNAc) | | | | | | |
| | | | transferase (UDP-N- | | | | | | |
| | | | acetylglucosamine:polypeptide- | | | | | | |
| | | | N-acetylglucosaminyl | | | | | | |
| | | | transferase) | | | | | | |
| Hs.438986 | 2 | LRDD | leucine-rich and death | BM2; BM3 | KNN; PLS- | 204 | 404 | 1.98 | 2.22E−16 |
| | | | domain containing | | DA | | | | |
| Hs.6880 | 1 | GORASP2 | golgi reassembly stacking | BM3 | | 1473 | 1007 | −1.46 | 2.22E−16 |
| | | | protein 2, 55 kDa | | | | | | |
| Hs.446451 | 1 | MLLT10 | myeloid/lymphoid or mixed- | BM3 | | 160 | 120 | −1.34 | 2.22E−16 |
| | | | lineage leukemia (trithorax | | | | | | |
| | | | homolog, Drosophila); | | | | | | |
| | | | translocated to, 10 | | | | | | |
| AK025431, | 1 | LOC253981 | hypothetical protein | BM3 | | 87 | 183 | 2.10 | 2.46E−16 |
| All | | | LOC253981 | | | | | | |
| Genbank | | | | | | | | | |
| Accessions | | | | | | | | | |
| Hs.212217 | 1 | MDM2 | Mdm2, transformed 3T3 cell | BM2 | | 84 | 307 | 3.65 | 2.52E−16 |
| | | | double minute 2, p53 | | | | | | |
| | | | binding protein (mouse) | | | | | | |
| Hs.371003 | 1 | PLAC8 | placenta-specific 8 | BM3 | | 1630 | 3287 | 2.02 | 2.57E−16 |
| Hs.104925 | 2 | ENC1 | ectodermal-neural cortex | BM1; BM3 | | 58 | 201 | 3.44 | 2.77E−16 |
| | | | (with BTB-like domain) | | | | | | |
| Hs.313847 | 1 | LOC51061 | hypothetical protein | BM2 | | 327 | 254 | −1.29 | 2.92E−16 |
| | | | LOC51061 | | | | | | |
| Hs.76686 | 1 | GPX1 | glutathione peroxidase 1 | BM3 | | 2864 | 4986 | 1.74 | 2.96E−16 |
| Hs.3850 | 1 | NDEL1 | nudE nuclear distribution | BM2 | | 647 | 453 | −1.43 | 2.97E−16 |
| | | | gene E homolog like 1 | | | | | | |
| | | | (A. nidulans) | | | | | | |
| Hs.446645 | 1 | KDELR2 | KDEL (Lys-Asp-Glu-Leu) | BM3 | | 578 | 371 | −1.56 | 3.20E−16 |
| | | | endoplasmic reticulum | | | | | | |
| | | | protein retention receptor 2 | | | | | | |
| Hs.179526 | 3 | TXNIP | thioredoxin interacting | BM1 | | 268 | 1021 | 3.82 | 3.37E−16 |
| | | | protein | | | | | | |
| Hs.442989 | 3 | ARHQ | ras homolog gene family, | BM1 | | 875 | 355 | −2.46 | 3.46E−16 |
| | | | member Q | | | | | | |
| Hs.437179 | 1 | HTPAP | HTPAP protein | BM2 | | 1392 | 829 | −1.68 | 3.75E−16 |
| Hs.434916 | 1 | STX7 | syntaxin 7 | BM3 | | 92 | 62 | −1.48 | 4.02E−16 |
| Hs.82109 | 2 | SDC1 | syndecan 1 | BM2 | KNN; PLS- | 164 | 446 | 2.71 | 5.53E−16 |
| | | | | | DA | | | | |
| Hs.85701 | 1 | PIK3CA | phosphoinositide-3-kinase, | BM3 | | 637 | 438 | −1.46 | 8.34E−16 |
| | | | catalytic, alpha polypeptide | | | | | | |
| Hs.6061 | 2 | PRKAB1 | protein kinase, AMP- | | | 379 | 724 | 1.91 | 9.01E−16 |
| | | | activated, beta 1 non- | | | | | | |
| | | | catalytic subunit | | | | | | |
| Hs.371856 | 1 | HSPC055 | zinc-finger protein | | PLS-DA | 629 | 1011 | 1.61 | 1.19E−15 |
| | | | AY163807 | | | | | | |
| | 1 | | EST | | | 69 | 145 | 2.09 | 1.69E−15 |
| Hs.318501 | 1 | TRIM22 | tripartite motif-containing 22 | | | 1486 | 2263 | 1.52 | 2.33E−15 |
| Hs.286073 | 1 | PPM1D | protein phosphatase 1D | | KNN; PLS- | 404 | 758 | 1.87 | 8.81E−15 |
| | | | magnesium-dependent, | | DA | | | | |
| | | | delta isoform | | | | | | |
| Hs.273330 | 1 | AGRN | agrin | | | 201 | 377 | 1.88 | 7.36E−14 |
| Hs.352119 | 4 | GGT1 | gamma-glutamyltransferase 1 | | | 68 | 157 | 2.32 | 1.70E−13 |
| Hs.2490 | 1 | CASP1 | caspase 1, apoptosis- | | | 74 | 156 | 2.11 | 1.78E−13 |
| | | | related cysteine protease | | | | | | |
| | | | (interleukin 1, beta, | | | | | | |
| | | | convertase) | | | | | | |
| Hs.279912 | 1 | CP110 | CP110 protein | | | 396 | 622 | 1.57 | 1.78E−13 |
| Hs.436200 | 2 | LAPTM5 | Lysosomal-associated | | | 1420 | 2545 | 1.79 | 2.10E−13 |
| | | | multispanning membrane | | | | | | |
| | | | protein-5 | | | | | | |
| Hs.76884 | 1 | ID3 | inhibitor of DNA binding 3, | | | 753 | 1577 | 2.09 | 2.30E−13 |
| | | | dominant negative helix- | | | | | | |
| | | | loop-helix protein | | | | | | |
| Hs.87860 | 2 | PTPN22 | protein tyrosine | | PLS-DA | 365 | 612 | 1.68 | 4.42E−13 |
| | | | phosphatase, non-receptor | | | | | | |
| | | | type 22 (lymphoid) | | | | | | |
| Hs.211601 | 1 | MAP3K12 | mitogen-activated protein | | | 65 | 103 | 1.58 | 2.42E−12 |
| | | | kinase kinase kinase 12 | | | | | | |
| Hs.512719 | 2 | ZNF79 | zinc finger protein 79 (pT7) | | | 48 | 107 | 2.26 | 3.19E−12 |
| Hs.331308 | 1 | LOC51257 | hypothetical protein | | | 101 | 169 | 1.67 | 4.77E−12 |
| | | | LOC51257 | | | | | | |
| Hs.511807 | 1 | FLJ90005 | hypothetical protein | | | 307 | 532 | 1.73 | 6.90E−12 |
| | | | FLJ90005 | | | | | | |
| Hs.436441 | 1 | LMNA | lamin A/C | | | 373 | 528 | 1.41 | 8.66E−12 |
| Hs.1274 | 1 | BMP1 | bone morphogenetic protein 1 | | | 54 | 86 | 1.60 | 9.87E−12 |
| Hs.511807 | 1 | FLJ90005 | hypothetical protein | | KNN | 258 | 404 | 1.57 | 1.43E−11 |
| | | | FLJ90005 | | | | | | |
| Hs.333488 | 1 | MGC13024 | hypothetical protein | | KNN; PLS- | 559 | 901 | 1.61 | 1.85E−11 |
| | | | MGC13024 | | DA | | | | |
| Hs.387871 | 1 | TNFSF10 | tumor necrosis factor | | | 51 | 122 | 2.38 | 1.92E−11 |
| | | | (ligand) superfamily, | | | | | | |
| | | | member 10 | | | | | | |
| Hs.435826 | 1 | MGC4172 | hypothetical protein | | | 97 | 178 | 1.84 | 3.35E−11 |
| | | | MGC4172 | | | | | | |
| Hs.380230 | 1 | TRIP6 | thyroid hormone receptor | | | 251 | 397 | 1.58 | 7.72E−11 |
| | | | interactor 6 | | | | | | |
| Hs.1770 | 1 | LIG1 | ligase I, DNA, ATP- | | KNN | 255 | 639 | 2.51 | 8.04E−11 |
| | | | dependent | | | | | | |
| Hs.279731 | 1 | LYK5 | protein kinase LYK5 | | KNN | 300 | 433 | 1.44 | 8.04E−11 |
| Hs.197875 | 1 | ASC | apoptosis-associated speck- | | | 162 | 311 | 1.92 | 8.13E−11 |
| | | | like protein containing a | | | | | | |
| | | | CARD | | | | | | |
| Hs.149957 | 1 | RPS6KA1 | ribosomal protein S6 kinase, | | | 487 | 792 | 1.63 | 1.27E−10 |
| | | | 90 kDa, polypeptide 1 | | | | | | |
| Hs.111779 | 1 | SPARC | secreted protein, acidic, | | | 211 | 352 | 1.67 | 1.92E−10 |
| | | | cysteine-rich (osteonectin) | | | | | | |
| Hs.81337 | 1 | LGALS9 | lectin, galactoside-binding, | | | 42 | 109 | 2.57 | 2.60E−10 |
| | | | soluble, 9 (galectin 9) | | | | | | |
| Hs.136713 | 1 | VPREB3 | pre-B lymphocyte gene 3 | | | 44 | 105 | 2.38 | 3.34E−10 |
| Hs.386299 | 1 | WIG1 | p53 target zinc finger | | | 545 | 854 | 1.57 | 3.81E−10 |
| | | | protein | | | | | | |
| Hs.108441 | 1 | HAAO | 3-hydroxyanthranilate 3,4- | | | 77 | 141 | 1.83 | 3.88E−10 |
| | | | dioxygenase | | | | | | |
| Hs.355394 | 1 | GGTLA4 | gamma- | | | 76 | 111 | 1.45 | 4.19E−10 |
| | | | glutamyltransferase-like | | | | | | |
| | | | activity 4 | | | | | | |
| Hs.153640 | 1 | PLK3 | polo-like kinase 3 | | | 124 | 185 | 1.49 | 4.91E−10 |
| | | | (Drosophila) | | | | | | |
| Hs.101840 | 4 | MR1 | major histocompatibility | | | 235 | 379 | 1.61 | 4.96E−10 |
| | | | complex, class I-related | | | | | | |
| Hs.147996 | 1 | PRKX | protein kinase, X-linked | | | 121 | 190 | 1.57 | 5.20E−10 |
| Hs.182536 | 1 | KIAA0284 | KIAA0284 | | | 45 | 88 | 1.95 | 6.89E−10 |
| Hs.311559 | 1 | NOTCH1 | Notch homolog 1, | | | 142 | 293 | 2.06 | 8.27E−10 |
| | | | translocation-associated | | | | | | |
| | | | (Drosophila) | | | | | | |
| Hs.227777 | 1 | PTP4A1 | protein tyrosine | | | 762 | 1098 | 1.44 | 9.26E−10 |
| | | | phosphatase type IVA, | | | | | | |
| | | | member 1 | | | | | | |
| Hs.91448 | 1 | DUSP14 | dual specificity phosphatase | | | 584 | 797 | 1.36 | 1.12E−09 |
| | | | 14 | | | | | | |
| Hs.368866 | 1 | MDS025 | hypothetical protein | | | 1081 | 1599 | 1.48 | 1.80E−09 |
| | | | MDS025 | | | | | | |
| Hs.82327 | 1 | GSS | glutathione synthetase | | | 914 | 1270 | 1.39 | 5.02E−09 |
| Hs.1103 | 1 | TGFB1 | transforming growth factor, | | PLS-DA | 624 | 1115 | 1.79 | 6.82E−09 |
| | | | beta 1 (Camurati- | | | | | | |
| | | | Engelmann disease) | | | | | | |
| Hs.5541 | 1 | ATP2A3 | ATPase, Ca++ transporting, | | | 106 | 185 | 1.74 | 1.05E−08 |
| | | | ubiquitous | | | | | | |
| Hs.173894 | 1 | CSF1 | colony stimulating factor 1 | | | 79 | 132 | 1.68 | 1.32E−08 |
| | | | (macrophage) | | | | | | |
| Hs.104382 | 1 | ZNF195 | zinc finger protein 195 | | | 599 | 866 | 1.45 | 1.60E−08 |
| Hs.103128 | 1 | CHRNA6 | cholinergic receptor, | | | 27 | 53 | 2.00 | 1.73E−08 |
| | | | nicotinic, alpha polypeptide 6 | | | | | | |
| Hs.377992 | 1 | RABGGTA | Rab | | | 223 | 315 | 1.41 | 3.45E−08 |
| | | | geranylgeranyltransferase, | | | | | | |
| | | | alpha subunit | | | | | | |
| M12423, | 1 | TRA@ | T cell receptor alpha locus | | | 48 | 93 | 1.92 | 3.65E−08 |
| M12423, | | | | | | | | | |
| X01403, | | | | | | | | | |
| X02592, | | | | | | | | | |
| All | | | | | | | | | |
| Genbank | | | | | | | | | |
| Accessions | | | | | | | | | |
| Hs.273186 | 1 | CABC1 | chaperone, ABC1 activity of | | | 178 | 236 | 1.33 | 5.25E−08 |
| | | | bc1 complex like (S. pombe) | | | | | | |
| Hs.223894 | 1 | IL12RB1 | interleukin 12 receptor, beta 1 | | KNN | 57 | 76 | 1.35 | 5.54E−08 |
| Hs.37003 | 1 | HRAS | v-Ha-ras Harvey rat | | | 343 | 539 | 1.57 | 6.77E−08 |
| | | | sarcoma viral oncogene | | | | | | |
| | | | homolog | | | | | | |
| Hs.351573 | 1 | NTAN1 | N-terminal asparagine | | PLS-DA | 156 | 271 | 1.73 | 7.11E−08 |
| | | | amidase | | | | | | |
| Hs.274329 | 2 | TP53AP1 | TP53 activated protein 1 | | PLS-DA | 136 | 179 | 1.32 | 9.42E−08 |
| Hs.333166 | 1 | MGC14799 | hypothetical protein | | | 115 | 202 | 1.76 | 1.08E−07 |
| | | | MGC14799 | | | | | | |
| Hs.388160 | 2 | MGC10940 | hypothetical protein | | PLS-DA | 316 | 468 | 1.48 | 1.39E−07 |
| | | | MGC10940 | | | | | | |
| Hs.257008 | 1 | PLD3 | phospholipase D3 | | | 313 | 422 | 1.35 | 2.38E−07 |
| Hs.33084 | 1 | SLC2A5 | solute carrier family 2 | | | 130 | 200 | 1.54 | 2.74E−07 |
| | | | (facilitated glucose/fructose | | | | | | |
| | | | transporter), member 5 | | | | | | |
| Hs.82173 | 1 | TIEG | TGFB inducible early growth | | | 279 | 421 | 1.51 | 4.23E−07 |
| | | | response | | | | | | |
| Hs.144407 | 1 | NUDT15 | nudix (nucleoside | | | 665 | 1141 | 1.72 | 5.67E−07 |
| | | | diphosphate linked moiety | | | | | | |
| | | | X)-type motif 15 | | | | | | |
| Hs.443711 | 2 | ANK1 | ankyrin 1, erythrocytic | | | 35 | 61 | 1.73 | 9.09E−07 |
| Hs.154149 | 1 | APEX2 | APEX nuclease | | | 209 | 335 | 1.60 | 1.33E−06 |
| | | | (apurinic/apyrimidinic | | | | | | |
| | | | endonuclease) 2 | | | | | | |
| Hs.80409 | 1 | GADD45A | growth arrest and DNA- | | | 1609 | 2459 | 1.53 | 1.36E−06 |
| | | | damage-inducible, alpha | | | | | | |
| Hs.255935 | 1 | BTG1 | B-cell translocation gene 1, | | | 2000 | 3113 | 1.56 | 1.44E−06 |
| | | | anti-proliferative | | | | | | |
| Hs.1583 | 2 | NCF1 | neutrophil cytosolic factor 1 | | | 65 | 102 | 1.55 | 3.51E−06 |
| | | | (47 kDa, chronic | | | | | | |
| | | | granulomatous disease, | | | | | | |
| | | | autosomal 1) | | | | | | |
| Hs.7426 | 1 | KIAA0841 | KIAA0841 | | PLS-DA | 91 | 176 | 1.93 | 7.78E−06 |
| Hs.412832 | 1 | PARC | p53-associated parkin-like | | | 108 | 133 | 1.24 | 8.63E−06 |
| | | | cytoplasmic protein | | | | | | |
| Hs.20930 | 1 | PCBP4 | poly(rC) binding protein 4 | | | 163 | 201 | 1.23 | 1.75E−05 |
| Hs.164457 | 1 | TK1 | thymidine kinase 1, soluble | | | 123 | 258 | 2.10 | 2.09E−05 |
| Hs.443960 | 2 | DDX11 | DEAD/H (Asp-Glu-Ala- | | | 229 | 321 | 1.40 | 3.34E−05 |
| | | | Asp/His) box polypeptide 11 | | | | | | |
| | | | (CHL1-like helicase | | | | | | |
| | | | homolog, S. cerevisiae) | | | | | | |
| Hs.8375 | 2 | TRAF4 | TNF receptor-associated | | | 417 | 611 | 1.47 | 3.48E−05 |
| | | | factor 4 | | | | | | |
| Hs.343911 | 1 | EI24 | etoposide induced 2.4 | | | 901 | 1357 | 1.51 | 3.48E−05 |
| | | | mRNA | | | | | | |
| Hs.284208 | 1 | ANKRD25 | ankyrin repeat domain 25 | | | 299 | 634 | 2.12 | 5.70E−05 |
| Hs.31097 | 1 | NOD9 | NOD9 protein | | | 218 | 290 | 1.33 | 8.53E−05 |
| Hs.278027 | 1 | LIMK2 | LIM domain kinase 2 | | | 87 | 128 | 1.47 | 9.88E−05 |
| Hs.31130 | 1 | TM7SF2 | transmembrane 7 | | | 514 | 760 | 1.48 | 0.000105 |
| | | | superfamily member 2 | | | | | | |
| Hs.232004 | 1 | NRGN | neurogranin (protein kinase | | | 127 | 268 | 2.11 | 0.000143 |
| | | | C substrate, RC3) | | | | | | |
| Hs.50842 | 1 | IFI35 | interferon-induced protein | | | 278 | 328 | 1.18 | 0.000206 |
| | | | 35 | | | | | | |
| Hs.23642 | 1 | HSU79266 | protein predicted by clone | | PLS-DA | 640 | 1262 | 1.97 | 0.000219 |
| | | | 23627 | | | | | | |
| Hs.224397 | 1 | TCEA2 | transcription elongation | | | 214 | 312 | 1.46 | 0.000226 |
| | | | factor A (SII), 2 | | | | | | |
| Hs.110746 | 1 | C6orf18 | chromosome 6 open | | | 146 | 183 | 1.25 | 0.000265 |
| | | | reading frame 18 | | | | | | |
| Hs.87246 | 1 | BBC3 | BCL2 binding component 3 | | | 159 | 206 | 1.29 | 0.000375 |
| Hs.288382 | 1 | FLJ13111 | hypothetical protein | | KNN | 69 | 85 | 1.24 | 0.000424 |
| | | | FLJ13111 | | | | | | |
| Hs.256278 | 1 | TNFRSF1B | tumor necrosis factor | | PLS-DA | 194 | 270 | 1.39 | 0.000476 |
| | | | receptor superfamily, | | | | | | |
| | | | member 1B | | | | | | |
| Hs.413078 | 1 | NUDT1 | nudix (nucleoside | | | 145 | 243 | 1.67 | 0.000544 |
| | | | diphosphate linked moiety | | | | | | |
| | | | X)-type motif 1 | | | | | | |
| Hs.439776 | 1 | STOM | stomatin | | | 206 | 229 | 1.11 | 0.000544 |
| Hs.412228 | 1 | KHK | ketohexokinase | | PLS-DA | 68 | 118 | 1.73 | 0.000586 |
| | | | (fructokinase) | | | | | | |
| Hs.17466 | 1 | RARRES3 | retinoic acid receptor | | | 516 | 745 | 1.44 | 0.000716 |
| | | | responder (tazarotene | | | | | | |
| | | | induced) 3 | | | | | | |
| | 1 | | EST | | KNN | 194 | 242 | 1.25 | 0.000785 |
| Hs.159428 | 2 | BAX | BCL2-associated X protein | | | 718 | 1119 | 1.56 | 0.000921 |
| Hs.14623 | 1 | IFI30 | interferon, gamma-inducible | | | 556 | 695 | 1.25 | 0.000931 |
| | | | protein 30 | | | | | | |
| Hs.7019 | 1 | SIPA1 | signal-induced proliferation- | | | 53 | 88 | 1.66 | 0.000967 |
| | | | associated gene 1 | | | | | | |
| Hs.279413 | 1 | POLD1 | polymerase (DNA directed), | | | 279 | 651 | 2.33 | 0.00132 |
| | | | delta 1, catalytic subunit | | | | | | |
| | | | 125 kDa | | | | | | |
| Hs.383396 | 1 | RRM1 | ribonucleotide reductase M1 | | | 1011 | 1579 | 1.56 | 0.00164 |
| | | | polypeptide | | | | | | |
| Hs.46465 | 1 | TCIRG1 | T-cell, immune regulator 1, | | | 347 | 460 | 1.32 | 0.00188 |
| | | | ATPase, H+ transporting, | | | | | | |
| | | | lysosomal V0 protein a | | | | | | |
| | | | isoform 3 | | | | | | |
| Hs.77783 | 1 | PKMYT1 | membrane-associated | | | 309 | 590 | 1.91 | 0.00195 |
| | | | tyrosine- and threonine- | | | | | | |
| | | | specific cdc2-inhibitory | | | | | | |
| | | | kinase | | | | | | |
| Hs.26471 | 1 | BBS4 | Bardet-Biedl syndrome 4 | | | 129 | 149 | 1.16 | 0.00221 |
| Hs.279032 | 1 | HUMGT198A | GT198, complete ORF | | | 172 | 289 | 1.68 | 0.00271 |
| Hs.94292 | 1 | FLJ23311 | FLJ23311 protein | | KNN; PLS- | 410 | 589 | 1.43 | 0.00434 |
| | | | | | DA | | | | |
| Hs.511950 | 1 | SIRT3 | sirtuin (silent mating type | | PLS-DA | 93 | 113 | 1.21 | 0.00529 |
| | | | information regulation 2 | | | | | | |
| | | | homolog) 3 (S. cerevisiae) | | | | | | |
| Hs.32922 | 1 | CARF | collaborates/cooperates | | | 331 | 397 | 1.20 | 0.00585 |
| | | | with ARF (alternate reading | | | | | | |
| | | | frame) protein | | | | | | |
| HS.383913 | 1 | BLM | Bloom syndrome | | | 193 | 341 | 1.76 | 0.00614 |
| Hs.387156 | 1 | GM2A | GM2 ganglioside activator | | | 149 | 223 | 1.49 | 0.00614 |
| | | | protein | | | | | | |
| Hs.421342 | 1 | STAT3 | signal transducer and | | | 910 | 999 | 1.10 | 0.00697 |
| | | | activator of transcription 3 | | | | | | |
| | | | (acute-phase response | | | | | | |
| | | | factor) | | | | | | |
| Hs.460184 | 1 | MCM4 | MCM4 minichromosome | | | 491 | 936 | 1.91 | 0.00721 |
| | | | maintenance deficient 4 | | | | | | |
| | | | (S. cerevisiae) | | | | | | |
| Hs.386264 | 1 | ZNF273 | zinc finger protein 273 | | | 234 | 315 | 1.35 | 0.00829 |
| Hs.108222 | 1 | CTNNBIP1 | catenin, beta interacting | | | 60 | 82 | 1.38 | 0.00863 |
| | | | protein 1 | | | | | | |
| Hs.143917 | 1 | HELIC1 | helicase, ATP binding 1 | | | 897 | 1349 | 1.50 | 0.00983 |
| Hs.501565 | 1 | DHTKD1 | dehydrogenase E1 and | | | 350 | 443 | 1.26 | 0.0101 |
| | | | transketolase domain | | | | | | |
| | | | containing 1 | | | | | | |
| Hs.122908 | 1 | CDT1 | DNA replication factor | | | 234 | 495 | 2.11 | 0.0147 |
| Hs.273397 | 1 | USP52 | ubiquitin specific protease | | | 194 | 177 | −1.10 | 0.0164 |
| | | | 52 | | | | | | |
| Hs.156346 | 1 | TOP2A | topoisomerase (DNA) II | | | 840 | 1603 | 1.91 | 0.0184 |
| | | | alpha 170 kDa | | | | | | |
| Hs.464813 | 2 | DHFR | dihydrofolate reductase | | | 1079 | 1896 | 1.76 | 0.022 |
| Hs.1281 | 1 | C5 | complement component 5 | | | 80 | 134 | 1.67 | 0.022 |
| Hs.2157 | 1 | WAS | Wiskott-Aldrich syndrome | | | 53 | 69 | 1.30 | 0.0228 |
| | | | (eczema-thrombocytopenia) | | | | | | |
| Hs.47504 | 1 | EXO1 | exonuclease 1 | | KNN | 209 | 404 | 1.93 | 0.0254 |
| Hs.177926 | 2 | LOC81691 | exonuclease NEF-sp | | | 170 | 221 | 1.30 | 0.0304 |
| Hs.109058 | 1 | RPS6KA5 | ribosomal protein S6 kinase, | | KNN; PLS- | 276 | 374 | 1.35 | 0.0337 |
| | | | 90 kDa, polypeptide 5 | | DA | | | | |
| Hs.149227 | 1 | FLJ20406 | hypothetical protein | | | 68 | 90 | 1.33 | 0.0364 |
| | | | FLJ20406 | | | | | | |
| Hs.72249 | 1 | PARD3 | par-3 partitioning defective 3 | | | 193 | 193 | −1.00 | 0.0364 |
| | | | homolog (C. elegans) | | | | | | |
| Hs.28491 | 1 | SAT | spermidine/spermine N1- | | | 403 | 409 | 1.01 | 0.0487 |
| | | | acetyltransferase | | | | | | |
| Hs.211201 | 4 | CYFIP2 | cytoplasmic FMR1 | | | 683 | 880 | 1.29 | 0.0562 |
| | | | interacting protein 2 | | | | | | |
| Hs.292119 | 1 | NUP210 | nucleoporin 210 | | | 133 | 200 | 1.50 | 0.0666 |
| Hs.282997 | 2 | GBA | glucosidase, beta; acid | | | 287 | 349 | 1.22 | 0.0689 |
| | | | (includes | | | | | | |
| | | | glucosylceramidase) | | | | | | |
| Hs.173464 | 1 | FKBP8 | FK506 binding protein 8, | | | 107 | 134 | 1.25 | 0.0737 |
| | | | 38 kDa | | | | | | |
| Hs.21331 | 1 | FLJ10036 | hypothetical protein | | | 479 | 656 | 1.37 | 0.0737 |
| | | | FLJ10036 | | | | | | |
| Hs.38178 | 1 | KLIP1 | KSHV latent nuclear antigen | | | 1185 | 2030 | 1.71 | 0.0745 |
| | | | interacting protein 1 | | | | | | |
| Hs.288672 | 1 | FLJ13909 | hypothetical protein | | | 68 | 159 | 2.33 | 0.0951 |
| | | | FLJ13909 | | | | | | |
| Hs.180402 | 1 | FLJ23506 | hypothetical protein | | | 98 | 110 | 1.12 | 0.0972 |
| | | | FLJ23506 | | | | | | |
| Hs.34012 | 1 | BRCA2 | breast cancer 2, early onset | | | 144 | 227 | 1.58 | 0.0981 |
| Hs.89385 | 1 | NPAT | nuclear protein, ataxia- | | | 137 | 172 | 1.26 | 0.106 |
| | | | telangiectasia locus | | | | | | |
| Hs.15535 | 1 | TCEB3 | transcription elongation | | | 117 | 117 | −1.00 | 0.106 |
| | | | factor B (SIII), polypeptide 3 | | | | | | |
| | | | (110 kDa, elongin A) | | | | | | |
| Hs.82502 | 1 | POLD3 | polymerase (DNA-directed), | | KNN | 436 | 629 | 1.44 | 0.13 |
| | | | delta 3, accessory subunit | | | | | | |
| Hs.296365 | 2 | ZNF324 | zinc finger protein 324 | | | 122 | 113 | −1.08 | 0.132 |
| Hs.275675 | 1 | KATNB1 | katanin p80 (WD repeat | | | 62 | 77 | 1.26 | 0.134 |
| | | | containing) subunit B 1 | | | | | | |
| Hs.66718 | 1 | RAD54L | RAD54-like (S. cerevisiae) | | | 206 | 340 | 1.65 | 0.135 |
| Hs.334828 | 1 | FLJ10719 | hypothetical protein | | KNN | 458 | 680 | 1.48 | 0.174 |
| | | | FLJ10719 | | | | | | |
| Hs.226390 | 1 | RRM2 | ribonucleotide reductase M2 | | | 1629 | 3230 | 1.98 | 0.177 |
| | | | polypeptide | | | | | | |
| Hs.405467 | 1 | FLJ10858 | DNA glycosylase hFPG2 | | | 193 | 266 | 1.37 | 0.19 |
| Hs.90598 | 1 | MICA | MHC class I polypeptide- | | | 140 | 152 | 1.09 | 0.193 |
| | | | related sequence A | | | | | | |
| Hs.106185 | 2 | RALGDS | ral guanine nucleotide | | | 222 | 262 | 1.18 | 0.211 |
| | | | dissociation stimulator | | | | | | |
| Hs.231444 | 1 | E2F2 | E2F transcription factor 2 | | | 67 | 106 | 1.58 | 0.224 |
| Hs.337242 | 1 | CENTB1 | centaurin, beta 1 | | | 403 | 461 | 1.14 | 0.256 |
| Hs.348920 | 1 | FSHPRH1 | FSH primary response | | | 88 | 137 | 1.55 | 0.317 |
| | | | (LRPR1 homolog, rat) 1 | | | | | | |
| Hs.376719 | 1 | MAGED2 | melanoma antigen, family | | | 428 | 434 | 1.01 | 0.318 |
| | | | D, 2 | | | | | | |
| Hs.142245 | 1 | HHLA3 | HERV-H LTR-associating 3 | | PLS-DA | 219 | 228 | 1.04 | 0.319 |
| Hs.46446 | 1 | LYL1 | lymphoblastic leukemia | | | 54 | 66 | 1.23 | 0.339 |
| | | | derived sequence 1 | | | | | | |
| Hs.408658 | 1 | CCNE2 | cyclin E2 | | | 155 | 221 | 1.43 | 0.36 |
| Hs.54089 | 1 | BARD1 | BRCA1 associated RING | | | 392 | 582 | 1.48 | 0.379 |
| | | | domain 1 | | | | | | |
| Hs.79625 | 1 | C20orf149 | chromosome 20 open | | | 767 | 840 | 1.10 | 0.405 |
| | | | reading frame 149 | | | | | | |
| Hs.442993 | 1 | MXD3 | MAX dimerization protein 3 | | | 92 | 127 | 1.39 | 0.423 |
| Hs.107911 | 1 | ABCB6 | ATP-binding cassette, sub- | | | 315 | 364 | 1.16 | 0.462 |
| | | | family B (MDR/TAP), | | | | | | |
| | | | member 6 | | | | | | |
| Hs.115740 | 1 | TBC1D5 | TBC1 domain family, | | PLS-DA | 345 | 404 | 1.17 | 0.764 |
| | | | member 5 | | | | | | |

We claim:

1. A method of predicting genotoxicity of a compound using a predictor model, comprising:
identifying a plurality of biomarker genes that display an altered expression profile when exposed to a genotoxic compound or a non-genotoxic compound from a calibration set of samples;
identifying a sub-set of biomarker genes from the calibration set that display an altered expression profile when exposed to a genotoxic compound or a non-genotoxic compound from a validation set of samples;
classifying the biomarker genes identified in the validation set of samples as those that respond to a genotoxic compound or a non-genotoxic compound; and
using the classified biomarker genes to identify the genotoxicity of a test compound by exposing the test compound to cell sample and comparing the expression profile of the biomarker genes in the sample with those identified in the validation set of samples.

2. The method of claim 1, wherein the classified biomarker genes are selected from the group consisting of biomarker-1 (BM1) genes, biomarker-2 (BM2) genes and biomarker-3 (BM3) genes.

3. The method of claim 2, wherein the biomarker-1 (BM1) genes are selected from the group consisting of Xeroderma pigmentosum, complementation group C, ferredoxin reductase, apolipoprotein B mRNA editing enzyme, catalytic polypeptide-like 3C, hypothetical protein MGC5370, damage-specific DNA binding protein 2, 48 kDa, transcribed locus, papilin, proteoglycan-like sulfated glycoprotein, fucosidase, alpha-L-1, tissue, carboxypeptidase M, tumor protein p53 inducible protein 3, cyclin-dependent kinase inhibitor 1A (p21, Cip1), phosphatidylinositol glycan, class F, interleukin 6 signal transducer (gp130, oncostatin M receptor), hypothetical protein FLJ10375, vacuolar protein sorting 54 (yeast), hv89d09, interleukin 6 signal transducer (gp130, oncostatin M receptor), phosphatidylserine receptor, alpha-cardiac actin, hypothetical protein FLJ11383, ras homolog gene family, member Q, thioredoxin interacting protein, hypothetical protein LOC339290, NCK-associated protein 1, TBC1 domain family, member 17, ectodermal-neural cortex (with BTB-like domain), thioredoxin interacting protein, phosphatidylinositol glycan, class F, phosphatidylinositol glycan, class F, and solute carrier family 33 (acetyl-CoA transporter), member 1.

4. The method of claim 3, wherein the biomarker-1 (BM1) genes are selected from the group consisting of Xeroderma pigmentosum, complementation group C, ferredoxin reductase, apolipoprotein B mRNA editing enzyme, catalytic polypeptide-like 3C, hypothetical protein MGC5370, and damage-specific DNA binding protein 2, 48 kDa.

5. The method of claim 2, wherein the biomarker-2 (BM2) genes are selected from the group consisting of EST370545, H. sapiens adenosine deaminase (ADA), Homo sapiens chromosome 12 open reading frame 5 mRNA, polymerase (DNA directed), eta, isocitrate dehydrogenase 1 (NADP+), carboxypeptidase M, plexin B2, polymerase (DNA directed), eta, hypothetical protein FLJ12484, KIAA0907 protein, transcribed locus, ARP9, wb67g03, leucine-rich repeats and death domain containing, potassium large conductance calcium-activated channel, subfamily M beta member 3, KAT11914, mitochondrial carrier triple repeat 1, tax1 (human T-cell leukemia virus type I) binding protein 3, sestrin 1, ret finger protein, SMAD, H. sapiens mitogen inducible gene mig-2, FLJ10378 protein, hypothetical protein MGC7036, ubiquitin-conjugating enzyme, KIAA0368, phosphatidylserine receptor, O-linked N-acetylglucosamine (GlcNAc) transferase (UDP-N-acetylglucosamine:polypeptide-N-acetylglucosaminyl transferase), Mdm2, hypothetical protein LOC51061, NudE nuclear distribution gene E homolog like 1 (A. nidulans), HTPAP protein, and syndecan 1.

6. The method of claim 5, wherein the biomarker-2 (BM2) genes are selected from the group consisting of EST370545, H. sapiens adenosine deaminase (ADA), Homo sapiens chromosome 12 open reading frame 5 mRNA, polymerase (DNA directed), eta, and isocitrate dehydrogenase 1 (NADP+).

7. The method of claim 2, wherein the biomarker-3 (BM3) genes are selected from the group consisting of LAG1 longevity assurance homolog 5 (S. cerevisiae), hypothetical protein HSPC132, FKSG44 gene, adenosine deaminase, pleckstrin homology-like domain, ectodermal-neural cortex (with BTB-like domain), F-box protein 22, ribonucleotide reductase M2 B (TP53 inducible), guanidinoacetate N-methyltransferase, transmembrane 7 superfamily member 3, isocitrate dehydrogenase 1 (NADP+), phosphohistidine phosphatase 1, hypothetical protein FLJ20296, discoidin domain receptor family, member 1, transcribed locus, guanidinoacetate N-methyltransferase, human receptor tyrosine kinase DDR gene, transmembrane 7 superfamily member 3, 601565341F1 NIH_MGC_{—}21 Homo sapiens cDNA clone, F-box protein 22, cytosolic sialic acid 9-O-acetylesterase homolog, BTG family member 2, astrotactin 2, IKK interacting protein, surfeit 4, neutral sphingomyelinase (N-SMase) activation associated factor, ADP-ribosylation factor-like 1, golgi reassembly stacking protein 2, leucine-rich repeats and death domain containing, mixed-lineage leukemia, hypothetical protein LOC253981, placenta-specific 8, glutathione peroxidase 1, KDEL (Lys-Asp-Glu-Leu) endoplasmic reticulum protein retention receptor 2, syntaxin 7, lysosomal-associated multispanning membrane protein-5, and phosphoinositide-3-kinase catalytic alpha polypeptide.

8. The method of claim 7, wherein the biomarker-3 (BM3) genes are selected from the group consisting of LAG1 longevity assurance homolog 5 (S. cerevisiae), hypothetical protein HSPC132, FKSG44 gene, and adenosine deaminase.

9. A method of predicting genotoxicity of a compound using a predictor model, comprising:
exposing a test compound to a first set of a plurality of biomarker genes selected from the group consisting of biomarker-1 (BM1) genes, biomarker-2 (BM2) genes and biomarker-3 (BM3) genes;
comparing the distribution of biomarker genes against the distribution of gene expression of a known reference compound; and
separating the test compound into a class of compound based on the expression of the biomarker genes, wherein the class of compound is genotoxic compound or a non-genotoxic compound.

10. The method of claim 9, wherein the biomarker-1 (BM1) genes are selected from the group consisting of Xeroderma pigmentosum, complementation group C, ferredoxin reductase, apolipoprotein B mRNA editing enzyme, catalytic polypeptide-like 3C, hypothetical protein MGC5370, damage-specific DNA binding protein 2, 48 kDa, transcribed locus, papilin, proteoglycan-like sulfated glycoprotein, fucosidase, alpha-L-1, tissue, carboxypeptidase M, tumor protein p53 inducible protein 3, cyclin-dependent kinase inhibitor 1A (p21, Cip1), phosphatidylinositol glycan, class F, interleukin 6 signal transducer (gp130, oncostatin M receptor), hypothetical protein FLJ10375, vacuolar protein sorting 54 (yeast), hv89d09, interleukin 6 signal transducer (gp130, oncostatin M receptor), phosphatidylserine receptor, alpha-cardiac actin, hypothetical protein FLJ11383, ras homolog gene family, member Q, thioredoxin interacting protein, hypothetical protein LOC339290, NCK-associated protein 1, TBC1 domain family, member 17, ectodermal-neural cortex (with BTB-like domain), thioredoxin interacting protein, phosphatidylinositol glycan, class F, phosphatidylinositol glycan, class F, and solute carrier family 33 (acetyl-CoA transporter), member 1.

11. The method of claim 10, wherein the biomarker-1 (BM1) genes are selected from the group consisting of Xeroderma pigmentosum, complementation group C, ferredoxin reductase, apolipoprotein B mRNA editing enzyme, catalytic polypeptide-like 3C, hypothetical protein MGC5370, and damage-specific DNA binding protein 2, 48 kDa.

12. The method of claim 9, wherein the biomarker-2 (BM2) genes are selected from the group consisting of EST370545, H. sapiens adenosine deaminase (ADA), Homo sapiens chromosome 12 open reading frame 5 mRNA, polymerase (DNA directed), eta, isocitrate dehydrogenase 1 (NADP+), carboxypeptidase M, plexin B2, polymerase (DNA directed), eta, hypothetical protein FLJ12484, KIAA0907 protein, transcribed locus, ARP9, wb67g03, leucine-rich repeats and death domain containing potassium large conductance calcium-activated channel, subfamily M beta member 3, KAT11914, mitochondrial carrier triple repeat 1, tax1 (human T-cell leukemia virus type I) binding protein 3, sestrin 1, ret finger protein, SMAD, H. sapiens mitogen inducible gene mig-2, FLJ10378 protein, hypothetical protein MGC7036, ubiquitin-conjugating enzyme, KIAA0368, phosphatidylserine receptor, O-linked N-acetylglucosamine (GlcNAc) transferase (UDP-N-acetylglucosamine:polypeptide-N-acetylglucosaminyl transferase), Mdm2, hypothetical protein LOC51061, NudE nuclear distribution gene E homolog like 1 (A. nidulans), HTPAP protein, and syndecan 1.

13. The method of claim 12, wherein the biomarker-2 (BM2) genes are selected from the group consisting of EST370545, H. sapiens adenosine deaminase (ADA), Homo sapiens chromosome 12 open reading frame 5 mRNA, polymerase (DNA directed), eta, and isocitrate dehydrogenase 1 (NADP+).

14. The method of claim 9, wherein the biomarker-3 (BM3) genes are selected from the group consisting of LAG1 longevity assurance homolog 5 (S. cerevisiae), hypothetical protein HSPC132, FKSG44 gene, adenosine deaminase, pleckstrin homology-like domain, ectodermal-neural cortex (with BTB-like domain), F-box protein 22, ribonucleotide reductase M2 B (TP53 inducible), guanidinoacetate N-methyltransferase, transmembrane 7 superfamily member 3, isocitrate dehydrogenase 1 (NADP+), phosphohistidine phosphatase 1, hypothetical protein FLJ20296, discoidin domain receptor family, member 1, transcribed locus, guanidinoacetate N-methyltransferase, human receptor tyrosine kinase DDR gene, transmembrane 7 superfamily member 3, 601565341F1 NIH_MGC_{—}21 Homo sapiens cDNA clone, F-box protein 22, cytosolic sialic acid 9-O-acetylesterase homolog, BTG family member 2, astrotactin 2, IKK interacting protein, surfeit 4, neutral sphingomyelinase (N-SMase) activation associated factor, ADP-ribosylation factor-like 1, golgi reassembly stacking protein 2, leucine-rich repeats and death domain containing mixed-lineage leukemia, hypothetical protein LOC253981, placenta-specific 8, glutathione peroxidase 1, KDEL (Lys-Asp-Glu-Leu) endoplasmic reticulum protein retention receptor 2, syntaxin 7, lysosomal-associated multispanning membrane protein-5, and phosphoinositide-3-kinase catalytic alpha polypeptide.

15. The method of claim 14, wherein the biomarker-3 (BM3) genes are selected from the group consisting of LAG1 longevity assurance homolog 5 (S. cerevisiae), hypothetical protein HSPC132, FKSG44 gene, and adenosine deaminase.

16. The method of claim 9, wherein the reference compounds are selected from the group consisting of genotoxic reference compounds and non-genotoxic reference compounds.

17. The method of claim 9, wherein the genotoxic reference compounds are selected from the group consisting of actinomycin-D, bleomycin, cis-Platin, daunorubicin, doxorubicin, ENU/Ethyl nitroso urea, methylmethane sulfonate, mitomycin C, mitoxantrone, and styrene oxide.

18. The method of claim 9, wherein the non-genotoxic reference compounds are selected from the group consisting of diflunisal, flufenamic acid, potassium chloride, N-acetylcysteine, sodium chloride, ranitidine, rifampicin, trans-platin, and verapamil.

19. A method of predicting genotoxicity of a compound using a predictor model, comprising:
exposing a test compound to a plurality of biomarker-1 (BM1) genes selected from the group consisting of Xeroderma pigmentosum, complementation group C, ferredoxin reductase, apolipoprotein B mRNA editing enzyme, catalytic polypeptide-like 3C, hypothetical protein MGC5370, damage-specific DNA binding protein 2, 48 kDa, transcribed locus, papilin, proteoglycan-like sulfated glycoprotein, fucosidase, alpha-L-1, tissue, carboxypeptidase M, tumor protein p53 inducible protein 3, cyclin-dependent kinase inhibitor 1A (p21, Cip1), phosphatidylinositol glycan, class F, interleukin 6 signal transducer (gp130, oncostatin M receptor), hypothetical protein FLJ10375, vacuolar protein sorting 54 (yeast), hv89d09, interleukin 6 signal transducer (gp130, oncostatin M receptor), phosphatidylserine receptor, alpha-cardiac actin, hypothetical protein FLJ11383, ras homolog gene family, member Q, thioredoxin interacting protein, hypothetical protein LOC339290, NCK-associated protein 1, TBC1 domain family, member 17, ectodermal-neural cortex (with BTB-like domain), thioredoxin interacting protein, phosphatidylinositol glycan, class F, phosphatidylinositol glycan, class F, and solute carrier family 33 (acetyl-CoA transporter), member 1;
comparing the distribution of biomarker genes against the distribution of gene expression of a known reference compound; and
separating the test compound into a class of compound based on the expression of the biomarker genes, wherein the class of compound is genotoxic compound or a non-genotoxic compound.

20. A method of predicting genotoxicity of a compound using a predictor model, comprising:
exposing a test compound to a plurality of biomarker-2 (BM2) genes selected from the group consisting of EST370545, H. sapiens adenosine deaminase (ADA), Homo sapiens chromosome 12 open reading frame 5 mRNA, polymerase (DNA directed), eta, isocitrate dehydrogenase 1 (NADP+), carboxypeptidase M, plexin B2, polymerase (DNA directed), eta, hypothetical protein FLJ12484, KIAA0907 protein, transcribed locus, ARP9, wb67g03, leucine-rich repeats and death domain containing potassium large conductance calcium-activated channel, subfamily M beta member 3, KAT11914, mitochondrial carrier triple repeat 1, tax1 (human T-cell leukemia virus type I) binding protein 3, sestrin 1, ret finger protein, SMAD, H. sapiens mitogen inducible gene mig-2, FLJ10378 protein, hypothetical protein MGC7036, ubiquitin-conjugating enzyme, KIAA0368, phosphatidylserine receptor, O-linked N-acetylglucosamine (GlcNAc) transferase (UDP-N-acetylglucosamine:polypeptide-N-acetylglucosaminyl transferase), Mdm2, hypothetical protein LOC51061, NudE nuclear distribution gene E homolog like 1 (A. nidulans), HTPAP protein, and syndecan 1;
comparing the distribution of biomarker genes against the distribution of gene expression of a known reference compound; and
separating the test compound into a class of compound based on the expression of the biomarker genes, wherein the class of compound is genotoxic compound or a non-genotoxic compound.

21. A method of predicting genotoxicity of a compound using a predictor model, comprising:
exposing a test compound to a plurality of biomarker-3 (BM3) genes selected from the group consisting of LAG1 longevity assurance homolog 5 (S. cerevisiae), hypothetical protein HSPC132, FKSG44 gene, adenosine deaminase, pleckstrin homology-like domain, ectodermal-neural cortex (with BTB-like domain), F-box protein 22, ribonucleotide reductase M2 B (TP53 inducible), guanidinoacetate N-methyltransferase, transmembrane 7 superfamily member 3, isocitrate dehydrogenase 1 (NADP+), phosphohistidine phosphatase 1, hypothetical protein FLJ20296, discoidin domain receptor family, member 1, transcribed locus, guanidinoacetate N-methyltransferase, human receptor tyrosine kinase DDR gene, transmembrane 7 superfamily member 3, 601565341F1 NIH_MGC_{—}21 Homo sapiens cDNA clone, F-box protein 22, cytosolic sialic acid 9-O-acetylesterase homolog, BTG family member 2, astrotactin 2, IKK interacting protein, surfeit 4, neutral sphingomyelinase (N-SMase) activation associated factor, ADP-ribosylation factor-like 1, golgi reassembly stacking protein 2, leucine-rich repeats and death domain containing, mixed-lineage leukemia, hypothetical protein LOC253981, placenta-specific 8, glutathione peroxidase 1, KDEL (Lys-Asp-Glu-Leu) endoplasmic reticulum protein retention receptor 2, syntaxin 7, lysosomal-associated miltispanning membrane protein-5, and phosphoinositide-3-kinase catalytic alpha polypeptide;
comparing the distribution of biomarker genes against the distribution of gene expression of a known reference compound; and
separating the test compound into a class of compound based on the expression of the biomarker genes, wherein the class of compound is genotoxic compound or a non-genotoxic compound.

22. A method of identifying a discriminatory set of cellular components, wherein the discriminatory set is used to characterize a candidate agent, the method comprising the steps of:
a) providing at least one model toxic compound;
b) evaluating a concentration at which the compound exerts a predetermined extent of toxicity on a cell;
c) exposing the cell to the predetermined toxic concentration of the compound;
d) isolating a class of cellular component from the cell and separately evaluating the presence, absence or concentration of a plurality of members of the class; and
e) identifying those members of the class that contribute to characterization of the compound; thereby providing the discriminatory set.
